SEQUENCE LISTING (1 sequence)

SEQ ID NO: 1 - DNA, 160221 bp, Unknown
  Salmonella bacteriophage S16
aattacctcttagatggcgccctggagcgccgcaattttcatgatgtcagtgtagtattcttctcgagaaatgtagtattcttcaagcatataccaaatcactgggtattttttagcaaattcgtcagaagctttattaaaatcagactttgacgataagatgagtttattataaatcttataacataaagcaattttttcagcggcttctgactgatttactgttgtgttaatagagcggtaatttaatgcttccgctatacggttaagaactaaagacttttcccagttatcaccggagataaaattcttcagcaacggattaagcgcttttatattaatcatagcgttgaagcgtctgatattaaacaaatgtggatgaattaaatcatcaagtacgtcgtcaatcaaatctgcgtaactatcagctaaaacatcaaaaactgaagttagagaattattgtctttgacatatttcattgcgctaggacgaatagtataaaattcttttatatctgccgctttacatgcttgtctaatattttcaatgctgtaactcgtagagcattctgttcttaattcaacaatgtcttctcgattaattccaactgctaaaccttccaattcacgaacttcatttgcagttaaaaacaaattagtcgattcccaatgaagttctgaatccaatttccatagatgaacattcggagattttggacgtttaaccgcatctgaattatctggcttattgatttcagcatctttggcacgggcttgttccatatcagaagctttaaaaataactacttcatcgccttcaaacaacttcttggcaagttctacaacttctaaatggtcttcattattcgggtcaattaaaataacttgacagcctttatgaatattaaggtaactcatcccacgaatagtgcttgctctgcggtttggcttatcgtcaatcataaaaacaatctttttctgattaacatgaattaagccagatgccgaatatcgattacgcgtgctccatgaattactaattttgcggcgttcagccatatcgccgacaaagtaagtatacatattagatgaatacattttattttcgagagcacgttggtcgaaataatcaagccattcgcggcaagttttgccttgaatttttgattggctattaccaataatagcaagagacctgctggaaaatttctttaactcacggaccagttctcgcttattggttatactttcaagatgtttgatatcgtctcttagatttgtttcttcgattttattaattttattgcgaatagcttcgatagtttcttcattgtaagaaagctcttcacggctaggagtaatatcaagttcacctaattcaaaattaacataaaccgtgctatacttgttattcagccattcgcatttgataccaggaacttcttgaaccttaatcggataaacaattcgtccataaattgcatacaaattcgaatcagtatcaaaataagagcgttgtttattaaaccattgcttttctggagtgaactcttcgaaataatcaatattgatattagcaccttcaatttctggttcaacaccagcaaatgtgcgcaaagtacgacggacttcatgatgccacttatcaatatcgtcagtttttacagggacagtaatttcaataccagtgtattcatcttcttccattgctgtgtcaaacagcggaataatttctggaccagtatttttcattatagcggtgtaaccgcgcttacggcctttatgacaagaaacgactgtaaaagtttttgtatagctaaatggagattttgagccaagacccattgccccgatgaaatcatttgagtcggctttagttgaagcaaaataagtattatacaagcctggagcatcatcagttccacgaatttgttcatcgctcatacctgggccaaaatcgcgaattacgaagcgcgggtctatacgagtaggaactttaatagtgaacggacgagtttggccattcagtttatgagcatcaagacagttagtagataattcacgaacgatagcgtaaattttattggtatataacttgtctgaaagaaccatgaacgctttcatgttgttctcaatgccaaacttacttgccttctgattggctgaaccaaaaatctgctcttcttcttgtttaataatcatctttttctctcattcacttaaattaatcttggttacgcttaatcaattctgcaacttctagaagttcttctgccgttgcggtgttgttttgtattttaaaccgtatttccttaaagcgttctttaaaatcttcagcttcactcatgtcaaaaaatctttgaatgatgcggtactctttatatacagcgtcatcaaataataccatacaaacgttaaagcttttcatttcctacctctctgaggatggctgcaaactggctcatagtgtgtttttcacgtacagagtaaaccagcctcaaagcggtttgttgtaggttcaccggaatgatctggttgttttcaactaatacagcaatatgttctatcatattagagaatttatttaaccagatttcatctggtgtattctctgttttattcagaaacatatctttactatctctaattgttgctgctacgttgtataaattaacataacttccgttaagcattttcatagctgtaatcaccatactaaaaagggactcccgaaggagtccctgttattaccatgtggcttttgacaccatacctgtaactttcttcaaagagttgtccggctgacgaacacgaatagtagccatatcaccagggagaggaagagcatctccccacatataaccgaaacttccatctacaagcgttacccagatttgtgacataaactctcctatacgggcggaatacccgtattatttattcactcatccagaccttgcgaggagcagcatcattacccataaccatttcaaaaagttctttccaatttggaggtaatgaaactacatcatacaccggcttctggataactcgttcatactcatcttcttctaaagaaccaagtcccttgatataacgaagtttccatcctgtgagtttatctttttcagcttcatactcagcggcattgtaataccatttttgctcagagcccttggacataataatcaccggggttttaacaaaacgaatacgaccttcttcgaacaacttcggccaattagcaaaaaatgctaacagacttggataaattgaccctgtgccaaatatctctattgtgaggtatatcaatgattagcccgaaggctaaccatcaacatcagcatcggtcatgatggcgatgtttttataattcaaagaagaagttgatgtacggcgtacgattgtctgggctttatatgacttcatatcgatttcagtttctttaactttagcaaatttcatttaaaacctcataaaatttttcatcaggagtccaaccgtttttaaactgattgaacgcgattttgaacagtttcgttttgatagttatattattaaccgttttccatttagcaattccggttttcttataactaactgggtcataaacgttagcataccaatcataaagggacggaatcaacttaactgcgtctggattggttttagatttgttataccaaggtttagatttttcaagggcggctgctacttttgtagcgtttaacgtgttaccaactccgcataaaccaaggtcctttattaaagggtcgtccgttcttagtctataggttgtgttatctttatccttgtaaactccgtatcctttcacaccttcaaattttcttccgtaatttacgccaacccaatcttcttcagtgtattcgcctttcgtcagtaatcgacattctccagtttctttatttctaagtaaaattttgtcacgcatgaactcagcagaccaatctgaaatcatattaacataatttttcctggctatttcataaagtttagaacgaaatattgttccagaattcattatccggttcaaagcataagacatttctttgtttttatgaattttaaacaataaccagtgcgcaataaaatgttcgcgatatgtcaattttaccaaattatctgaagtatctaatccacccatgcttcttggaagtatatgatgaatttctcctttaaccggcggaaccctggttttaccccgggaaattagtttttcatatatcaaactataattcatactaagtcttttacttttttccagacgccatcaataaaaatttcgtcattgatattaactacaatatcttcaccggcaacatttacagtataccattgttcgccggcttcaacttccgtgaatgggtcttcaccaatgactaacccagtaattgcacaaatatcaaagatttctttgtttttcaaagcatcacctgcagacattccccaggtgttcatcactttaccacgtaatggataaccgccatgaagggcacggtcacgagtattaattagataaccaatagcagaatcaccttctgttaagaacaaagttgtttctactttatcattaccatattcaccagctttgatgtgtttatgaactttagctttggccgcctttttcgctgctttggtttctgctgccttctcagccgccagtttacgtgctaacgcagcttcaataatcggcattaaaatagcatcagatttcataatctgattagaaattttctttgcatcgagatttaagtgagatttaatttcgccccatggacttgtaagacgctctttggtttgcgagtcaaagcgcaagttactcatatctcgaataaacatcaacacagtaaaacactctttaatacgagctttgtttacttcaattttgtgtttacgtttaatagccggaattaattcattagcaatttcgtcaataacataatcaatatgcgaaccgccattctttgtatgaatgttgttaacataagtcatttgacgaaaaccatctggagaattacctatcgccaaagaataattttcttcatcaataatgatagcatttttatcatactgcttagaatattttttgaaattactatcaacttttttattgttaaatttaaattcaatttttggataaacgactgccaatgtctgcaaacggtccagcataatatcaaaataaacatcatcaaaattgttcatttcgaaatggctaaaatctggaataaattctaccttagttcctttataagaggattttttggatttccaagaaacattgtcagaattattgctacaagaaactgttaattcattttctccatcagatgttgtacctttaaacataacagagaaaatattagtcaatgaagaaccaacaccgttttgcccgccagttttacgctcttcatcagctccaaagtttccgcctgccttagttttcgtccacgctgctactgggccaggaatttcttcaccctcaggagtagtaaccatagcctgtggaattccacggccattatcttctacggtcactttgcttgtggaagaatcgatattgactgaaattttattagcaaatttaaaacttgtacggatagcttcatcaacagagttatcgataatttcatcaataagtttgagaacgccagctacgtattgtacccgcttaaattcgccaaaaacaaaacgctcatgaaattcgttagatacacttccgatgtacattccaggacgcttaagaacgtgttccttgtcagagagcatttgaattttattttcaatcatgttattatcccagtttgaatttgtctgataattatatcatcaatttaatttagcaattaattcatcacgatatttcatgagatgatgaagcgccggagccccatatataggagaacacaaacttgaattaggttttttacaaaatatggtgtgaatagcttgctcttcactttcgtatgaaaacgtcaaagtttggctataccgatcatcataataggcagcataattattttcttcaattacgataaattcttgaacaactttataatatttttgtaacaagatgtaccgtccgttatccaatttagtcgggaacaatgcgaatttatattttccaatcgctcgttcaactaatctaagcttgcgggcggcattcttttgaattgaagattttccaaatatcataatatttttctcactcagccgttaagaataatcgcgatttttgtatccgttgtaatgaacagcgggcgcagcggtttctcggaacatttttccttcacaattcagaaatgaacattcaattggttcatcacgttctgagaccttgcgcatcttttctaccttttcaccgcaggcttcgcacgtgtaatcataaattggcattatagtaatccttttaacatttcaatagccgctttgacttgatttttattagtaattgctaaagtgatatgaggaatttcattttcttctgaagcttcatattcgtcatcattagccgccgaattaagtgtttccaacttaaaatatttagcttcgtcaggcaagataaagaaatattcattactagttttaataccagaatattctggtattttgtcaattatatcttgcgcgccgcatagagcctggcttaatgttataattgcttcagcggagccacaccaattaacgcttaaaactttaaaaaatccgccatttttattaatgaaattaataattgatttgttgtgtctatgagctttgacaaatccgtcgtaatctttaatagaataccattgacctttaacgaaatgtgttaaattctgtgtagtcattagatagtttccttccaataagaagttccgttttcattgatgtaacgaactaccgcatagattgcacggctgttttcgtaaacgtaggcgtatgtatgatgttctagatgtccttgaacttctttttgcacaatagtcaactctgggttgaacaagatatcttcaaactgctcttgtgttaaaatgcggttcatttattttcctcgtttgttttgatagggttatagtatcataaccctcaaggaaagtaaacagtttaaactttcacgctcagaaaacggcttgaacggattactgctgggataactaaatccaaatctttagtagccattaaagcgtattcaccctgataaaccacgttcgcaacttcttcgccgtcaatatcataaaccaaggtaactaatccacacttacggtcacaaatgtgacagtctccctgaccgccggaatgctcgattgctgcatctgcgtttcgaattcgtacaatatcgccaatttcaataacacaacgctgagaagcttctttcgtataagtgtcgttttcagacacatagtagtcttttacataaattgtgttattagttttaacatcgcgcagacgatatccgtcacgctttgaatgacctagaacaataccaacacgaccagcatttttaccactaattacacgaagttcagtacctttagcaaacatattatcacctttcaattttcagatttgagaaattattttatattaaaatatttaaagcgttatccacgaccttttggaagtgaaagagagtcaatttcagcaccgaccggagcttcttctaagccaagcgcatatcgttgagcatacttcagcatcagaatatctttagcacaatcatggatactatcatgagcgatgaacccgtcaagtacaccattacgcaatggagttgttgttaaatttctagtcatcagcagagcttctattgctgtacggatatctcgctggttccagaatttacatggttccaaattaaatgtgtcaatatctttatcttcaattcctttccggagttcaccttcacgtaggatatcaacaagaataggaaagtcaaatgactgtccgcggcaccatccgaatgagttccatgcatctactccgttatctttcaggaatttaagaagtttataaagtccttcgacgtggtcaatgtcatcatcagacggtgcaaggttagctctagcttcagctgactgctttttccaccaagctaaagtacttgcaccgaataaccgaaatggacgctgagaccggaggtcaaactttagtttcattcccctagaaactagttcgtcgaacgtttcgataacttccggattagggtcaaaaactaccaccgcacagtcaataactgctgatcgagaaacgttaccgaatgtctcccaatcaataataaaatcttttacgcccggcatagatattccttaaattcattaatctgtttagatattttatcattaattgatataagcggtacttgtccttggaaccaagcgatactcatagcttcgtcgcgaatctcgtttagttgaagcaataacgtagattgatgaccgcgccaccaagcatcttcgggtttgttaatttcaatagcattaatcaacttatcaaaatcatcaatatcaagagtaaacatatttgttccttatacaaagaaaacatcatggcggccacgagttgcacccacataaagaagttctagcttaaacttattatcgctgcttacgtgaatacacggagtataaatgaaactactatctacagaaataccctgagctttatggaacgttgaacaaggtaaagctttaaccttatgaaattttcgtttagcatcccagaattctgaccaaggagctttaccgcctttattccagtttttataagtatctgccgtctttgccaagaaaaactgaaatttgttcatttcttgttcgtcagatattacattaattttctcacgagcatattcttcatcgtcataagtttctacatctaaaacccagtgacgaattagatgttcaccagatactccctttgctcccaagaatgaagatgtgtaatctgcacttagaatacgaacatattgaccattagtaaataatgtttcatggaatttttttccctcaaatacaagttccctcattaaaggttcttgcataacaataacttctcctactacgaacgcttcttccgtttgatataaacgtctacgaatgatagagtttaatttatcaaccgacttatttgtgaatgcgagcattcggttttcaaacaaatcttccggtgatttgacgatactaaaatattgcatcataaaatctttaagtgccgttgtacttgtaaatccatgcacaccatgaccatcaacagttttttcgtaaatccatgaaccgtttcttatatcagtagcaacatcaataatcggagcgttactgcgcattacttcagtaagatttaattgtttaaaatctttatgaataaagaaaggagatatatgagcttctgtttctccagggtcaaccggacgaatttgagcgacatctccaatagcgactatagtacaccatttaggaattgaagccattagtattttaaataatttgcggtcccacattgaagcttcgtcacatattagcactcggcatgatgctaaatctggcacttctttttgttcaaacaacatactttcttcatatgttgtggggttaatttttaaaattttatgaatagtattagcttccatgccggacaatttggttaatacttttttggctgcatgtgtaggagccgtcaaaataataccagtttcgccagtagaaactaaatgctccatgataaattttgttaacgtagttttaccagtacccgctggaccgttgatagtaacatggtttttcttttcttttatagctctaatagtttcatcaaatgctagtttctggccagaagtcaactgctcaaatgtaatcataccactgatacccttttaacacttaatgtgttcataatttgtctgttcattctactttcaatttcagaaagctttttaaacttcatttcaactttatcgaaccagaaacgacgtttcttaattgtagtttctactttaccgacattcaatatatgagtaagataagtttttagctgctcatagtgcttcacagcatcatcaaatttttcatagattgtagcctttccagattcgaagtacgggagttcaaacccgtctttatctttgtagactaacatgtatccatagtgcatcacattttgcctcggataagttgtaacaatgttgcagaaagtggaagaccttttttcagcttcgctttatccaaacgagataaattttggaaacgagtaagaccttgaataataatatcataatctttcacggtgatttctgctttgctattctttttggatgcagcgcctgaagttacagcttcagaagacgggtatttttcaaatattctctttaatgttttaattccgcctttgatgcgagtttctagagaatcgcgagtgtctttctgtattccggcttgcttaagatgactgcggcgggcctgcacgtttgcccaaatgcgtttagcttcttcacggcggacaccggaaattttagaccaatcaggctctttgttccaatcatgagtttctaatacaaagtcagaatgattgaggtcaacagcaggttctacaactttgtttttagagtcaacggcggaaacgatgcgcgcagctagttcttcttgctttttaatgaggtcatcaatttcgaagttggcgcgcagtttattgtacttcattttaacaggaataacgttgccttctacatatcctttgttgttatcaaaccgctcgagagtcatttggtcaggcccaagttccttcttgaacttttctcctgaatatgcacaagtatcttgctccatgatgttcatcaagtacttcaaagaaagattaaattctttacttctagaagaagcacttttgtatgtatgaaccaaacgttgagcgataacaatttcacgaggcatggccataacgatattccttatttgctttttatgcgaatgtggtataatggtttcaaggattattctaatacactctatccggaaagtaaacggttagaatgaataaaaatccaaatgatatacagtatatgacggagataaagggtcatactgtaactcttcaatctccactatctcaaattgtgttccaatagggaacatccattcatcttctccattgaccatttcaagtttatccagtctttcatcaaaaataaaatctgggtctatgctgtgcataaattctgtgtctggcgcagccagaagcatattcagtgcgtgctcttgatagttaaaagcaaatgggcaattacgtaatgacaaaatagtatgagtaccatacacactccctccagcgaattgtcttgctgtggaaaaatctgatgtaaacgacgtaactcggtcatcagcaataattcttcctacagccatatttttcaaccaagcttcggtacgttttgacactcctctgtagagttcaactggaacgtcagaactaatatgcttacgtataattttgtccagttctacatgcaaagttttgtcaattttatcattcatacactgccaaagtatgctctgttcaaaatcactgaacatcttaattttttcttcatacaatccatagagattgttatcaactatgttacaaacgatttcattaagctgagaatttgtgtataacataatagcctccgtagtttacagaagctatcataacacattttgactgggatgtaaacggttattctgtccacggagcccaaggaggagggtctaaccagatagaagagagttcttctacgaaagtgtcgttgagttttacaccatgccgtaaggcaagaacaaaaagctcttgtttgatttcagcacgtcggttgccaaatgcttctgaattttttgactggtcttcttcaaataaatcaaataaatccgacattacatacctctgatgtatttgacagcagttacggacatagttttttcttcaaatccattacgacgaattccagtatcattaaaatgatgccaaatgaatttttccaattcaacgatgtgttcaggagtatttacaataaattttttgaagatttttttgccatatccatctgtacgacacaaaggttcgctaaaattgaattccggaaaaatgtatttctgactaagcaaagtttctaccataccaaacggtgaattttcgcatttgtcgatattacaatcatgaatgatttctaacaatgcattttcgggaattcgcattttcataaactgcttttctagattattataatgctcgtttgaaaaaggtgcaggttcaccatactgagttagaacaacttcaaacttttctcgagtttcttctactcgtcgattagttcttttatagaatttcactacaaatgactttgttttcatatttttcatgatattctcttattttatgacttatcgccgtaaatgttagttaaaagctttttagcttctattgaaatacgtttagcttcttgttcattgcgccaatttctagcgtattcttccgcttcatgttgaagttcttgctcaactttagcaacccattcatcatctaaatgagtaggtgtttcaaaccaatttttgaattcttcgtaccatcgtttaatcataaccaggatgtcccaaagcgaataacagatttttcacctacaaagtgaaagtgagcctcatatacgacacgtaaagcagtaccttcctcacggtagcaatgaataaagatgtctactaaatcatacagatttgggctatttgcgataaacaaatgttcatgaattaagcgatttgcaataagactattgataccaccaacttcttcaactggcttcatccagttagatgttttcataatattatcctcatttgataaaagaattatatcatatcgtttaaaagcaaaaaagggactcccgaaggagtccctgcaatcaatcacctggtactactggcggtacgcctttaaacatatcagcgtttttggcaatccaagcgtctctttggtcctcttcaaaaacggtagaatacgccgctttttcggaagggaagagttgataatgagaaccagcaatttgatgcacgtcggagtaaagcttaaaagctacagaaacttccataccttttacttcaccgtcggcatttgtatggtcaaacgtttttacgttaacataactcatgtaattctcctttgttgattacatgagtatttattaatagttatttaaagcctctactatatctgctatgatatcttcagaatcgccaataagttctcgaagagatttgtacttatcttctggacttagaggatttaagccccaatattttattaaagcattttcaatatcagaatatgaaatcattagtatcctcggttttgccgctcaaagttttcagcatttttcagatagtaaagtttaaagatttcttcagccgacatgcctaatccttggaacatattcaacacaaagtgaagaatatcaatcatttcaaatttaatttctaattggtcttttgaagacatttcagaaataagacgattgcgtaattctgcatgttgtgctttccacggtttccagacagaagaagcagccttctcgccattagacataccgcccagagaagtcaacagctcacggaattcgtcatcgatataatctttctgattacgtagccaatcaacaacttcaccagctttagctaagtcatctggattgcggttatagtcaggtttatcatttgctagacgcacttgcaatgatttttgcatgtcaagcatcacttgaagcgggtcaataccagcattcacagcatcataatacgcattttctgctttttcattgccagagatgagttgagaacattcattaaaatgggccattatatttcctgtcaaagtattaaatagtttaggaggatttatgtctgaaaaaattaaaaccccagaaaataaaaatctgaagtctcaattcgttgagaacaaaggtaaattaatcttagttggagttattacagctgtaataacagcatggaactatattatcatccctttcgcattagcatatgggtttactttacctccaattccattggataaagttattcatttcattatgctcggaggattttaaactccaatctttgagtaattcttaaggcgaagttgagccatcaaacccgaagatatattttcggaaatatatttttcgatgtcttcaactttcgccccttcattttttatcatatcattaatgtctttttctttccattgagatttatcccaaaacacaactctttcgccagcgtctatcaaacgcttcattcgcttgattgtgtcttcttttcttggttcatggtccataatccatactctatcttctttaaatggaaccaaatccaaatcaatagcgccaccggtgatggcaatagcattgcccaagaacaatgagtctatcgggccttctaatacaaaaatattttgaccggtctttgctgtgtctaatccgtatatttttgttgcatgttcgtttcgtttaattgttatgtatttttgaggggcgtctttacgcaatgctcttccttgaaaactttcaataatacctttctcattaaagattggaattactaaacgaggctcattacgttctgttttataagttccgggattaacggaattcaccaaagctggccattccatcgtaaaatacaaacggttccaacgcgattttggaatacaacgatgtttaacgtattttataataggatgctcttctgacaaactatctaagcggctgcaatgaactaatttaattccttctggttctttaatttcaacttttttcacctctggttttgtatcaggcttaaaagtcattttgtcctttctgagttctaaaataaactcacggtataaatcaggttcatattcctttaaatacaccccaattggttttccataatcacagttataacacttcaaaaatacatcatcgcccgtgccataagcccaaaaacgagcttttaatgcgtctttctgtgagtcgccacagactgggcagcggcagtttaacttgaattgggatacgttgtttacttgacgaaagcgaggtaagtgagataatgcgcgaaatgcaaactcattgtgaacccaagacatatattctcctaagtggccttatttctaaggccattatattacaatttcttaagattaactttaatgcgcttacgttttgaggggatttgttctggacccttgttggttattgctccggttgtggtaccagaggcgatattctggacacttccaccggaatcaccggctaccatgtcctcgaacatagggagagcatcaaatatctctttctgttcggattcggttatattgtatctagaagcgattgaagaccaagctgacatcatagaagctattccatttaaaccgggaacagttgacatcattcgcttcattgaacgaacagccgcgtgaaacggagtatacgctgccttttcttcaggggttgatggtcgtttaagcacgctgcctttttcgtcaatgatttttgcttcatatgcgttccattcagtgaatggtttttgcattagacgaataaacttatatgcataaacagcatctataccgtttttaatagtgctcataaacacctcctacgatatttaatcaataacaaaaacggctttatttccgtttgcgtctgttacttcataagtatcttcgtcatagagaggtataaaccattctacatcagtatctgacataacagaaataatattttctgaaatttttgtcatttcgtattcttcaaataaacgaaacacatcgatatttgtacttgtgcaagttgcagtagacatttagcctctcatttaaagtccaatccattccagcacttcaggaactgatttattttcacaataaagattagtgccagcaactaccaaatcattctggtcgacatcttcaatgagcatcttttgattcgcattagctccagcaagaaggtctttaattagcttaggttttaccgtatcccaatcaccttcgacaaatttaaggcattgaatagaattataatcagctactcccggagttgcatgggctggaactgctgaacatgatgctactaccaatacgagacttgcaattaactttttcattattactctccagtttgttgataaagtaatagtatcacatccttccatggatgtaaacggtcaactcaaacttttcattgcttcttcaaaagttaattttttaacggaaagataccgcgccgagctaattttcttaccattgctaaggacgaccagtgtcccgtagtcccatcctgataaatctattgagttccatatatcaacacatacttgtagtgactcatccgctactatgaacttctcgtgaccatctcggtcacgattggcaattaaaacataaatcaaaatttaagttcctctgcaagtgcgtccagcttagctcgggctgatgtctggtctgtgcgttgttgtctattagcctcggcttttcgttgctgagctccggatgtttcagtaactggagttggctgagttccaccttcctgtgcaatttcaacccagcgctgatttcctttcttaacgcctaccgcaaacttattccaaatatttttatcgccataacgagatttaatctgcttgatgagttgttgtcccatctgagcaagttcttctgtctcaatcacagcaagcatgaagtccgccgttgccggtaagccagctgattctgcaatgtcggacatattcatatcagaagcatcccatgcaccacgaccaacctgagccgcagaccagactacagtttctgattctactgccaatgcacggagttcttcggcaattgctttcactaaagtgtaactgttttcagtataaacacgaatacgacaagaaccacatattcctagatagtcaatcataatgatatcaggaacaaaattctttttaagttttaactcatttagtaaagctctaaatgtgttcgcattagctccgccggtaggatattgtttaatgattaaacgaccaagagtatttttatctcgccatttttccatcttacctttgtattctgcatatgacacattgccatcatcaatatcatccaaagatacatcaagcaggttagcatcaatacgtttagcgcagacctcctcggccatctccatggagatataaagaacattcttaccagtttgaagataatcagctgctaaagaacacaatccaagagacttaccaacgttaacaccagccatgagaatgttgagagtgccagtttctgccccgcccttagtgatacggttcaaaatattcatcaagaatggaactttacgagccttgttctgatacgctaaccaacgagcttcataatcttccatccaatcatgaccgacataagagtcaaaactaatagaaagagcttgacgcataatgtctggaattgctccaacatccggtaattttttatttcttttttctggcggtagttcagcgttcgtttgaatttcaatgatttttgatgttgcgttatacatcgcatgagactgtacatatttctcagtctcttttaccaaccatgcttggtcttctggcgtatctgctaatttatcaattaattttttagcttgttcagcttcagattcgcctagagttgaattgtctaatgcaatattcaaagcattgattgaagggacagattgatattcgttgatatgtttttgtaataagttaaacacatttttagccgggccatgttcaaaatattctgaatccatatatggccaaacttttgcgaaatatccttgattaaaaataagatgcgataatattgtttctaccacggtaacctcattaaaataatttgaaacgttttttattacgctcagctaacgcttgctcaatttgaattttaacacatttttcaacatgcggagctagttctgcttttctatcttcggataatgtagaaaaatctacagaaatttcgtttccattgtgatttattgatgtgacataaactatatgtgaagaaccatcttctaatgttagcaaaatttcttgtactatattagccattgcctttttgacaatatctaatgatttttggtaaactctttctgtcctctcaaattccccctcctgagagggggcttcttcgacgacttcaagatttaaatctaattcgcttaaatcataatcgtcttgtttcattattcgtccatcatagagtcaaggtcatcttcaattgctgccggagacggagcatgagaaccttcgggagctttgaaaacctcagtttttgaattaatcaatgcatcaacttcagcatcaacaaccgcattactatcaattgcgcccagttgatatttacgtttaattgcatcacggaatggttgatgcttgaacatcggtccccagaaatctacgcacgatgtagctgctgcgcgccatgatttttcttcacgaaccatttcaccggtttcaatgtccaaatattcgcgagcataccaaccattttttggtttaactacaaacccgagctccaatgccatttcaagcaaaccagaatacgggtcaataccaccgtcaaatttaacatcaataaagaacttagatttctctttaactgtacgagatttttctgcgtttaaaacaaactgataaccttgcaaatcagtaccgtctttaatctgacgtttaccaataataaacacggtatccgcagaatacatcggaccagtaccaccggtcattaccgttttactgaacatttcaatagtttcaattgtatggttaactgcaacacatggaatgttcttaatactgaagtatggagtaacgatacggaacagagatttcaatgctttcgcacgggtcatatctgcgaccgatttttcgttcaacgcatcttcagtttctttcttggaagccaggttaccaattgagtcgatgaatacaataaccttttcaccacgctcaatttcttctagctgatttaccatatcaatcttaagttgttcaacagactgaacaggagtatgaataacacggtcagggtcaacgcccatagatttcagataagccggagtaataccgaattcactatcatagaacagacaaattgcatcaggatgttttgtcatataagcactgaccattgtcagagacatattcgatttaaagtgctttgacggaccagcaaagattgttaaaccagactgcataccaccatctaatgccccactgattgcaatgttcagcatcggaattttagtacggataacgtctttttcgttgaagaattttgacttagttagttccgcggtcattttagaagtggatgctttaatcagacgagattttaaatcagacattcattttttccataagtctccattatatttttctcataggtttaaaggatagagtaattatatcaaaacaaatttaaagcgatttaacttttattacgcacttaattggtgagttgaccattgattttcgaggtttagacattttaacctcaggcacatcctcagttcttttaatccaacttttgtatggacagtatttttctttcttggtcatgatatttccggtttaaatttttgaaagaaggtacactagaagtataccttcgcgaaaatttttaaacttacaggtcaatagccttgcggaactcttcttgccaaattggtttttcatcaagatatttttgaagaattttgtgctgatatttcaaagtttcaacacggaactcttcatcttctttaatcttgttgattttatctactaattcttgacgattactcacataaaagaaatcattaccttccatgatattcatgtcagggtcaaacgtgctatcgaagaatgccactgcagtagatgctagagcttcccatacacgaggagtgatttggttgttatcgtaggttttatcacctaatacaatagtagcatacgcggttgagttgcgttgaaccatttcacgagagtctactttaccggggaataccggcggagttgtccaaggaaattctgggttcttgaactgttctgctttcactgaaccaaagaattcaacatccaatccagtatcaaataggtattcaatcattttagcttcacggttaccagaacggaaagtgccgccataaatcaggtctcgcattttgatgccatctgcggcaatcttaaagacactatgatacattttatgacggtccaaagcaaaatgaacgaattctagtttatcggataaacatccaactaaacgatcagaatgaattttcttgcattgctctagatttcttccttgagatacaatacgcattggagatgttacaatgaattgttcttctttatatttactggaccatttctttttagacatccttcgccaagcttgctcaaacggaagacgaatatcggtgaacaaataataaatttttgatttatacttattcatgaacatataagcttctttgttcatcttattttcttcgccgccatagaagttcagagcagcattaacgaccaataagcggtcatacacattcgggtcttttactgaatcgaaagaaattccatactgtgtatttttcattgaaataaggtcaacatcaagacccatatcttttaaacattcggacaaataaattgtttctgaagcaggggttgttttaaacccctggatgttattgcccatattaataatagcaattttcatagtgtcggttcaatctcgctaaatttatgaaaagcatctgacttctgctttttagcaacacacatacgaagtactttcaaaggttcatcagtaccaaacatagttttggttgggtcaccttctgatttccaccgagcttgagttgggaagtcagcatgaattttttccagcgctctgttctgtttagcagcattacgcatagatgatacaccgcctggagcttgtcctttacctgatttaacgagatatttaaaaatcgccaaatgaggataacccatattaatgagtttaagaaacgcgtatgtatcttcggataggtctactataccatatccaatgtcatcggcagaaagtttgcttaaatcataaaaagtatttgtaaacccgtaagagttctcacggaaatgaccccatttagagtcaatcttgaatattggcaagcgagcgtgaccatgataaaagccgcagtccatcgctgtttcaacataaagacaaagattattaaattcatcccaggtcattccaacatcatggagaatgcgccggtcatctttttcgcgaatttccgttgtatgaatagtagtatcatcatccaacatccagatgcgttgtccttgatacatttcggtaattaaacgacgagtaccagcaatcccatttacatcatccgggatagttactattttagcaattgtgctatatcgagtttcgtattcttctttttgagattcgcgaactacaagatgagcgacataacctttagggaacatgtctagggcagtaactgccccgacacgattataacttggaattacaaattgaatcatttccaataacctttgtaatctttctttgatatatgagtttcaccagtatggtaaaaatggtcaactagatagaagtgacgagaataaacatgcaaactacctacgttccaaataatgtcaccaactacgtattttttatcgcggccacagttaagtgtttgtactaataattctaacacatgtttttgccaagcatagtcatttctaaaaccgaagactacatcattgcttctcatactcacaacagcatgaacttgctcatcgcgaattaaatattgaaccgtgtttgtacacatgaaatcactcataccgtcacggttataatcagtctgcatacttggacgagtataaatcataattccgcggcgagaatctggattgacactcagttcagccacacaacttgcaaattggttataattatctttattccaaattgcccatccgtagtttgagttaatctcgccgtttttggatgaaatctggtcccaaattgctggagtttttcctggaatgtctttaacgaataaactttgagacttataccattctaattcgcgggctacatattcatcattaactgaaccaaaaataagttcttcatctgcaataaaagatgcgccgataatttcaatagtttttacgccagttttgtcaataacaaactcttcattttcgagagctacagcaaattcctgacgaatgtcttgtactgtcaaaggtgtgataatcattttgcctctttaattacgataatttgttgaggttggttattttttcgctcggcgacgaatgcccaaattaaagcaaccaaccatccaatgaaagtccaaccaaaaataagatttaaaaagaaaattccaacattagattttgtcccacgaagaagagcaataatccacggaagaaaatacgctaaaaacgctaagaacaatgaaccaaaaccaagtgccgctgtacccaatacgatagtttccattataatttcctctattttatcaaatgatttatttagcgtttttagccatacatttattaaaagctttcacttttccgcctgaacgataatgaataactgccagacgagttttattatttggatttttgaagtattgttcacgaagaacttcttcatgagcttctacaacaaattcacacattctgatagctttttcctttttatcgagtgcagcttgacgttcatcgccttcagctactgattttttaattgcagcttcaagcggactattcgcgcgccgttcttcaatttctttaatagcgttaagagtttcctgcgagacttgagaagttgcacgagtataaaccattccagaagctggcttataaaccaaattaccttcacttccataatgtggttgcgaataaggttgaatagaacaacctgctaaagtagttgctgctagaacaatcaatgatttcaaattaaatttcattttattttcctcatttgttttgatgagataatagtaacacatccttccatggatgtaaacggttagaagtcaaacatatcttctaatgatgctttctcttcgtagtccataccagcagcctcacacatgccagtcaaaggtttgacaaaagacttctgaaagagcgtagtgtaatccatccaagccaatacttctgaacgaatttcctgtggcaactcagtaccggatggccaagcaatacacttatcaccaaacgggtttccttcacgcaaaggaacaatcattactttattcccctcaagaattggagtagcgctgaacccagcagtcgctcggttgtaagtcaaagcacctcgaatgtggaacggacacttaaatccaggccatccgttatcatcatacttggcgatgtcattacatgtcttaacttctgcaatgattttgtaatcaagaccacggtattctttttcaaactgtttgtaatattcttgtactgatttttcaccttcttgaagcatacgacgaatactttcttccaatgctgcctgcaccgcctttggagtagaagattgctgagtttccatacccatgatttttagatgcggctcagtgtaacgagtatcttccatgtcatatacgttcaatgcataacgtttcttagctttccagaaaccgccaataccctttgaaccaagaggaggacaagaaatagcctcacggtccatatgcattaagtgttctttattattcatgtactcgcaaagctcacggtaagctttgtcaatcataggttccatttttttcttaccaaattggttcatgaattcaaccaaatcattggtatttttaaaacgctctaaacctactttttcaattactttatcaacagaaacgtaaactgagtcagtgtcgcctgccgctataaaatcttcatttgttgtaccgcatactcggttaagatactcgttaatcttacgagcaatccactggataccaacctgaccgaacagagtgatagcagtcgcattacgaaggtcaaaatatcggaaataaatgttaccgagagcaccataaagactgttgatgagaattttacggttcaactggtttgtattagccaaaatactcgcaagttcacaatcatgcagcatcgctttcagagctgacacacttaacctgtagagttcattcttcacttcatcgctaaaatctttataacgctcaacctgaattttaccgccagttccaccggattttgaagcgataacagcattaataacttcgatgttacggttttcggcttgctgctttttcttccaatctttacgttggaaaaataccttcgcaatctcaaccgggataataccttcacggtctttgtgatacatccaaccatttggtgaacatgaatatgtgtcactaggacgcggtgctgttccattgatgtattcatgaattggatgaagcttaaactgaccagcgatagtttctggactgatattcacttgacgaatgatacttggataaagagacgtcaagtcaaaactcatgatataattacgagcacatgcttttggttcaaatacgtaagcacccgggaagctctgcttaacatgcgaacgtccttgcggaaccactcgcttatcttctttgagactattgaaaataatagcatcccaggttttaatcgggctcattacaccgccaaaaggcattttagcgtaataagacatactaattgctaggtcgatgaacccacgaacttggtcgataccttgcaccgattcaacgtccatgatgttataactaatataacgttgatggttcgtttcacgcaatttgttaatcggaccatcataaggcagtttaccttttttggtctcatattttgcgacataatccaaagtataagacggttggttcgtgaaactgtactttttgtacaaatccatgtaatcaagaatagttacgccatcaatgctaaatacttctttatcaccatacatgttagtgataattttagatttcacgcgattgattggtgaaaaacgcttcatcgaacgttcacctagaacttgcttaacgcggttcatgatatacggaatatcaaaaccttcaatgttccaaccggtgaaaattgctggacgcttttgttcccaaagacgaatatattccatcaatagttcggcttcagtttcaaacggtagataaacaacccggtcaagaatatcttgcggaacttcatcgccgccgtctgcttcgcaccgagctgctaactttttatcccatttggatactgacccatacaacgaatggagtaaatcaaagacataaaatttgtcatcaatggaatcgtaatgagtgatagcatcaatttcatattctgctttcatcgggtctgggaatttatcgccagtaacttcgatgtcacagttcgctacacgaatgaattttcggtcataaacaatttcggaaccatatgtgtcactgatatatgcgagtttaaaatcatccattcccattgcttcaagaccgacatcttccatgcgcttgaaccaatcacgggcatccttcattgtaggaaaattaattggttcgcagtcctttccatagatgtctttgaattttgatggtttatcaacatgacggaacagagtcggagaatattcgacgcgccgagttttttctacgccatcttcaatatatcgttcaacaatatcattaccaacagtttctacagatacataaaatttcataaggttccttagtttttccagtggtccgagtgattagaccttgggtgtattatattctattctttgaatagcagaaaaggcccggaggccttttcattgagttacgcgcctatagtatatttcgcgataagtttccaatcgtctttttgcttaaatgtgatgacgcggaaattattttgcatagcttgcagagaacctctgtctacgagttcgattaaaccccaatcttccaggagttgagcaattgagtcgcggcggataatatcttcatcatcaatagtgactggccgtccgtccagtttaagcatctctttaaaatgaactacataataaagaccctgcttctgtaagatatgacaactttgatataatacacggtctctgttattagcaatacccatacgagtaagagtttcttttactttcaggaagtcttcaggttgtttcagtttaatttcgatcatttttaccattccaatgcttgttttttaaattgtttttgttctttaacatttttggtcacgtctttcaaaaattcatctgtgaccaaccctttggcttcttttaatactacgcccaatttacctttgcgttctagggtttctctataaacctgagcgtcatttaaattaatagtataatatttcattaataccctgagaataagtatctcctgggtatcctctattaacttagcccacttaccaaaacggcggccttgaggaacagcagctaccatatagttgaaatgtgcttcatctgacagttcagaaccgataagattcattgtataaactgctgtcatgcattccggatgttgcgataacgcattttcaaccatgaatttgttatattctttttgagcgatggaacattgtttcttttcgttaattgcgccgattatttcaaaaaattcattttctgctttctgtttgaaagtatcagccatttcttgaactttgttccaatctttagaataccaagctacctgatgctcattaaattggacgtcatcatcaaataaactcattatttccactcattattaagttcagctgttaaacgcaagaacatatacatcacatgaagttcagtatttgaggcaactcctttgtactggttgttttcaccaataatttcgtacattgccattataccaggtcctttaagcatagagtataattcttcggcgagtttacctacaaaccaagagtaatcagtagaatattttggagccaaagccctaagctgtttaacatctcgattttttagagcatcaatcacatctgaaattgaactagagtctttagttacaatactcagaattccagcatccagaacgcctttggacgaatacatatcaagttcgccaatagtcttacgaaaatctggaaagttctttttaactaaagcagcaacaacttttaaatcggcgatttcaatgttttcatttttacatatttcaaccatacgacgaatcatctgtttcatcattgttgtacggtcttcttctgttgcttggccaaatttaattactcggcaacgcgaacgaagtggttcaataatgccgtcaatattgttggcagtaataataacagaacagttacttgaatatgcttctaaaaatgaacgcaaatgacgctgagattcagcaagtccagaacggtcaaattcgtcaataacaataactttttgacgaccttcaatagaagcagaacttgcaaaattagttaatggcccacggacaaaatcaattttacaatctgaaccattcacaaacatcatatcagcatttgtgtcattacacaaagcttttgctgtagttgttttacctgtacctggtgaagcagataccagaatcatatgagggattttaccgcttttaacaattttattcattgtttcgcggtcggcggcgggaaggatacattcttcaattgtagaaggacgataccgttgttcaaggatgtgttctttttcgttaattgtaatcataatttcctcatattaatattcaaagcaatggggccgtaaccccattttaaatcattttatttacagcattaaaaatcatgagtagaatcagcttccatagctactacataacttgcatgttcaccttcaaacttagctgctgttttcttaccatcagcccacagcatcaatttgtatgaagcgggttgcattttcatattagccatgttaataacaaagttaaagttattggtgccgtcatagtcacccaaagtcaaagaatattttacacgaaccaaagcagaatcttcaactttattataaccattcagaataattttaccatctttgttagtgaatgtgatggtatcaatctgcaaaccgcgagaaactcgcatcagctgctgaaggtcttcacctttaaaatctacaataactgaagcgaccgggaacggaattggtttgctcggaaaaacaatggtgcttgggtcagctgctggccagaaaatagttgaacgagcatctgcgattttcacattaccatcatctgccatggaaatctctgcgtcttcattgaccaaaccgagaatacccagaaaaccattcaaatcataaattgctacttcaaaatcaattgtgtctgcgatagttgcttcagcataagttgtgccgtttacagcacgtgtcatgataaagttaccctgcttaagcatgataccagagttaatagtagagaaatttttcagaatattcagagtatctttagacagtttcattatttttcctttcaattacacgtttaataagatttattatattacttaaaagtttttgcaagttcttcgataacttcttcagataccagcaaagcagcagaaatcaattgttcatcagcgttaacacagaaatcatcttcaagacgctcgccaccaatacggtccagaacaaatttagcgccggcagaaacagattcattgtaatgcttccgcatcagttcaatccatttatcatttacggtgcggtcaattgactgataatatgcatggcgcgcttcagcaatagggatacgtttgcggataagttcagcaccttgttcacccatagcaagtacccatgctcgacgaattttgttttggttattagggttagagtcagtacgtacatttttaggctggatatctttagtatcaattgcaaaattcaagttcataatatttcctattcaattaatcaaagtattctattactgtccaagcggtgttgcggttagacattattttaacatattcgtctttaaaagcatctctgagctgtatttcagtaactaagtggtcttcacctgaaaaattattagtcagtatatatcttttaatttccggtacggccaacagctgttggccatttttaaagtctgtcatttttccattaccgtgaatctgccaactttcttcatctgaagatgttgtccataatcctgcgggtcatggtctttatggcttatgataaagatattactatcagtcattccattgagaattgttcctactcgcttaataccttcattatcaaacgcgccatcataaacttcatcaagaaagagacagttaattttaacattagaaactttttcagcaatgtctcgccacgtgaacagcaacgcaatatcaatacgagctttttcgccttggctgaatgacgcataactgaattcttcgcgcccgcgagatttaatagtttcggtgaattcttcgttcaaagtaaagacataatcagcttccataattttaagatactgattaatctgtttgttgaacatcggaatatatttgctaataatagctcccttgatacccgaatctttcagcatttcagttaaaatgcctcgatgatatttttccataaccatattggatttggtatcaactattttattcaattcttcgttaagcgttttaatctcatctgcatgattgatgaattcttttgatgctttttcaatcgccgcttttacttttttagccttttctactgttgaaattaaagtttgctttttagattttatgtcttgagcaagttcacgttgcgttctaacgttgctctcatattcatatactagtgtctctagattggctctatgactttctaacgactctgatttatgtttacattcattaatcttatcgttaatctgagtgactagagatgacccagagtctaattgttgcatgcatgttgggcatgaacctccagaatgatacaaagaaacaaccttattatatgagtcaattttagacttaatcaacagagtttgattaccaatttcagtaaacgcggaccgagggtcttcatcaagcacgatagatgttaaacgctcagttgctttttcaatttcggatttaatagaacgtgcttcagtcgcaagttcatcatacatggtctgaaaacgagctatattttctcctgatagctttttctggcgttcaacgttctcttcataaattttaatctgttggataattccgtctttctttgcgtccaacacagagacttgtgaattaatttctcttatatgagatttattcaatttatccatttcagctaatgtagaaacttcgagcaagtcttctactaacttccggcgagctggagtactcaaacccatgaacggtgtataaccagctgtaccaagcacaactacttgcttaaagctggaataagacattttgataagttcttcaaaatagctttgaaaatctttaacagaagctgcctcgtccaggcgaactccgtctcgagttatttcaaagatattcggcttttgaccgcgctttatataaaaatgcttaccgtcatactccatccaaagctctactaacatatcttttttattaatagagtttattagttgacctttcttaatatcacggaacggtttgccaaataaagcaaatgtaatagcttccagcatggtactcttgccaccgccgtttttgccggtgatgagagttttttgtaccttatcaagttgaatatcaatgggcgaaccgcccactgacataatgttctggtacttgatgcggtttaacttaaatgttttcatgtgttattctcgcgaatataattgcggcaatattccagcataaaatcttcggatatatgcattacatcaaaatattcttgccatgatacacctaatgaacactcagatgtaacaaacattatgcctttaaacccgccgtcttcgggccagtattcaatattaccataccaaccattgcctaaattaaattcatgaagtttcacgagttttgaacctcgatataaagttgattagcatattttataactgcttccctgtcatcatcggataaatcaggtaaagagttaatatattcttccataagttcaagtaagcttttaacttctacttcagcttcttcatcaacttcaagagaattatcaatctttgaaacggtacgaagctcatgaacaactttttcgagttcgctttcaaattttggaaggtctttatcaacttctgtgataatgacacgaactgaaatatttttgtaacgattaatatcaaatttacccttaaatggataaattattttttgatgccagcatgtttcgttttcgataaaatcaaaactgtcatctcgagtgtcctgtatccagaaacctcgcgggtcattttcgtctcccgcagtaagtgtccatggcgtgccaatatatttgacattagctgcgctagagatagtatgaaagtgtccagaacgaacatgtttatattttttaaggaaatcaggttccaacccgtgggattttagtcctttgtaataataaaaaccacttaattcccaatgaccaatacaaatatcggcatcagatgttttgatgtgattcattatatcggacgcgttctcttcgcacatccacggaatcatatcaatcaaacaaccatcaaaatctacagtttcaggagtatcatgaattatgatatggtcatatttacctaataactcagtgattgcattcggatgcattttgtttttatagtgaagatcgtggttacctacgatggtgtgcatcgtaataccagcttcacctaaagaagttgctatctcacgagcaaattccatagtcttgtgagtgatagctttacgaacgtcaaaaatatcaccatattgaacccacatagttatcccatgctttttggagtattcaatcttttggcgtattccgtctcgttgaatattctggagccatgggtcatcgcccttaactcctaaatgccagtcacctgtatggagaattttcatattttaacctgtacaaaaatgataattaattataccatgtatataaaaagcaaattagtacgcgcacaatatttttgaaacgtttgactggttaattttgtgaataaactcacatttttcttctggcgataattcgtgatttctgatgagtgccgcgcaaggatattttggtggataatctttctttaaaactaaaagtaactcatctaaatatccgcaactatcataagcatgccgaagtttaacaatatcaacatgcttaatgcgttcaaaatctttagagctttgtactgtacttcgccaatgcacttcattatctttagtcgttggagaaatataaactgcaactcttagttcagtgtcatttaatttaattttttccattattacctcaaagaacaaagggagcctcggctcccttaaattttacgatatgttatagtattttcagcttttgctttatcgtgtaacagtttgaattgtgacatcattccagacatgctgttatgtatttttgtataatcaacagtcttctttggagtttctgtcacgatttttaccatttccaccaccgtttaacttgaaaagtatcagcccaaactaatgttttttcatctatagcaatctctgaacttttagttacaccatacggaccaagaattttgtatgtgtttttagaagtttttagagccattgttccattaaccatagatagagtgaaacaagcattaactttaagacgtttgaatttaacctttactattgccatttacaatttcccaaatctgtcgacgagtggtttcccactgtactttgacaagttcatctgtataaggttggcgtaaaatgtcccgagatttctcgatagcatatttgtacgccgcgaagttattttctagtactgctctttgcgcatgctcatttaaacgtttaagttcttttgcatgctttttataaattttcgctgctttagcgttagcttcttgacgtgttgcttcttccattcgagcgataatttgttctacttcttctgggttttcatcaattttattgatattatcaataatctctggagacatttaattaccttattttggaaaataatccaatgaaaaataaaatccgtcgggagatacaacatattgatgaggaacttcttttccatcaacaataaatgtaatatcgtgcggattagttgggtcaatatgaatatccatttcaagaacttcccttaaatacatttttagtatataaggaatagcttctaattctggaatatcttcaagcattcctgcgaggtcaatcttcagcctcatataaaaaatccaaattcggagaatcgtctacttcaacactctttttgtcagaccctggtgctttgtaggtagattcttcataatgcgtcattttatcgtagatgtcctgaatgaacgtttcatctgctaacgcgaccatatcatcgtcacgactgtcatagacattgtgaacaaaatagctatatttctttgccatctctttgcgttcttttttgatacgctgaacgaaagcattaaaacaagcctgagttatgtatgcatgtgggtttttgtatttctcttcgtcaaagtttttgagacctttaatagcagcctcaactccatcagaaatcatttcatctttccatgattgggtgtatcctgaaaagttaaaacgctttgacaatccctcggaaataagcataatagcttttccaatagtgtcattctgacggacaagcgttccttctggcgcttctctacatttttgtttccattcacatattgcgttgtaaagctctttgttgtttacatagtcagccattaatacctcatcgcctcaagtttatatatacttttattatatcatatttgtgggacaagaggttatttgctaattagaagaacgaagaatgcaatacatctgaaaaagttgttcaccaatttctttaaattggtcaaataaaagaaaataagctgtgtatgaatacaagtcattatcttcccaaaaatcgttgaaactattaaacatttcggtataatctttttggttgagttttgaagcatgagaatgccaatatactccaggcatcacaccagtttcaaatttaattcccatcatataatcaacactaaaaataccaaaattctcaataattaatttaagttctgttcttttcattgctcctcacatgtttcggcagttaacttcaaattatcagatttttagcagcttctaaagctttatccattgaactgaatgcatctaccgagtgataatctttacctgtgtattcatataaccaccaggcgtcaaagtcttcttcaataacgtaaccaacaccgttcttcgaagtaccttcaatcatcagcctcccatcttcaacagaagcatcaaatcccgcgagttctaaatctgcaacaatttgttctttattcattcagatattcctcaagctcttttcttgttaatccttcattccacatagtagaaggattaggacagtcagtgttgctagtactaataggataatatctcatttctttaccgagagcatacagacatccaaatgcttcgtaataattaacagcttgttgagtttcaatccgttcgggcaatgaaatagcctttgcgcctgtaatagtgggtttcaagtaaactgcaataagtgctatgccttcgccgaattcgctcatttcgccgccttaacaattttgaggtcaacaaatcctttcttgcgctgatttttcattttacgaatagtgcgttcggaaatttcaggttttttatttgttggaataccaaaagcatctagattaaattcatcaataatatagcaaacaatcaattcgcgaattcgagcttttccaatcttctggtcgttctctttcatagttccatgaagagcagtttcccattcatctaaaatttcaggcgtgacaataacagatttgaattcaccatcaactttcatttcttcaactttagggaaaacaaaagagttcagaacgtttttgatagcttgcgacatgttattttcctcattggtcgttagatgtttgacatagagattttaaattaaaatccctatagcaaactcaactcatctgtatgtttttagcattatgaacaattttgaaattatccttcgacataccaacctttatcttgccacgcttcgcctttataccaacgagtcatatcataaccgccattgtcgcgaaccgttccattatcataaatgaaatactcatctgatgtgaaatattcatgacgaatacacttgccggtaatttttgaagtcatcacagcttcttggtaagtcattatgcacctcttacagcatcaatcaattctcgtaccacagtatccaattcacttgtgtatacatccggaaccagagctttaatacaattactcattcgtcccgggtagtgttgagcatgattgagcgaaacatctgtccgacaacccttcgcccggaaaacaacttcttcgtcagagatttcaactgtgagtggcactttatcggtggatgaagtacgaataatcatttcatacttaatcatactcgttttagatacgataatcatctttaactccatttgtttggtatgaggtaatagtaacacagtttttggaggatgtaaacggttgatatgaaagaaaagagggaccgctagggtccctcggatttaaagtcaatatattatattagaatgatacaagaatgggatagagtatcactcttcgtccaggttataacctaagacgctaagttgttctaataggtgggatttgttgcgtattctttggttgttcaaaaagacgataggatatcgtagagctaaactcggataactacctacacgtttagccgcttcagtaattcggtctctgtcatagacaaatccaacttcgttttcgtttggaattattacatcgtaaaaagcataagggatattttcatcatccaaagttttacgaattgaatagcaggccggacaccggcctactgtctcaggaattccgtatatttctatttttgcagacatcttatttcttcaataagcgcttcaatttgtttaagtttatcttcaattgaagctttggaggttgattcaattatgtatttctcgtcaacttcatatagaacatctttgtcgtagaagttgaataaacagctttggtcaaaatcgtccgcgtcaaaaatacgcttatcatgactaagaattctcatgacttcagcatgttcaccatacccatttaattctagtactttaaatgcgccgcctttgagcttgtcataaagtttttcatcaccttttgcccgtcgcgcagataaccatttgcttacttctgccgggttataagcgtaccattgacctgctttgaattcagtaatcatattaatattgtccaaagaaaatgaaagcataaagagcagggaactcttcactaaaacgctcaatgtaactgtacatgtacacttgaagttcatgaatccaaggatagtgaatctgcatttaaccattcctcattgtgttgtttccatagccgctggttatctgaaccacgccatggcttatcagttgggttatcttgttcatatttaccatcaataataacatcaatgtattttagcaattcaaggtgcttgatgtcttcaaacttgtaaccagtccacatccagatatcttttttgggaaaacgcgctttaacccatttaactagagcttcaatatcttctctgtttcctcgataaagagggtctcctccagtaagagtaagtccttggatgtatggttttgaaagatgttctgcgatttcttttactgtattagtgttaaatgtctcaccgttgcaagggttccaagtgcttttattatagcatccttggcatttatgaatacaacccgtaacgaaaagaacgaccctgcaaccagggccattcacaaaatcgcatggataaattctatcatatttcaatgtgttttgtcctatgcatgatttctttattcttacctaggttaaatcctcgatcagaaggattaccgagatatccgcaagtccttctaatagtattcatcttcttaggattagtctcgccacaaacagtacattcaaatccgttttcagttggtttcatttcatgagttgacccgcaactcaaacatttatcaactggcatattaacaccaaaataatccagtttttctacagcataatcccagactgcttcaagagcttgaatatttctcttcatatcaggcaattcaacataagatatgtgtccaccctttgcaatgaagtggtattttgcttctcggtcaattttttcgaatggagaaattttttcttcaactgaaacatggaagctattagtataccatcctttgtcggttacacctttgactattccatgttcggctgcgtcaattttacagaaacgataacataacgattctgccggggtactataaaggctaaaagcatatcctgtttcttctgtccattcgcgtagataatcattcatgtgtttaagcactaattcaccgatgcctttgtgggtcattagttcaagctcgtgaattccgatatatccaagcgaaatagaacttctaccatttttaaacaactcaatgatttcatcatctggtttcattcgaacgccaaaagctccttcttgatacagaatcggagctacagaagcttttacaccttttaacgattcaatacgaagcagcaacgcgtctttacaaatcttcattcggcagtctagtagacgcatgaacatgtttaaatctgttttgccgttgacctgagaatccaaagctatacgaggaagatttaatgtaacaacacctaaattattgcgtccgtcaagaataaatttaccatcggaatttttccatgcgctcaaaaagcttctacaccccattggagatacaggaataggagaaccagtaatcttacgattatttttggcgctaataatatcgggatacattcgcttagaagcgcattctaaagctagttgtttgatatcataatttgggtcttcactatgaagatttaaaccttcttcaacgaacataaccaatttaggaaaaattggagtaattccatgacgacctaatcctcgaatacgatttttaagaatagcttgttgaattagtttttcttcccaagatgtccccataccaaatgtaatggtaacgaaaggtgtttggccgttagaactgaaaagagtattaacttcatattcatatccttgaaaagcatcgaatacatctttttctgttttttcttgagcgtataattcagcttctggaatatgatatcggcgagcgtcttcgatatgtttgttgaaagttgcttctacataaggagctagtacttggtcgacattagcaaatgtagttccaccatattgatgagaagctacttgagctgtaatttgagccattacggcagttgctacaccaattgaatttgatgtttcaatttcagcattaccgagtttaaacccattttgaagcattccggctaaatctactaagcaacagttagtaaacggaagcgatggtgaataatccatgtcatgaaaatggataattcctttatcatgagcatctagtatagagactggaatgaccttacgggcgacatgcttagaaacaatgccggccataaggtcacgttgggtgggaaatacccgcgaatctttattcgcgttttcatttaaaaggtctgtattagttctatcaaacagacctttgatttcagtttcaattgtcattttaagcctttctttaaataatagacataatcttcaagccattctattgtcaatagaatttcttcggggctttttaaattagcctttatttctttaaaagaatttgtcattattttagaagtatgttcaattttaatagtttctactaaatttaaagtcgaaagtctctcaatgtaagactttttatcttcaatttgtaatttaataatctcgccagatttaacaaatttagaacagcttccacgattagaaccaaagaattcttcgacttcggaatttgacgcaaactttttaccagtttccacatgttgaaacttccatcgctgacgtcgaattgaaggatgtagtgtccatcgatcttttataatatcaagttttccatttaataaatttgtaatatgagacgatgaaatatcattttttcttgcaaattcagcttgatttattacttcgatttcgcacgaatttagttcatcccaaattttaaatttagaaacagaatgatacactgataatttttcttcctttgagcgaccaaattgccagccagaatctaaatacttttgaacatcatcgggtttaacatatttggttttttgaccaattttatacatcatcggccatgaaacatgctcatttcctttgtcaaaattcatccatcgagcaatatcttcttctgttaaatcatcgaagcagttagggttaaaatgcccgccaatttgtttgtttaaccacatagggtctcgtaatacgtcattagcaagttgcatttccatttcagccattaaagttttaccccaagttggataccatccaacaattagatattctttaggctttataccattttccaacatcgaattcaattcatttgatgaagatgtataagtcttccaatctgattcttcaaatccttttttaggaccgcgtttaaacgttgaaggggcagctttaattcttttccaaatctttttagcgcctacatactttttaccgtcttcaaacgtgattacataaacaaatccaatattatttttaatatctgtttcttcaaaaacagaccaatgaccataatctgacattataaatacatcctttttactaatattatgatgtatttatacaataagctaaaccattaatttatctaaattatagagccaatacgtccttgcccatttcttacggtttcggatttgagctttagtcggcttagtagagaaccaccaagaaattttatacccatcatcttcaataatttcaaaaactttattcactaaactcatattaaattccatcactttttagtattcggagtatcaaataatgatatgctacaatccggatttccagttatatgacaacttgtaaatagagcccagcggctcaaagcatgtttacctaaaatttttctagacctgttattagattcttcattactgagagtcatattaagtcttggaaaataaacagaagttataccagttatttctccggtgtcagtaaaactcgtatagcatttggaaataacaatttcatcgccagggataatacccatatctttgaaatagtctatcacatcaccaagctcatgcttaactttaaaaacttccggttttactgtaagtttaagtccagttaaattcattataatttactcaattaaaaattaaacaagcgattaattcttttataccgacgaattaatcgcggagtcaacttagaaacgctcaaaaccgtcgtaaatgttccgtctttgttagatataacgaatttccatatgcaagaaccatctagctttttgtcatgaataattttagtattcattaaagccctcacaatctagcatctcgttcatcgtgggttcattataacatggttcttcatctgtgtaaactggttcttctggttcgggctctacggtttcccaccgagctgcccaccatggttttaaagcgtaacccattctgtgattgtcctcatcacgacgcgttcttgtttttcaacaagcgaaacatcaggttcattgtaataccaatccgaatgatatgaacccgaacgagtttcatttacagcaacatgaacatcatgctttttgctgtagtaaactacctgtcggtattgatatttgtggtcttgaacccagtcttcggcttccactttttcgagatattcagaatcgtcaaaatcataatattcgttatacccatcatggtcttccatgatttctttaagaatatcagtttgtccaggagtcattattcacctcgtaaatgattaagctgttcgtcatcaacccaactctcaagtccagatggcaggtcgcattcaatctgccaaagtaactcttcaacttcgtataaccgaaagagctcttcttgtttaataactgcttcgtcgtcattcaattcaatcgttttcattgtagtgtccacataaacttaaaaagattttcttggaccactgcgtcatcccaaccccagacattaatatcttctgctaattcagttggaagaacatcaagaacctgttgagcagtcggagctgatatacaaattcttttggcgcatcggctataagcagctaaaaactcgtcatagttattaatcataaagtttcaccatacaatcaccgtatttccattttgacataactttttcacccgtagagtaagttacttcaaccttagctcgatgattttttatttgaacaattcggccggtttcaagaccaccgtaaccataataaagcgcaattatatcattaacgaaaagctcctttccgcgataatcacgcatgtaatcttgaccttcaaccatgcgttctatcaccgaaaatactcgcgcaatttatcaaaaccaccaatataacttccatctggagcaaatatttgcggtacggtaagaccgatttgtgtatctcttccaagacgagtcaaaagttcagcaataatttcatcgtcaaatacacctttttctggcatgatattgatgaattcatatggttgttttttaacatccagaagacgtttagcgttatcacagaatacgcatttatgaatgttgctgtcgtaaccgaatactttgaacattattttacctctacagggaatacttgagctaattttgcggcaatagctttatcaataatttcgctaaaactttcgttcaatcgagaaacaatcatttcttcatattgtcgttcattaatcttaattgcatcagcgatataattttccattcgtttagctgctgcgtctaccgagctcacaagtgagtccaaaagttgttcatgcgctatacgttcagcttcttctttcatcactcgtttgagttcaactgtacccttaacattccagccattacgctcaaaaaacttctcgagctctttgcgaaccgcatcttctacgttaggaatgttagaaccctgaaaagcaatttcagatttaactgcttcagcaattttatttttggagtccttaacaacaagttctttaacaatattgttaatcacggattgttgtaaagcaactcgcattgcagagccttcagggaacaactgacgaactgcgtgagtatctaattttaaatcaatcattctgtaataacctcatagtatgcgtcgctcgccgctagataaattctgtcagatatatttttatacggatttttagtaaatttttgatttgctttatgtttaaaataaattacatcaaaagctgtagccgcgttaatacagttatgaataaaattaatatcagttttttcgccggcgtcaatagtgtgttgtacaataatttcagcgtgtaatttacgaagttctttaaaaagagacttcatttcctctgattcgcacattgcgtcagatgaactaaagggattcataactaacctcaatatcaaatttaccaatttcacgaaaaattaaattcaacaaatcctcttcagtaaaattggacgatgagcagcaactagcgaatggatgaagttcattatattgtacaccatcaataactacatcgtatccctcggctgaattccagcaacccagatcgcaatctccactatcagcatacagcttagttacttcaattttcatttagcacctttgtaaatttgtgtttacatttacggcatttcattttaagaactttagtatgccaattaattaattgaacttgattggtttcgcattttgggcaaggagtaacttgtttcatggaccgttcacgacggtccgccatttctaatacagtattccaatcaatttcaaaatcttcttcattttgaactaaatcttcttttaattggttccgcataatactgcattagcctctttaagtttctgtgattgttctttaagacgtttaagttttaaattagacttcttaattttatcacttaaatctttttgcactgatacttctttttcaatttccactttaattaggtcaataaagtgttgaatttgattagaaacatgagtttctaccaatacgtcagttgtctcaaactgcattgtcggagaaaatttattataaaccaccggattattagcgtcaatgcgccgtgaataagttccactaatagtatctttcatatcttcagtctctttcaatttgatattaattttaattcttgttttacgttttgaatcgccataattaatatcgacattaacatcttcaacataattcatatgctttaaaccagcagcaaattgttcagctataattctagaaacattatcagactgcccaatcatcattttaattgaaaattgaatatcataatctcttaaaggagacgtagttacttcagtttgaacatatctcaaccggttgataaaacactgagaatattcatgaattaaggttttacggccaagtgtaataatttgtttgtattcactctttaaagcattaataaatttgtatttaaaaatttcagacttttcacaaataatttttcgttcactcgttgaatttctttcttcagtgaacatattcaatgcacttaattccatgaatgagcgcaagcgcatcactgacgtgatatatgaagttattttacaacgagtcacttcttgaaaaaattcatcatatgttttattatacgttttaatagaataaaaattataattgaatttgttaaacagaaaattcaatgttttagcatccagaccttttgaaacaaaagcatcaatatattgctttgtccgagttttattttcataaccaaaatcaaacactggcttcatatattcttttaaatctgctgctgttttaatttcttcaaatttcatttcaattatctccagaatccgtaaacccattataacactattaattagtaagcattttaacagcagatgggcgtttataaaaggcgtgagtattgtcatcaactgctttagtaaaagtagctttgaactcaatttcgccgcgataatttacatcaactgctccgggtaatgaaccataaacagtagctccattttcaagacgcaccatcattttagcagatactccccaatagtcttggtaaatttttgttgaaactactctgccttttactacttgttttccttcaggtgcttcgcctttagttgctttaagtttatcgtagtaagcattgaaccattcttcggagtatttctgaattgcttcaagaatacttttatgggctctaatttctgccatcaaaactgcagtattatcttcaagttcccaatgcttatatggttcgcggacttcaatagggcatccgtaaagcttgagctcattaagcatatcagatgttaaacgaagtttccaccagccaaaatctccagtgaattccggcttatctaaaacatcgagctcagtaacatacggaaggtaactccctccatgataagcttcaacttcgccaagttcattttcccaaagataaccgtcaaacggagcatgtggacggtcgtcaattccccatgttggtgcaaccaccctttcaaatccttcgcgactgtagagagtcttcgcccatcctgcattcaattcctgagcgcgtttttcaactttcgctcggcgagcagcacgtgctttgcgattttcatctaagattgaattgatgatatcagttaacattttagtctccgttagtagattacgaaactatcatatactaaacttaatgcgttgtaaacggctgaagtaaaaatttttaaagttaaccagaacggttaagaggaactttcttaggaaggatgattaatcatattacgaggatataaaaatgccccagcgaagccggggcgtacactagtggtaagatggtgcaacatcgtcaccttggaaccaggctgaattggaagatactttattagcatattcccatttttctgttaagtcatttagcccagcttgcatttttgcgtatgacgcttgctgatatcggtccattgttattaaagattttgtcattgtggacaaaagttttcgcctaccttcattgccataattgcgaataagcgctctattatattccggcactaaaaatgaaagcgagtgcccaatgtcagacaaatgctcagcctttaattttaatcttttaacggcaatagtttttcttaacttttcaatcattgtcaattatcctcggtttgctaatgcgtattcattagcattaatataatcctcagcaaaaacgatatcaccgatttttagttgaattacaaatagagagtctaaaaactcaggtggtttaatctcgatagacatttcttctttaataatttctattaccgcgcggtgtaattcatctttagtcatcatttacctgcaattaaaacaccgaccataaaaataatccagaacgggtaaaagaaaaccattgaccattctgcaactatttttgtcagtttctgtttagtagtacgacagctcgacgctggcattccaatacaccaagcaaattttctaacaaataaaaaaccgataattaaataagcaactacacctaatacaattaaaatttccataattacaccgccattataaacccaatgcatcccgttctgattcggttaattttgctaaagcttgttcgcgtactcgtttaatgcgctcttctttgtctttggcagtttctcgttgaatatcaaaaccatttttaacgataaatgaaagcgtctttccatctgcaaatataactgttaaagcttcttttgacgtgtctgaaacatgtccgtcactgccgtaccaggatttaccggcgacactctcacgcgctttttcatacgagtcatagtatccataatgttgagttctgcggtcatctggggatatcgtagcttcccagaccttttcaattttactgctaataatagttgtattattaatcatttttaattcctcatatatggctttcacaatttacccttaaagaattctgcccgggaagcacgtttaggttcgcagttccaatatttatctttacacggagtgctacaaaacttatgttgccaactacgcttcgtaataacctttcggcaataaggacaatacatttttgtccctactttcactaaagtgttgttatcgtaaattggtttcattacattataacgagtatctaattcttcctcttcaacgtaatcccaatcttcatctaatccgtatcccattatcctttgctccaattattaattatttcaacattgttacttctgagatttcacgccaatttttctcgtctgttgctacgaaatccgccaaatacaaggcagtacgtaaagatacattgcgaagacgatttacgttatttttcataaattcaagaacatctacaacttgtgaattacgtaatccgcgattttgcaacatccgggtattcataataacttcttcaacacggaccattatttcttcatttgaatgaacgcctaaatctaaataaactgaacgtgataccaaagcggcgagatgtggtgctaatttgcttccgcgttctaattctttatcaatatcaacgtttgtgataaaaactactgttccctcatattcaaattcatttgggatgtttttttcttccaagtaagaagaagcagtactccagcaaaccttgcgtttatcgcccgaatccaaagcagctttaagaagatttagaatatccatatcagaaaatacatccacatcatcaataagcagaactgaattagcattgcgagattcccaaaggcggcagtaaagaccaatcccggaaattttaccattgactgatttatattcaattctaccatcattgtgagcattttctaatgctttatccaaggtgtaagttttaccaatacccgcagctcccgagatgataagtgaacgaatgttaccatttataataccattcgtcataaatcccataacgttaaagcgcttattaatgcgagctttcatatcatctacgctttcgataagttcaatctttttagtagttccgctgtagctgatatctgatttgtaaacccaaacaccttttttcttaccgtcaatcattacgaatactttaccatcaccctgggcggcatcttcgggtttcaaagtttccgggaaccattcccctactaattcgaacgtcccggaaatttcttttccgaagttaatacctttattgatagtgatggttgtcattttattctccaagttaattttgttttaccatttatttggtatgaagtaatagtatcatcatttcataccgttgtaaacattattttttgaaatttgcgtttttaactgtaacttcatcttctgggttgaaaacgaactgcttaaataatgtttctgcttttggattgaaaatcatagtgaagaaagttaaagtaccaggttcaacttcacgaaccccacaaatatcgtattcaacgttatcaacaatgagtttgtttgagttcagtgcatctttagctttgattacagaagtttcgattttcagggtaactttcattttattctccaagttagtttttgttttaccatttatttggtatgaggtaatagtatcacagtttttggagcatgtaaaccttttttgaaatttttcttcaaaaacaacaaaacctcccgaaggaggttatttggagtatttttctagctgacgctcagcgaaccgtttagggagcatcaacaaccattttaagatatgccagagacccgttaagataaaaacaggtaaccataatagtaatacaaacaggtaagaagaagtgtcctcaatcgtccctcgtttaacaagggcatttgttataaaccagccgcatgttagataaactaacgtaacaatgataggcataatccaccaaagctgagctaaaagtaaagtaaccataattcaccggtagtaatggttgtgattttcaagataaacctcttccaagaacttgtcccagaatgtcatatcaattttgttaggcattccatttttagacgcagtcattgccagtgcttcaacttcatctacgatgtcttcaagactagcttggacatctttgaatgggattaatccttgcttaatttctaagatgaatggcgcagtacaaagaggatattttaagtcgcctgttttgtaaatttcctttaactgatatccagcacggtacgcatgactcagagctttccaatcaatgccttcgttagcttctgcctttcgtgctcgttcgccatattcactatcaagtttgtttaaagactgtttgagctcagtaacagagagtgtagtctggtatttgcgtcctaagacggtatagaacgtctgtgggccagttttctcgtggttatggaatacccattcacagaattcattctctggaagacgatgtttaatatcttcaaccttagtgcgtcggacccggactatatcatcttctaggtaatcaacccatttttcaggaacatcattaataatttctaaaacccgacgaagagcagccaggcgcgaaccttttacaccatatttggcagcttgtttcctgacatatccaagataagatttcatattagtggtgtaaaaccgccaacggttgtcttggataaatttccaaacatcaggaaggtcggatttgacaacaagtcccggaggagtatgaagcatatccaacgcgacagtttcacccgttgcggccaaatgaaagaagtatttcaatgaatacaattcatggtccacgtcgtctttggtgtttttagtttaagtgttattggtgttaaaatttgtgtggttcatagcccgtccaagcagaatgtctcgggcatttggaacaaaaatttctttaaaatcgacatcactctcaggcgtagatgtaccgtataaatgacttccaaaatagctttttacaactgttttcatattagccccaaaataatccgtacgcagaaagcgcgtcttcatctttaaaattaatcatttcaattttacgagtattttcgttttcaacaactacagcagagcagctatcattaacataaactactttccaatatccagaacttgaaggtttagaaagcatatcaccaacagccacaggaacattaatgaattttttcttatttacaactttacataatgtatatttttgagggtcaaaaacaagttcttcgcctttatattcaacaatagaaaaatgttcaactttgaaaaaatctgagccgttataatctaaaattccgtctttaaagtccacacgaacgatagcatccgggtctccaactactgtgccaaatatataattctggcgccctgcgtccggaaattctccaaaacaagttttacctactacacgtatttcgtattttttggttccagcgaggtcaatcaaaatattaagaatatcgccagtttcaattggcactagttccggttcaattactgtcttggattttttaaatgaaattttgctcatgtttttctcatagataaatatgtagacctttagcaaactcaataagagctttgccgttttcacaagctgtattagcttgctcttcactttcattatatttcgagaccagtgaaagcataccaattttttgatgaactgaataatgagtcacatcaatcatacgatattctcgacggtctggatgagattcgcgagatacattcttaataacacttgggttatgcattgggtataagcaccaatcatttaatccgcgaatcaaagccatgctagtaacaacttttttataagggaagttagtgatataacccaagaccctggtttcagggtccttcattgcgaagctgatatctgaataagatgctaacttcatttgtttaacgatagacaaagataatttcttctttgttgttacaatttcgatttccatcatttttcctgcataaattcaatatgtggacagaatttttctttgcgagctttaataaaagcgaagataatattaggctgttgttcagcataagcaccatttctggcagcttcccattttttatattctttcctttcttttcgatgttcgcggaaactgtaaattccattaccaatgcatataagtataccaaaaacaactgctagtataagccaaccaataattaacccaggaataaacgcctctactgaagaaagaattacaccgcattgggcaaacaaccaaatagctaaatctgcaccaataccccagctggcgaaacaaactacgaatatagcaaataacaaaaggaaagcatgccaaacacctttccaaaaataaggacataaagaatatggagcgatttcagaaccattcatagtaacaagtttatagtgccaagagcctttattgatttgcattattcatttcctttcatagaaggcagtacaacgttcaaatagtcacgaagtttttcagcttcagctttcaacagaaaaatttctacatcttcgtcttcataatctttatgaattatgctaacaatctcatagttttgtccttgacacttatgctcaataacatttaagttgagaacacttatttcgccaaaagacgcatcaattacattagcttcgcgaccaacacctttaaaattcatcacagtcattactatttcctattattaacaatacaattataattaaaagaactatagatattatagtctcaaacccataaagcgtaataaattctatcatttatgcttatcctgttcccttttgattggttttgttagcaatataagacattttagcagcataaacataagaagaacttttatgaataatttgagctaaatggggtagtgcttcagtatcttttataaacctttctagctgtgaacgacatattccatcttccaacatttcatcgtatatggtatacatcaaaaacccggtctggcccttgtactggcaaatttcaattcgttcattgccgtcataacaacgagtaacaagcaaatcacctacttcaagttttggaaaactcatcttacactcccagatattaaagttcattgtaaacttactttagcaaattcagcgatattattcattgtccactgtttcccaagcaagagttactacaatgttttcaatagattgcactaagtgttgttttgcaccagttgataaatcatactgacataacgaattagctaattcaattaactttcttttagtctcttcatgagctgtttcgtcatatttcattgtaaacttcccttaaccaattcaacgatgccattcacaagattgtaagtaaacaatggatgattgtattgaacgaacagataaacagcaataataacgtttttcatatatcctccatatgatgagataattatactatatctcatcatgaatgtacaatcaaaaattaaatgatttcaaaaacgctttttcatctatcgggctattatttttagcgtattcagcatcttttgggtcactaaattcattatctttcaattctgcgcagaaatgaattgctccaccaaaattagtaaaaactcggttcaaattataaaccgtgcttcgctctgaagtctcaacgcccatatcagccaaagaagattcagttacgtattctttaataccatcaaaacttttatactttcgaatatgtttaacaaaccaagatttagaatacccaaaatctaccaagaatggatgactcaaaacaataagtttgtcaatagactcttctgagacttcagtttcggtacgatgaattccatagacatgatacagaactcggccagggacaaaatcttcgaatttagctttcatgatattttcctcatttgttttgataagttaatagtatcacagtttttagaggatgtaaacggttgatatgaaaatgccctggactgatgccagggcgataggattactccaaggtaaggaggtacttcagttggtaaaatgctccaacaatctcatccaccgtgttctgtatagcgcgaggaattttatcataaattgcgtcagattcagttaagatgagttcaatcatttttatagtgtcgcttggcaaagtcttttgttctggaatgtccggaacgtaaggcttgccagaaaagcctagccattgttcaccaaacttatcaatcaagtcaggtaattcatcaaatataaaattgtatgctttatgacgagcatagcttttagtttcgaaatgagctgaatgaaaatatgaacgagaaaccattaacaagccaagatatctattggcttcgtttgatttgccgcctttagcaaaatcttcaaatttcatgttcttccttttcagtaaatcgattagtgtaatattctttagcaacctctacaccagcagcttcgcacgtgctagtacatggttgtctatcccattttgacttaacaaatgagaagaattgctcactttcccgtttattataaattttatattgagtatacactttaagcgcaccctcaaaatactcatcaaatttaggattaaacgtgtctgcatgtactggaacacacataattccaataagcgcagatagaaatagagctcttaaggccataatcggcctccttatttttgtccagtgttttgtttgtgctgtaatacagccttaacttcactgaggtatttttccagcttacgtttacgtgtataatctgctttcgaaccgtatagacgtaattcttcttgaaggtgcgaaataccatgcccaatctcacgacgaagttcgtccaattgttctacagtaagattacgaagttgcttttcgtttaaatgctgcatatacacctcattagttagtaatagtatttataaatgtagtactattattacataccagttaattcacaccagtgtttgcggcaaagagatacatacttatcttcgccacctaactctattgtattaccttctttcacagcgtttccattttcgtctatacgagccaccatggtagcttttcttccgcaatgacaaacgcctttcatttctatcaatttgtcagcaaccgccaaaagagaagctgaaccagtaaataatttacctctaaaatctgtgcgcaatccatatgccataactggaacattatagatatccacgattttacataactcatgaacattagcttcagttaaaaattgcgcttcatcaacaaatacgcaatgaatatctcgttgagtttgagcccatttgaaaaattcaaatatatccatatcaggcgtgattacattagcttcttggcgaagaccaatgcgtgacacaacttcagttgccgaatctctatcatcaattcccggtttgagaattaatgtacccataccacgttctttatagttatgagcagctgtaagaagagaagctgatttcccggcattcatgcttgcatagttaaaatacaattgagccattataagtccttcactaaattttccagatattgttctagagcattttcagcttttgttaatttatctgataattgataatatgtttcagcgtcgccataatcagaattaatctcaaacgacatatctttttccaaatcaattatatcactaatcatctgaagtatatcatgcttttgttcctttgtcatgtcgttatctcatctaaatattttttaaacgctgctttatcgtcatctaaaattttacgataagtttcccaatcatgaccagtaattaattcagcttcataattaatttgagaattcaaaatctcttcgactaaataaagtatttctttattttgctcagtagtaatcatactggctctcctggttcaatccattctggagtatattgaaagaatccttcaccaacgtgattcttacacgttttgttggagcaatataaccaccaatcccacgcattataaggtggagtattcatcagcccgtcattacataaagaaaatactacgggccatttacaatctttacaacggtgtttttcttttatatgagtttgcattttagccatcccaatccacaacaataatatcaatgtcaggagtaaacatatcaataatcaactcaattttattccaatcaccgcctgcgataccggcaccaatgcgaggaatataaatcacaggcctgaataattgtcttttagcccaacaatttaagccctggaaagcatagagtaatgcaccataattgatgttaggacctggctcgtattgggtataaagattaaagcaaatttgaccacgttcgccagtcgcttgagtgtaatttcccaatttatctgggtctgcatgctcagtttcgtaaacatcaatttccaaaataggaggatatgccttagctagttgtccagctactcctgcacccattgtatggaaacaattacaaccgtgagctacattgtgaccttctaagaatatttttacaatatcgcctttgatatattttttaatcattttttcaccatataagttgaatattcgtcaacatcattatatactctaataaaaaatgtatcgcacgttttcattatagttttcgctgtgttataactatcaaatgacgctatcaaaaacgattgctctatttctcctttagcgcttttctcgcagcccctgatattaaaagaaccaacgggtataacgacttggtcacctttatcattataattataaaacgatataccaagaagctctttaattggaatataaattaattctacatttcgtttaaaagaaccggaagtttcaatttgtttaccggttaatgctaaaacctcttcgggatagcctgggagtttttcccaggcattcaacgcaaatgtaacgaataataaacatattaattttttcaattagttaatcctctcatgtattgctctaataatctatttcggtaatcaaaacagatttcagtatttggagctttatcacacagattattaagttgtttagttttacgatttattaaaacgttccactccgattttgatttagatgctcttactccgtcttcatacgccccgtccaattgcaaggacaagatatcaatacattctgcgtttgtagaacaaaatgatttagcgattttaagcgattcctccatattatcaccagaagcatttgctcctgatataagcaaaagactaagcacaagagcgattttttgcattattctacctcaattctcaatagtttatttgactttagataatatgctttttctaggacttgactagcatatctgtttccagatttccagttgttcccggcgttgtaacttgcaatagcttttcgcatattaccattatatctatttaaccaataagaaagttcaatatatgaccatgacgctgaattcgagcgtttattcaacattttaattatttcagcatcagtcatttcccatccaatttgtttcaatctagcccgcattgttggaagatagttttgaaacattccatatgcttggtgaccagattttcctttggttttcaacccagcggaagattcttgccagaccaaagctgccataatataacctagccctttattatcatagcggtttgcttgtgttttatatttgccatcctttgcaaattgctctccaaactgataagcataattcagattttcgagttggacattactgaagttgtgctcggacccaaaggccattgaacaaaaggccaatagacctacgcatagagcttttttcatgtttacctcatttaaaacttaaagataaattacgtgtttgctagtttttccttcgtatctatttgtattaacaaaagccatccgacactgcatagaataaggagtagagaaagttttaccaggagtaggttttgaaacagtgaaaccaagccaaagagttttgtcagtgatttcaaggcgaagaggtcgatactcaatatttgggtctaaattttcttttgcatctggtcgttccgggagctcaagaaattcattaacttcgacaacatgatttgaaagcttgtgaaaaagttcaaaaacatagttctcgtcaatttctcgttgaatggcgcggtccaataaatgctgagaatattttacatgaaaacctggaactccagcggattcgcatgctgcttttatttcggaattaattttagcaaattccgtttcaaaaagacgacgaagtttgttgcggcggatgaatacttctgcgttagttgacatttatttctcctctttatgatataagattataataacacatccagaggagaaagtaaacggtttgtaggcttaatgtcttagttgtatttcacttcctcatttgtagcaatatcatattcaactaaacgaataggctcttccatcccatacccactcatagagatataagtggatggataaattgtttcttttccgtcccaagtaccgccggaccatgcttccataaagtcttgttcgccggaattaactagccaatcaacaaatgatttaagggccatttccgacccttcaataacgattttagccatgatgcttacaccttataatgataaatcttattgcattcctatcacaaaaaattgcggtcgcgcagtttgattgtttttataacaatcaactcgacaacaatactgcatggtttccatatgaacatcgtaaagcttatccatatcaggagcttttacaggttcatcaattatatacaagattcttgaaagcgatagacctcggaatttgtatcctttattgcctataaaactacgcacagaatcagtgaacaagcgaaatcggatatcatcattagaataacgcgaaaattcctttttaatgtgatttgcggaaagttcagcgtatgccgatttattggataaaacaataaccgttccactatcatacagccaattggcggcgaagttagttacagcgattgatttaccagattggcgcccaccgtctagtcgaagagtgcaatattctttaagcagggtttctaatggcggaacccagccatttttgcaaatttcatctactctagcatcagaatgatgtgtaaaagcattcatcagggatagatatggtgcagttaaaaatgttctcatttgtttctcttaagtttgtggcccgttacgtcggcgcatgattggtccttctaccgctatgtaaacctattaccgcacttgggctcgaccttattacaggttggaaaaggttcatcactcagaggacacgacgttcatgaggagaggctgcgttaccctttattaggcaggaaatgtttaagctttaccgcctgaaacaattccaaaattatcaaaatcgtcttcaacatcagaagggtctacctttttaccaggtacaacataagcaatttcgcggcgtttagcatgagtaacaatttctttacctaagccgttaaagaaagaatagccatttcgttttagagacccaaagtcttctgcgtcgccagtaaatgcacgaactttaaatgcgccttttggagcttttactgactcgttaataaattcttcgtaagttttcatttaatttccagtattaaccaaatagttagtaacgttctgtagaataattataacatcatctacagaacgtgtaaacatttaaattatttgattgatttgacgtatcgggtaacacctttgtcattgacaaatgcaatcttaccgcggctgttatacattgtcacagtacgctgatagccataagtctgtttacccgcctgataaccaatcaaagcgaagttatcttcaccaggcttgttcagtttagctttgatacgttcatggccataagccattaaacttctctgatcacctgtgttcaatgctttgcgaacactttcatcgtcaacagaggaaacaaaatcctcaaatgaactgaacttggcgtggctcttgttgtaaagtttgccttcaactacataattatagcccataacatccatatcaacttcagtaccatcttcaagtactacagtgattttctgacctttcttgtatttcagcagaccatcagtagattcgttaatgataatctgagaaattacgcgggcttcattgataaaatcttcataagttttcatatgctttccaagttcctgtttcaaaagttttaataacgcggcgggcgcgattagttgtttgtctgtaccatttagattgagctaaatttacagcagctctatcccaatctttagcttttagtaaagccatagaatttttaaaacccgctacaccagctacacccatttgaaaaaccatgttaatcagagcagccagacgaggttcatcaccaataaaagaattatatacggggcgtaatacagaattagaaagaattcctgaaatagctttttcaacgtctgtattaaaaattttttcagcttccgctttagtaattttaccggatgtagcccggccaacaagacggtccaactcgctaatagctaccgatttattagggtttttagtcaaaagatgacctataccgacggtccaaaaaccttcagtatctttataaatttcaagttttaagccttcgtcgatgcgaagcatgtcaaaaatgttcataatacctcctttaatagaggtatttattattcccgactttttacaaaaaggtctgccatgaattcttccaggcgagtttctacggacgatgcaacaccggatgatgtagaaacaagataaccgctcataggactgaaactttctaaattgctttccatttcgtatttgatttgttcttcggactcgttatcgctaaatgaatagagataattatatccctttgaatttacgtaaattgctacactcatcatatcacccatgaatagcgcatcattaacacaccagaagctgctaatggctcaacagaataaatccacgtttttgtatattttcgacataagtctactaactcacctatgtcatgaaccacaacggatgttaaaggcagagttatatgacccgtattagttaatactatcgctttcgggtcatcaataactaagtgctcaatcttctcgtcttctaaataatttacaagttcttcgagtttattcgtataccatccaaattatatagtacgtccttcgacgattttagcgaaagaccaatttttagtaatgaattcaattattaaattcaattctttagcttcgacaatatcagttacgtggttttcgtgatttccagtattcagaacagcacgaaaacgatcgaatttaccaaaatcattagttactttatcgatagttacagtgttaaatttagccatgattttattctccaagttaattttgttttaccatttatttggtatgaagtaataataacacatccgtccatggatgtaaacggttgaagtaaaaatttttaaagttaaccagaacggttgagagattggatacagaaaggataatagattataaatctatacaaataaaaatgccctagagttaaactagggcgtgagagattaaatcttatagaacctgaacggatttatatggaaagcaagcattgctctaggtatcggacgggataacaagcttttaagtttccacccgcaataaactcgtaggtaaaattgaatttttccaattcttagataaggaacagcagcaaaaactccccaagcgtcatcgttccacataaacagccatccatgatgagctttatccggagaacccgattctacattagggtttccacgataatgaaactctgaagtagcggggcggccaaggacataatatgcaaagttataagctttatttcgccacagccatgctacgcgttgaaagtatttacctaaaactggaattttcgaccagcgctcaatatgtccacggtctccatcaataggattgtcgtatgtttccatccaacggaatcctttaggtaagtgaccagtcttttcagaatagaatggaacaataaatggagccaatacaacagctaaaaccatagaaatgaaatctagtggaacaagaaaaatccatgaagcgtattttagaaatttagtcataatctactctaattaaaatatttattgaagcgaatttcgaattctagtcaattgagcgcaaaattcccgctccgtaagaatagtttccgtttctttatttttacccattgaatgagttaatgtagcgttacgggttgctaaaagagctcttttgaacccgtcgttttgggacagtgcatcatatgctcttgtgattaaattttgataagcctctgacgaccgatgaataggaacaccacgccagtacaatgtctgagttggccaccatcgtttctttttacctttgaatttagcttgtcttccaactaaagtgcaaacatgctcttgcatttcaaccgaagaaaatttgagggattgtaaaaatccctccattgaagcacatttaactccgtcaatttcaaatgaatgtggagcaaagttgcttaatgaagacgacggataacccgaccctgaaccaatatccatttaatcaaccttataaacaaatatggagggatttatccctccatcatattaatactgactacgcattttagctttaatggctttaagttgcggagaatcattgccgtatgctttccaaacgaccatttcagcaccgttgttttccatggagtgaacgataattttaccgttcttacctttttctacaccagcttgatagcgttggaaatcgctgttagtaattttcttaaagtctttgatatcaccttcaatctcatatgagaaattgaagccgctccacttactttcattgataaattcttggtaagttttcattgttatctgcctagttaataaaaatatatttattatagcataaagagttgaaataaggatttgaaccttatatagttgcacagacgtatctgccttcgaattcctcactaagtttaagcaactattcaattaaattggtcgagacagaaggattctaaccttcaacctacggtttagaagaccgttgctctatactattaagctatgcctcggaaatagttttgcgtctatatacttctccgtcgtaatatttatcgacaagacgctttacttgactgtgtgatatttttaatattttagagacatcagaaacccacccaaatttagttttatccacgtcttttattaagtttaattgagacgtagataattctagacctctaatcttggctttagcactaccagcttttcctagtttaacaccggccaaataaagttgttccttggttcgagtatcaactctttttccatttgtatggaggtctttattattttggctattagtagcgcaataaacattttcaatagaataaggtccagaatcaccgatgcgacacatacaatattgttgagctttattaccgcgtttttctaattttccagttgaaatccaccaattaagccaggactcatatgtaaataaccattctatgtttctagccttcgcctttcttctttgattttcatatttaactttcatgtttattgctttcactcggctatccaattttaagaagagtgagagtcttagtcttgtacggagtaaccttttatacattggcagctatcgcgcgattcgcacttccgataaatggagttaccgttacactctaatttggctgggaatactgggctcgaaccagtgcatcccggaatcaaaatccggtgccttaccaacttggctaattcccaattatttggtggcccttgctggtttcgatccagctacctatcagttatgagctgacagctctcccattgagctaaagggccgtaattctattatgaaaggctctatgttaagaacctttggtaatagagggtacttattaataataacactaatttcttaaagcaaattaaaacgtatgcagatatattttacgaatatgtttcaattttaacggattttcaaaaatattgtagtcctttcggccatcttcagttagtaaaaagaactcaaaattgacagtgttaaactcacgctcatttcctaccattttaacgacagaagagctccggtcaatgtcaatatattcaacttcaaaatatgataaaattccgtgttcttcaattaatgatttggcagccacctggtcagttgcgtatccgttttcagtattatttacagctgtgtagagaatcatcaccacactcctttgtcaataatagtgtgagtgttggcattcacaatttgccaccatttggcatggtagaaactgtgtttaggctttttctgattttcttcgataagttcacgaagctcatcttcagaaaaagcagtagcaattaaatcattgtatccgcccgcgggataataattatcaccgccaaataacaagaaattgactttagtcatatttaccttttaaacatctgatgagtcatgtagacaataaccgctaaccataaaaatacactattaatcgacgttaagacaaggcctgctataattccagcaaaagcaaaatcccactcagtgaattctttcttgtcaaaattatagttttttctaaaatatttctgaatttctttaagctttttcattagaaattttgtccataacaaatgatactacgccgagaaccgctacggcaatgaaagcactcatagtttcagctttagataaaattgctaaagaccctgccatgatagaaaaaccaaagccaccaagacataatactgcagatatattacgaataagttcacaacgtttcattttattttcctcatttgttttgatagggttatagtatcataaccctcaaggaaagtaaacggttaaatcgcgccgtcgtcttttgcaatattaagaatagtatcatacaattcctcagcttccttccggcgggccgagattttagtgtactcttcatattgctcaatcttagaaagcatagattttacagatgaataatggtttttcaactttttgatttcagaaatagtaaaacgtttatctaggccttcgttcaaataagtcgattcgttaacaaattctttaaaagatttcataatagttccatgtttgttgatagagttatagtatcataacctgcaagaaatgtaaaatgtttacattttacttccacgaatgacaccataggttgcgaaatcatcagtgatatctttagcagaatttctacctgtttcaatatatgcaatatcagattttttcgaaaaagaagtgattttgttataattagagtctaaaaaggtgtaaccattacgcattagattttcaaaatcttcagcatcgccacgtcctttaaaatctacccatttgtaagtgtttttcttactaagacccataggccatgatttttcggtaagaaaagcttcgttaataaattcttgataagttttcattttaaatcttctgtccaattaattttaagtggttctttatactccctgtcaagtataacagggacttggactatgcccgaaaattgggcaggtcctacgttgtagctcagtgtgatgtgtggagaataatcatcaaaatcatgagtagctccgagggcgcgggcgtaattgtgacgaaatttaagatagtcagagtccagaactaaaaccaatgttctgccatcttgcgtgtcccagacttggagttctccagaatttgctacttcaaaacttccagtagaaaccacataaggcacattaacccgagaatagcaaatagtgctatgtattttatgtcttggaactggattaggaaccttcaattctcgctgaaggttctcaatttcatctaatgtgctatcgctaaattttgctgcaacgtagagtccagaactaaagtcctggaatttcatcattcatcatccggcgttgcggttaactcatcaattttttcaagaatagcttcaaaggtcacttggccttcaacaacttctagaccgattttttctacaattttacttaccaaatcgcttagcgactgaaccgtgttagtagtttcagcaaattgctcattcaaatcaaaaagacgagctttaagaacagttacagtagcttcaagctgtttaattttatcagtcattttaaaacctttttaatttttgcataaagttcttctaaagaaccgtcattagtaataactgtatcgccttgtttaataggcaagccagcttctgttatatgagtgtcaacttttgaattgactgagctaggacgaactacatgaattaccgtagcacccatcgccctagccgcgtccaattcatggtcttgacgagtgtctggtactataaaataatcgagattttttccaaaattatctaaatagaccagagaaaaccatttaacccaatacatacggtcgaagtgattgaccatgatgtctgtcccaagggtctgcatgagacgacgaactgaccattcatcttcaatactatttatagtgtctttaattattgaaagagaacgatggtcgatatatccgttataaaaataagcatttttaatagataacgtaccacttagccatgacatggcagactcaatgatgtttataacttgcacctttgaaattttcaaatcaacttcacggtcataatcaattccttcccaatcacttcgatttaaaactggaaacaatttaccgaggtcttttgacataatagcaacttgataagcatagcaaagagcatctttaattggtccagctaattggtgcttaattgcgccataattttccattatgtaatcagcggttgtgtcctttccacttcgttttttaccaatcaaaaaaattaatttcattatttcctcatagatggatgcattccaatgcgttgattagcagcctcggccatattttgccgtgttgtaataattctaccatctttttctatttgcaaatacttatacggcatgatggcttgacatgttacagctgggtcagtatcttctgtgtagttgtattccacttcgcctaagtcgcttatccaacatccatagtaatgaatagacaaaacaattctagttttgctattgtctaaaatatgaacactgacgtgttcaggcatactgccgtcgcgccatgcgaagttatctccagtttgatagttgtttatgcctatcatccattgatacatctgcagccaagagtccagttcttcatccaccaaaaatctgataaccagtgggtcgaattcgaacgttgaaccaggaaggttcgctcgtccaagacccatagtgccagagggaatatcagtaacaggaattcttataccaggtatattagctgattgcgcgttaagcgtaaaaccttttgtcaagccaacatccggaatgtctacaacaaagttagttatgttggtttgattgtatatctgttgtgtgttcaatctgcttttctccagatgttgttataatgaatttgtccttccggttaatcaaataatcaaccagaagaacaagaaagtaaatagaattatgatttccatacagcgtttgcgctgaaacgtttacctttactttggaaattctgaagaggtaacataactacatttgcccaatcagcaggtttaatttcaatcaaactcccctttatatgaccaggtaaatatgctttaatcattttatctgcaccttgaaatcctttcacttgactccagttcactttcaatttcgttttgtttgttatagttggagtgttagaatactgctttagcagctcttcaagaaattgttgccgagcctttggcggaatatagtgtaagttcaatccatacattaatgtagaattgccttgtttacccattcctaaataaattattaatggaaatctatcccaatatggaagagtatctttatgcttagcatcatacatataagcatataattttccaggttgaggttttgttacttgatggcctctgatgttctttttgatagtctcggagaaccatttagcagatttattattgactgccgctccttcatttctaattttatcgcgaagcgaagacctgaaactattaatcattatcagttgtctttcttgctttgacaacttattagcaggttttccttcaagtttagcaatcttttctgcgaactttatcttagaagaataccttgacatagccttagtgaaagtagcataaggtatttctttggactcagcaaattcttttgagctcatccctttggatttagctttattaaattcaagccctatttcaacccatttcttttcatttcttgaaactggtttaggacgagtagtagaacttgcagcctcgccaatgatttcaaaaatagccattatcctttccaccctagtcttcgaagaccatcttctgttaataatctgaactgtatattatttttttctgctacttgtaacgcagctttccacttatcagtatttactgaatatgtataaattgaatcgatgtatcttttctttgctgctgtagttaatttagcaggtttaggaggagggactgtttcttttttgggttttacttcaaagaaaaactcttggcctgtatcaaatttcacccaaaaatccatgaaatatcggcgttttttgccgtcggcattgctaaagtatggaattaccacttcttctgaattccacttcactacttgaggatttgtatcgcaccatctcataaaaaactgttcccatgaagagcgataagttattttacggatgtctcctctatatttttgatggttcgttggagtgaaccttcctgaatatgccattattatctcctctaataaatactaatattatttatatgtgggagaggttccatgattttttcttttttcgacccaattgattataaggcaaaaactgtcgataaaaattccaaaactattaaaatgactgacatctttcgcaattacaaatcttactttaaacgtgttgcggcgggttatcgtctaagaacttattacattcaaggaagtccaagacccgaagaactagcttatcaaatttacggaaactctcagttatattgggttcttttattttgtaatgataattatgacccgtattacggctggataatttcacaagatgcttcttatcttgcagcaatgcagcgttatgaaaaagcgggaggagaacaagtactttatcacgtagatgaaaatggcgagcgctattataatctaatagaagaccctaataaccctggtacttggtatgataaaggcgacctagaaatgaaatatcctcaatacaatggagctctcgctgcagttgatatctatgaagctgctatcattgataatgaaaaaagacgagaaataaaaattatttctcctaatgatatcgattcgtttattaacgacttaattagagagatggagattgcttaatggatatgattaataacaacgtcgaatggtttgtcggcgttgtagaagatagaatggacccgttaaaacaaggacgagttcgtgtgagagttataggtcttcatccattccagaaagttcaaggccctgtatcgggaatgccaacagaagaccttccatggatgagtgttttacaacctataacatccgcatctatgtcaggaataggcggttctgtcactggacccgtcgaaggaactcatgtttatggtcattggttggacaaatatcgtactaatggtttagtgatgggcacatacggagtaaatgccagagttagaccaaacactacagagggtttctctgatccaactggccaatatccgcgttacttaggtaatgatactaaccttttgaaccaaggcggcgaagcgggatttgagtcaatccctaacgttattcaagataataaccttgatacagctattaatcccgacgacacagatttatcaaatattccagaagataataatccaaattatactatagaagctatgcttcgccgcgacgaaggtcttcgtttgaaagtatactgggacactgaaggatacccgactatcggtattgggcatcttatcatgagacaaagagtccgtgatatgactcaaattaataaagtgctttcaaatcaagttggaagagaagttaaaggaaatcccggttctatatcaatggatgaagcatccgcattatttgctaaagacctagctgatatgcaaagagatataaaaaccaactcaaaagtcggtccagtttatgtcaaaatgaataaatcgagacaaatggctcttgaaaatatgagttttcaaatgggagttggtggtgtagctaatttcactaatatgcttaaagccatggatgaaggccgttggaaagatgcatataacgaatctcgaaactctttatggtttcagcagactaaaggacgagcttctagagtatctatgattattcttactggtaatatggaatcgtacggtgttcctgttaatccggttcaaggaaaatctgttggtgctcaattagctactgttaaagcttcagttaatccaagcgaccctcctataccaagtgacagcagaattctttttaaagagcctgtatcatcatataaaggacaatacccttatgtccatacaatggaaactgaatctggtcacattcaagaatttgatgatactccgggttatgaaagatatcgtcttgttcacccaacagggacatatgaagaagtagctcctgatggaagaagaactagaaaaacagtaaatgatttatacgatattgctaatggtgatggaaattatttagtttccggtgataaaaaggtaaacgttggtgcagatgaaacatactataacatggccaacagattacatcaaattgacggaaataatattttgtttatccgtggagatgaaacaaaaactgtcgaaggagatggaacactttacgttaaaggaaatataaagatagtcgttgacggaaatgctgatatcttggttaaaggagatgctaaaactcaggttgaaggaaatcacgattatacagtaaacggaaacgtaaaatggactgtaaatggtagtgttaatatgacagttgctgggaattggtcagaaactatgagctcaatgtcttctatagctcagggccaatatactattgatggcagtcgtgtggacattggtttataaatattaattattgactaactggaaattatatggcccagatacttcccgttaatacatccctcggcgatattcaagaaggcggggctgttgatttgactttcactgctcagcttgatgctactgatacattaaagtcaataaatataatagattatcagccaacttctggtataatagttgaaggttccagatactacggaaattataatagcgtattttcatttggagctgatgcattaaaatatcgtgaaggcgatgaattaaaaaccgcagcaacttgggaggatttacctcctcccaaaactgcagatttatatatgtggagagcccctagttcactccagagaacttttacgtatacggttgaatgtatatatgaatatcagtcggaagagtcttctggcggttctggtgaatcaggaggtacaactcctccaccggtcgaacgaagaataacaaaaacatatactcaattagtttacggaaattggagtcgttggggaaataaacttcgtgaatatgtgtatgcggggaactaatggcaggtttaagttttaatcaatgtataacatctggtcatgatgcatttcctcctaccgtaattaattcaactcagccaaaagtgtttactggcggaattccggtattagttgatggagaccaaatcactcctcatacacgcatcgtaaaaccatatgacacgcacggtggagcagtccagccaagaacatctaaagtttatgtgactggaaagaaagctgttcaaatggctgaccctatttcatgcggcgatacagtcgcgcaatcttcttataaggttttcataaaataatggcagacccaattaactatcaattaacgcgcaccgtaaacgctattccggacatttttgtaggaggaacattcggtgaaatcaagagagatttacttgattggcttcgcgggcaaaacgagtttctagattatgattttgaaggttctcgtttaaacgtattattagaccttttagcttataatacactttacattcagcaatttggtaatagcgcagtctacgaatcatttatgagaactgcaaacttgagaagttccgtagttcaagctgctcaggacaatggatatttaccttcttcaaagtcagcggcgcaaattgaaataatgcttgaatgtactcatgctttaaattggaacactataagtattcctcgtggtacaagatttttggcgtacgcgttagaaacttctgttaacccatattcatttgtaacaacagaagaagtcacagcagttcgtgatgctaataataagtattttccacgaattaaattagttcaaggccgaattgttcgtactgaattacgatatgataaaatgaagcctatcattattcgtgattccaatattgaccgtaatgaagttaaattatcggttaatggagttgaatggactaactggacccgccgctctatggttcacgcaggttctacatctacaatttattatatgcgtgaaactgtagacgggcatactgaaattttcttcggagaaggtgaacagagtgtgtcagttgcgggtggggctcttgaagccaattatattggcggattaaaaccggtacaagactctaccatcgttatagaatatattcgcactgaaggagctgctgcaaatggggcgacagaattcagttatgctgatactttaaattatataacagttcaaagaatatatgaaaaccctgatgactccaaagattatgttggagctgacggcggcggcgaccatgaagatatagaacgtatccgtgaacttggcacgataaagagagaaactcaacaacgttgcgtaactgcaaccgactatgacacctttgtttcagagcgttttggctctatcgttcaagcagtccaaacatttactgatatgtataaacctggttatgcatttattgctatcaagcctaaatccggtttgtacttaacttcagtacaacgagaagatattcagaactatttgaagcaatataacttagcacctattactccatctgttatatctccgaactatttgtttttgagacataatattaaagtatcttatgcgctgaataaattacaagaaacggaccaatggctcagaggcaaagtcttagaccagattgatagatattatattgacgaagttgaaatttttaatgcgtcatttgctaaatctaagatgttaacctatattgacgatgcagaccatagtattattggttcgtctgcgacaattcaaatggttcgcgaagttcaaaacttctttaaaacaccggaatctggtattaaatattataatcaaatgattaacaggtcattagagtcaaactctttcacttttcacggtgaagattctgattatatggttagaatagttggttcagaccccgaccaaaatggaattggtaaagttataattggcccgtttaaagacggcgatgttaaagaaaaccaagatatccagccttacatgggaaccgattttaataagcttaatgcagaaaatcgtgataagtactatgtaattggggaaattaattacccaggagatataacttattggaatatttcggcaatagacttaacgtctgaacaatttgaggttcaaactatcgagctttattctacaccaaaggaagataacattttcacaagagatggttcattaatagtttttgagaatgatttgcgtcctcaatacacaaccattgaattggagcctatagcacaatgacagtaaaagcaccatcagtaacgagtctcagaattgttaaattgtcagcaaaccatgttcatattaaatgggatgatgttggtgctaacttttactattttgttgaactcgcaaacacccgcacatcagaaggggtctctttagacccctctagatatcaatggagaaatctaggatacacgtcagaaaacgaatttttcgaaagtggatttattcgaccgaacgattattatgttatgcgtgtgtcagttgcagctcaagggtttgaacgctctaattgggtacaaactgaagaatttcaaacatttttaacaaacgcatatacgtttcagtctatgctcgaaatgactttggctaataaattcatcagagaaaaatttactaataacaatcaaagttatgtagatttcaaccgtgatacagttatggcggctttaatggatgagtcatttcaatttagccctaattatgaaatagtatcgtcaatttctgaccatatattatttgaagaagaatatcatgaaatacaaagtagcatttctgcggtatgtaaagacataaaccgagtaatgctaatggaatctgaaggaattttatatctgtttgaaagatttcagcctgtagtaaaagtttctaacaacaaaggtcaaacttggcaagcagttaaattactaaacgaccgtgttggtaatccagtttcccgtactgtgtattatcaaagtgaatatacaacttatttgcttggatacgatagaattttttatggacgtaaaagtaatgatataagatggtcttcagatgaagttcgtttttcttctcaggacgttactttcgctaaaattggcgaccaacttaaacttggatttgatgttgaaatatttggaacatatgcatctttgccggcagacgtttccagaattgctgaagctataacaactactgatgatttcatatatgttgtagccagagataaagttcgttttgctaaaacgcgcaatgcgcctattgaccaagacacattatcacctacattcggtgaaaaattatttgagccagaagtactaacaataactggtaatccaaaagcagtgtgctataaaatggaagctgttaatggtaaagtttttgctcttattactggcgaagttaaagaagacaggatggacccgactgttccagaaaacgtaatagattctcaatcaaaaggaatttacattcttcagtccgataatacatttaagcgtgtatttggtaatacagaagaagaacggcgtcggatagagcatggttatacttctatgtctaccaacggaacagaagtattcatttcttctagcaattttaaatttttaaatgaccaaattgtgcaagacccagacacagcgttaaaacatgatttgttaggagccgttaaatatgaatttccgcgcgaatggctttctgataagcattatcatatgatgtcttttagagctgacgaaaaatctggttatgaacaatttgttcccggcgctatgaattattatgctgaaccattttttagctggtctagaaaatctggtactcgctgctggattaataattctgatagaattgtggttgtttattcaaatattactcatacaaaaataattgacactcatggttccggttctccagaacgagttttgcatgaattctgggataaaggcacttgtactgtaactgctccaaatgttgaattcaacggatttactaaatacgcttctggtattctcttttataaatcttccggtgaaataatttcatattacgaattcaattatcgtgttcgagatgaaactaaaataatttggaaaccgtctgaaatattccttaaagcttatttgcaaaatcaagagcgagaaacggaatggaagccagaagaacgagacggaatacaagacccagatttaagaccgttgattagaactatgatgcctgacagctatttgctagaggacacaaattttgaaaaattctgtgacgcatatattcaatacttatctgatggatatggaactcaatataacaatctattgaatttgataagaaaccaatatccacgagaaaaagactcatgggaatatctttggtctgaagtatacaaaagaaacatttatcttaacaaagataagcgggatgcggtatcaagatttttcgaagctagacgttcagatttttattcaacaaaaggtattgaagcttcttataagtttttgtttaaactcttatataacgaagacgttgaaatagaaatagagtctaactctggaaccgaatatgacatagttattggatctgattctattaatgaagacttagttggtcaaaccatttatactccaactggacgttgtaatgttacttatattgaaaggtcttattcaaaaggaaaacttcagtggaacgtaacaattcacaacttattaggacgcttaattcaaggccaagaagtaaaggctgaacgctatccaggctttaatggaatgatagttagaggtgttcgtggtaaggaattagtagaaaatactattgattacatcaaccgcaaccgttcttattatgttatgaaaatacgttcaaatcttccaacatcaagatatcgtaatgatgtgttaagatttgttcatcccgttggatttggctttattggtattacgttattgactatgttcataaacgtgggtttaactatgaaacatgtccaaactataatcaataaatacaaaaactacaaatgggatgctggtataccgactttttatccagatcgagtagcatcattagattcaagtggaaatgtagaaaaagacccagtcacaggtgaagtaatttatcttcctggaccaatgtctggtattgcatatcctgtcccggctgactatgactctgagaatgataattctattttccaaggtcaaactcctactgagcgtcggaaatcaatgagtccgttattcgatcaatctgccgtaactttttctcaattcagagacttagttgagcagcgtttgattgataaaacaggtctgcctcgcgaacctaataatccaacacaggttaaaatagatgaatgattcaagcgtaatttatcgtgcgattgttacttcaaagtttcgcactgaaaaaatgcagaatttttatgattcgataggagattcggcaaataaaaattcactttatataactttcggtcgttctactccttgggctgataatgagaatgaggtggggtttgccccaccttatccagttgacgatactcagggcgtagttgatatgtggactaacatgatgggttctgtaaaagttatgccatcaatgttagacgctattgttccaagaaaagattggggtgatataagatatccaaacccacgtaactttcaaattggagaaattgttgtagttaatagtgctccatataatgcaactgaggttggtgctggttggttagtttatcgtgtgcttgatattccagattctggaacttgctctatacaagatataaacaacaaagatgagtgtattaaattaggtggtaaatggacctcttctataccaagcgctaatcctcctcgtggaagaggtgatgcagaaaaagggactttgactatagacacaaacgatggatatttatgggagtatttgtatgaaattccaccagatgtgtcaattaacagatgcacaaatgaatatattgtcgttccttggcccgatgaaatagctgaagacccaatcagatggggattgcagaataatctttcttggcaacaagatgattatgggttaatttatagagtaaaagcttacactatgagatttaaagcgtactttgactcagtttattttcccgaggccgctcttcccggcaatgatggttttaggcagatttcagttatagtcaatccgcttgaaaagaaagataaacctaatgaccctaatgttaaggctgaagatttgtactacaagcctcatgatttggaacgtcattcaggcgagatgatttacatggaaaatagagctcctattattatggcaatggaccaaactgaagaaataaatatcatttttgaattctagcagggactccttcgggagtcccttttttattgcataaatataaatataaagaatagacggatatcacttgaggaatagatatgtataatcaagaaccaaaacaattaatcgacgtcggtgaaatcggtaacgcctctactggtgatatcttattcgacggcggtttaaaacttaattctaatatgaacgcaatttataattcgttcggtgaccaacgcaaaatgtctttagatagtggacaaggaactactggtcaagttatccatgccacaggttattaccaaaaatcagaaaatccggctgtagattttcaaactccggtgcaaaacggctctatgcatgacattgatacatcagctggtccagtcgttgttagattagaccaaggtgtccgtggagaaggtgtgttttttattaactcaagcggctctatttcagtccagaacccgttgacaatagaacctaaagacaattttgtcggcatctctggaccgcttgtagtgacttctccatttagtgaaattaaagtatggtgtatttctgatgatggcggacggtcagtatggaactattcaatcagaaacatgtttggggattatcatgacccggtccaaggaacttggcaaataccagtcgcgggggtagttgattttcctctttttcataaaaatgaatatatagcttcaaaacttttagttacttctaggtctaatgacggtaaaagaataaagtcttccgaaataaatatattaatagatgtagtaactaatacagtgatatctactgaatacgctgttatgcgagtaggagcgttaacagaagaggacgatatcgtaacttattcttttagtataagcggaacaggaatgataacgatgactgctaacggcgcatcaggattaagagtagctgttaaatctatcacaactcagaaaatcggggcagcacaatgaaacaagatttaaaaattggagctgtggttgatgacggctctggagactacctgcgtaaaggtggcgaaaaaattaataataacttcaatgagttgtattatcaactaggcgatggtgatttcccgcatgcagcaggcgcgtggaaaactttcaaatcagctgataactcaattctgacagccgactttgggcgttcttatgttttagatacaaccgctggcagaatgacatttgaattaccaaagggaaatactccagattataaccatgttattcgagttagagatgtatttggtacttggcagacaaatccggttaccattactccagcggcgggagatactctgaagggtaatccaaacccaatcgaatttaatgttccactgactgatttagaacttgtttattgccctcctggacgctgggaatatgtagaaaataaacaaattaacaaaatcagtaattcagatttagcttctgtaattcgtaaagaatttttagtagaaactcaagaccaagttgattttttagacgtttttgacgggtacgattataataaagctaatacccaggtctatcatcgtggtaacattctttattatggaaaagaatttagcgaaaatagtgattacggctctcctggagctacacccgatgaagtagttgctttaaatggtaaagatattcgtttacgtcaaaaatgcaatattggtgatacagtaatagttgtttcttacgttgatggtattagtcaatggcgtagttcttataataaacgccaaattatgttactggattcttctaaaacaaatcaagtttcagttcccggttcaacattcgtaggcgatttgaaaaatactgatacattcacagtagaaatgtttggattgactttacatgacccgataaatcctaattcgttggaagttgaatttaacggcataagtcaagtgttagtgggaacaaccggtttgcctgaagtctattgtcaaggagctgacgcagatacttatgagtcttgcgttgctcttggaggaacttggacttcatctaatatggattattcagtcaattttgatacagataaccgtattgtttctatcacaacagaccgagaaatggaacacggcgatattattaccataaaatggtataataacaatattggaactaccacaagcatggaagatattattcaagagactgattctctttatatctctcaaggcggtccaattcatttaactgggcaagtttcaataaccgattatgataatcctcgtattccgaatactgaacctgtagcaccaacagatgttttggtcacaagtccgtatgctttatttgatttaatttatccagttggaactatctacgaaaacgctgttaatccaaataatccagctacttatatgggtattggtcgatgggtattgtggggtcaaggactagttactgttggttggaattcagatgtaaatgacccaagatttgctatgaataacaacgatttagatatttctggacagccatctcacactgccggtggaactactggagaaatttctgttagtatatcaaatgaaaaccttcctactactcaaaccgatgagaaagtgctaatagcagacaacaacggtccaattgtcgtaggtggttgtcaaattgacccagatgatacaggtccagtttatactaaataccgcgaagactacgcgaagactaatgaaagtcatgtcaatgttaaatcacttgacaatgttcaaccgtcaattaccgtatatcgctggttaaggattgcataatgagcgtaatgagtactaaagcgggtgttaaatcccgctattctgataatattcagtttataccttcgcctaataataacgatgtaatgagtaagcagccatatggtagcttaacaatttctgagtattcaaaaggcattgaattccctaacgtacaatcagcaattaatgatgttagaaattttaccattcgtcctataaattctatagaaattaacacagacggcgtttctccagaaggaatttctcaaaccgacacctggacattcgctggtacagttgttaaaccggatggagctactggcgatgctattatttctgtgttcggttttccggtgacagtaactgttggagatactgccgaagaagttaccgcaaaagctaaattagttttggaagatgcagttcttaaaaattttattattaacacagtttcgcaagggttgactggggctgaacttacagtttcttatattgataaccaaactcatgttcttaaaccggaaacacgttttggcattacagtaagttcaactatcgtatctccagctaaaccgggttatggagcttggacacgtataggaacaaaaaccgaaacattagaaggttcagcggacccggtattgttgcactactttaagagattagcataatgcaaaacaacactctaaaacacatatcagatgaatccaaatatgtaacatttgacccaactaatagtggttttaatgaaaatataactaatgtgcaggatgctttatctgctattagcgttgatggtatttcaggagttccacaagctacagaaaccgtcgcaggtaaagctagaattgcaactcaattggaagtcgatgctggtgtttctgcggatacatttataacaccagcaacgttatcatataggatgcaacgtccagaagcgagtacaactgtacttggtgtaactcaatatgcaactgatgaagaggctatagctggaactgctacaaaccgcactattgttgcgtcatcgttgaaggctactatagacaatgtttttacagttagaacatcaactgaaacttccaatggtgttttaaaaatatcatctacgccagctgctcaagctggcgtagatgacaccacagcaatgacaccattaaaaaccaaacaagctatagctgcagcaactgctcttattccagcttggggacctgctactgaatcagagcaaggtgtagttcgtttggcaacattgtctcaattaagagaccctaatataagagacggttattcagtgtctccatttacgttgaatcagtggcaatctactgagtcaaatttaggtgctattaagcttgcaacatcaggtcatatggatggaggttctgaccatacaactgctgtaactccatatcgttttgcttccactagagcgacaacgggaagagcagggacaactattttgtccaatgatttgaatggagatggttctaaagcattatcagctaactcagcagttcttccaagtaatagggcagcggtatcagctggagtatatgaacatgatactgccgctgataacaagtacatgacacgaaataatcttaaagcttatttacctgttggtactatgacacttgctgcttataattacgacaccggtaattgcttgaaatgtaatggtcgttggttaaataagcatcaatggcctgaattatttgctgtcattggatttacttatggcggagattggggagataactttgctattcctgatatgcgcggcttagttccacgcggatttgatgatgggcgtggtcttgacccagggcgaggttttggcagttatcaagaagatacgatgcagcaaataactgctggatggacaatggatgaccaagcagtaacttcaaactatcctccttcgggagcatgtgaagctagagattatggctctgtcaactatgacgcaagttctgatgatagaaaatggcgcggatttagaatgtatttcgactcagctagacaaactcgagtttctcatgaaactcgccagaagaaccttgcacttaactatgtaattgtagctcgataaagaggaaattatggaattaaagccattaccgtttgttaatggccttccagaagaaggccaacagcgtataaattggattaaaaatggggaggaattaggcgcggcaagtactaaatttggtactgacggtgaactaaatcgtggtcccaatcaagtacagtctaacgtggtcgtaatagatgaaaacgttagaaaacttgcagaagcttcgactgaaatgtcagctcaaatatcaaccatcaatagcgtgttagaagtttctggtaatactgaagctctttctcaaattggtaaaaatacaacagatattggtttattaaagcaatctactactacaatacaagatggagtgcttgaactagacactcgagtgtcatttatcgaagaagatgttggagtttttaatccttctcttgatacgcttcaacgcccaattcgcgatgatttgtattggattaaaaaagaaatggggcaatatccgggccaggatataaatggacaagctgtaaccggaaatgaagcgaccgggatgaaacgccgaattattaataactcttcagcaattaataataacaatgagcgtttatctaaactcgagaaatctttttctgactcagatgtaggttctttaacatctgaagttacaagcattagggcagaattagggccgaaacctactggaactattgaccctatatattctcgtttaacaaaaatgaatggtagtattggcggtcttgctattaacatggaagacgtcatggattccataggatataactccggtgtaacaagcattattggattagtaaatacaaacacttccgatattgttagtataaatggaaaattatctaactcaacgacgggagttataccaagattagatattgttgaagctaaaatcggagacgatgcttctacaaattcaatcaatggaagaataaaaacaaacactaattcaattaacaatttaaatcaaattgttggggctgatacttcttccggattgaggggacaagtagcttggataaatcaaacagtaggtattgttcctagtggttcttctccatctccgacttctgtgatttatagagtagaccatttagaaactcaacaagatgctactaatagttcaattcaagatttacaaattgaaattggtaataacactgagggacttaaaggtcaagtaattcgtttaaatactactattaatggtacttcttctggcgggacagtagaacaaaaaggattgcttcctacggtcaaagagcacgaagaaagtatcaataaaataaacctagatatgcaaaatcttattccagaagccccgatggacggaaaggcttatgtgcgtagagatggtgcatgggttgatattacaactttaactccataatataaagggccgaaaggcccttgaggtacttatgtctattcacgctccacaaaaccctaaagaattaaaagacgctattttaactagacttggcgctccaattttaaatgttgaactcacagaagacatgatttataattgcattcaaagagcgcttgaattattcggagagtatcattatgatggtttaaataaaggctatcatatgttttatatcggtgatgatgaagaactttataagcatggagtatttgatttaagaggctcaaatatttttgctgtaactaagatagttcgcactaatgttggctctattacttctatggacggcaacgcgacttatccatggtttactgattttttattaggaatggctggtataaatggcggaatgggaagttcttgtaacaaattttacggccctaacgcttttggtgcagacttggggtattttacccagttaatgacttatatgactatgatgcaagacatgttgtctccactgccggattattggtacaatggagctaatgagcaattaaaggtcatgggtaatttccagaaacacgatattattatcatagaagtttttacactagcttattcgggagttgataaaactgttggaaacaaagctggatatggatatgcaggtaaagccgaccaatggtctatttctgaccaatgggataatatggacaggtctttgccacaacggcgtgctggagaagacgcaaacgttaagcagggcgcatataataatcgttgggtgaaagattatgcgactaccttagcgaaagaacttctaggtcaggttttagctaaacaccaaggaatgcaattacccggtggagtcactctaaacggagagagattgttagacgaagctgaaagagaaaaagaaagattgcgagaagaattatatttactcgatcctccttttgggattttgattggttaattgagaggaattaaaaatgatgaataataatttattcgcaaagttagaaaataaaaacggatatgaaaaaacaaatgttgctaatattctcaatccgtatgtaaattttaacgggcataaaaacacccaatcattggcagacactcttgtagctgaatcaattcaaatgcgcggcgtggaatgctattatattccaagagaatatgttaaacctgaccagttatttggagaagacttacaaaataaatttactaaagcttggatgtttgcggcttatgttaactcatttgaaggatatgaaggagctaactcattttttagtaaattcggtatgcaagtttccgacgaaataactttatccataaatcctggattatttaagcatcaaaccaatggaactgagccaaaggaaggagatttaatttatttcaaaatggataatagtttgtttgaaataaattgggttgaaccttacgacccgttctaccaagttggaactaactcaattcgtaaaataacagcaggtaaatttatttactcaggcgaagaacttaatccagaattgcagaaaaatcctggtattgaaattccagaatttagtgaattggatttatctccggttaaaaatcttgacggtcttgctgatattggagaaattcaatacgaggaagtcgaccagattaataaagaagcttctgaatttgttaaagaatatgtagtaataaacggacgcggcattaatgacccgcagaacactagcccatttgatgatggttttatgtcataaatataattataaacatactaggcccttagtggcctttggagaaaaaattgttcggacatttttataactcgtctttcagacggtacattttgcttatgggtgatttattctctaatattcaagtagcaagaacccgcgaagacactggaactagatacataaaagtccctgttacttatgcatcaaaagaacattttatgatgaaacttaacaaatggacttcagttaactctcaacaagatgttgctaaggttgaaacaattcttccacgaattaatttacatctcgttgatgttatgtataacggaacatataaaactaatatatctaataggactgctcttcaacaagctgatcctaaaccaactactatttctcaatttaatccaactccatataaaatgatttttgaattgggaatttttacgcggtatgaagatgatatgtatcaaattgttgagcagatacttccatattttcaacctcatttcaacactacaatgaccgaacaattcggtgatgagattgaattcgaacgagatattagaattgtttttcaatctatatcagtagatgaacaaattgacggagacaacatcagtagacgtagacttgaatggtctattatgtttgaagttcaaggttggatgtatccgccgcagcgtgatattaaaggcgaaatcagaacagtttatttggattttcatgctaatacccgtgaattagttccagaaggaattttcgaatccgttgactcagaagttgaaccacgggatgtcaatgttcaggattggaacggagactctaaacaaacttattcttctaatatacctattcctactccgcctgcccctccagggccaagaattgtaaaagaagatgattagtgaggaaaaatgagcgaacaattagatattaccaaactcttagatatcggggaaatccctggtattgatggggaagaaattccggtatatgaaaaattagaattagtagaagtaaaaagtaatccaaatgaccgtaaaccagacttagaagatgattacacggtcgttcgtaaaaatatgcattttcaacaacagatgttgatggacgccgcaaaaatatttttagagactgctaaaaacgcggatagtccaagacacatggaagtatttgctactttaatgggtcagatgacgactactaataaagaaattctaaaacttcacaaagagatgaaagaaattactgccgaaaacgttggaacacaaggtggcaatcaaactaataacattgaaaacgcaacgttctatatgagttctcctactgacctgatggacgaattaggagattcatatgaatctcaagagcgtcaggagaaattagtaaatggaacagactcaaccgtataacgttctgaatgacgctcatccgctgaatgatgccaataaaattgtaattaaacacccaggtcagctagaaagaatggttgaccaaggaattaattggattaaatcgcagtgggacgataagtggtatccagaaaaatttgatgattatttaagaataaacaaaattgtaaagattaaattacagggtgaagacccagataattttcagacttttaaaaataaaaacgtaaaacgttctaggtatatgggtcttccaaacctaaaacgctctaatatcaaagttaattacaccaaggagatgattcttgagtggaaaaaatgccgcgatgatattgtttattttgctgaaacatattgtgctatcacacacattgactacggtacgataaaagttcagttacgagattatcagcgtgatatgcttagaattatgcataaaaaacgtatgacagtttgtaacttgtctcgccagcttggtaaaacaactgtagtagctatttttcttgcgcactttgcctgttttaataaagacaaagctattggtattttggcgcataaaggttcaatgtctgctgaagtactggaccgtacaaaacaagctattgagttattaccagattttctccagcctggtattgttgaatggaacaaaggttctattgaattagacaatgggtcatctataggagcttacgcgtcgtctccggatgctgtgcgtggtaactcattcgcgatgatttacatcgacgaatgcgcatttattcctaacttcatagacgcatggcttgctattcaaccagtaatttcatccggtcgacggtctaaaattattatcacaacgactcctaatggattgaaccatttctatgatatttgggatgcagcaataactggtaaatccgggtttgagccatatactgctatatggaactcggttaaagaacgcctatacgatgataacgacgtgttcgatgacggttggcaatggagctcacagacgatttctgcttcatcgcttgaacagtttaaacaggaacactgcgctgaattccacggaacttcaggtactcttatttctggtatgaaacttgctaatatggaatggacggaagtaactccagattcttatggatttagcaaatttaaagaaccagaagaaggtcataaatatatagcaacattagatagtgcagaaggccgcggacaagattatcacgcattgcatataattgatataacaaatccaatatgggaacaagttggagtgcttcacagtaattctatttctcatcttattcttccggatatcattatgagatatcttattgagtacaatgaggctccaatttatattgaattgaactctaccggtgtttcggttgcaaaatctctttatatggatttagaatatgagggagttatttgtgattcaatgcaagacttaggcatgaaacaaactagaagaactaagcccgtaggttgttcggcattaaaagatttaatagaaaaagataagctaattttgcaccacaaagcaactatccaagaattccgcactttctcagagaaaggggtttcatgggcagctgaagacggataccatgatgacttggtgatgagccttgttatttttgcttggttatccacacaaactaaattcactgaatatgctgaaaaagatgatatgcgtctagcttctgaagttttcagtcgtgaattagaagatatgaatgacgattacgcaccagtagttttcttggatgcagtggccggggccgagtacaacccaactgaacacggtctgtcgtttgtataaatatactaaagcacacatctagaggatttattcatggctttactctcgccgggcgttgagctcaaagaaactagtgtacaaagcactattgttaataatgctacaggccgtgccgctatcgctggtaaatttcaatggggtcctgcatttcaggtaattcaggtaaccaatgaagttgaactcgtcgatttatttggtactcctaatagcgaaactgctgattattttatgtcagctatgaacttcttgcaatacggtaatgatttacgtgtagcacgtgcagttaatcgtgacgtggcgaaaaactcttctcctattgcagaaaatattgaaaccacaatttccgcggctggttctaactatacagttggcgatgttatccgtgtacgtcataatatggatgtaattgaaactgctggtaaagttactcgtgtagatgctgacggtaaaattctgggagtgtatattcctactggtaaaattatcgcttatgcgaaaagtactaaccaatatccagacctaggtccaaactggactgcagaaatagcttcaagttcttctggcgtatctggtactattactcttggaaaaattatcactgattctggtattttgttaactgaacctgaaaatgcttatgaagctattcgtaataccactttccagaacaatttgaaaaaatatggtatgccgggtgtagttgctctttatccaggtgaaatcggctctcaacttgaaattgaaattgtttcaaaagctacgtatgaaaagggcgcggcatctgaactttcaatttatccaacgggcggaactcgagttactaccgcacgggcagtatttggttatggtccacaaactgatgaccaatacgcgattattgttcgccgtgatggagcaattgtagagtcagctgttctttcaactaaagaaggcgaaaaagacatttacggaaataacatctatatggatgattattttgccaaaggttctagtaactatatttttggaacagcaataggctggcctaaaggtttttctggcatcatcaaattgaacggcggcatttctgcgaactcagctgttaccgcaggcgatgtaatgcaagcatgggatttatttgctgaccgcgaagcattgcacgttaacttacttattgctggcgcgtctgcaggcgaaagtttagaatttgcttctactgtgcagaaacacgtagtttctattgccgacgaacgccaagattgtcttgctttaatttctcctccgcgtgaaattatcgtaaatattccgttaactcgtgctattgataacttggttaactggcgtacagcatcggcagcttataccgacgataacatgaacatcagttcaacttacgcatttattgatggtaactataaatatcaatatgataagtacaatgatgttaaccgttgggtgccactttctgctgatatggcgggtctgtgcgctcgtactgataatgttagtcaaccttggatgtctccagctggttataaccgtggtcaaattctgaacgtaattaaactagctgttgaagctcgtcaaccgcaacgtgaccgtttgtatcaagaagcaattaacccggttactggcacaggtggtgatggttttgttctgtttggcgataaaactgctaccaaagttccaactccatttgaccgtgttaacgttcgtcgtttgtttaatatgctgaaaacgaatatcggtaattcatcgaaatatcgtctgtttgagattaacgataactttactcgttcttctttccgcatggaaactagccagtatctgcagggaattaaagctcttggtggtatgtatgagtatcgcgtagtttgtgatactactaataacaccccatcggtcatcgatcgtaatgagtttgttgcaagcttttatgtgaagcccgcgagatcgataaattatattaccctcaacttcgttgcaactgcgactggtgcggatttcgacgaattgatcggaccgcaataatatctcactgggccttcgggccctttggattaaaagtgattatctctaaaactgttaagataaaaatcgttcctcagaacttcaagtacttctctaatcttggatataaactatctccgcttggagcagttaaacatggatttgaatattattctatcgatgttagtgtagagcatctaaaacctggatcaaatattgatgtagaatgtgtatgtgataaatgcagtgagcattatactcaaagattttgtagaaatactgatgtatgttatgaatgtagaagtggaaaatttaagctcggcaataaaattggaactaagaacaaaggaaaaatcttggtttctatgcacggcgaaaatcatcctcgttggaatccaaacaaatcagactacaataagtacgcttctgaagttcgtcgcataaccaatagaaataaatcgatttattcaaagtgggaaaatttcgataaaatcggattatgtggtgtagaaggagcttatcagttagatcacaaggtttctatcaaatacggattttatcatcatataccagcagaaattatagggtgtattgacaatttagagataatcacttgggaatccaatagagataagtccggtaaatctagtatcgatttatgggatttacttaagtgatcatagaattaacttagggaccttctaacgagggtccataaatatatacagatcacacaatttaattcgtctcgatggttctggtgaatctggagctatataaataaacacatagaggttattatgtttcttgatgacatgactcgtgcatttgagtctggcgacttagctcgtcctaacttgtttgaagtagaaattccgtaccttggcagaaactttagctttaaatgtaaagctgctccaatgcccgctggtatcgtagaaaaagtaccagttggttatatgaaccgtaaaatcaacttagctggtgaccgtacatttgatgattggactgtgactatctataacgatgatgctcatactactcgtcaagctatcgttgactggcaggctatctgtcatggtcaaggcaacgaaattactggcggtactccggctgaatataagaaaactgcggttgttcgtcaataccatcgtgatggtaagacagtaactaaagaagtaacaatcaccgggctgtggccaactaacgttggtgaagtacaaatggattgggattcgaataacgagatagaaacgtttgaagtaacgtttgcgatggactggtggttgtaataaatatattcaaacctcaacttcattgtttgaatatgttgcacttatcttacaatttatacggggaataaacttccccgtcattttttagatgctgcaaaactgttataaataagtatatgcttattaccctttcacggagactctaatgaatttcaatattttaagtctttttgctccttgggcgaaagaagacgaacaaaattataaagaacaaattaaaaatgacttagagtctattactgctccaaaactggatgacggtgcgcatgagattgagtcttcagccaatgaagcttcttataacggcctgttccaaaaaatgctaggaagtcatgaacctggcatgaaaaataccagggagcttatcaatacataccgtaatttgatgaataattacgaagttgataacgctgtacaagaaatagtaatggattctatcgtatacgaagacggtcatgaagttgttgctattgagcttgatacaacggattttagtcaacgtataaaagaccggattattgaagaatttaacgaagttttaaattgtcttaattttcaaagaaaaggcgctgatcattttaggcgttggtatatcgattccagaattttctttcacaaaataataaatccaaaaaacgtcaaagaaggaattcaggagctccgtcgtttagacccacgaaatgttcaatatatcagagaagttgtaactgatatggaacaaggagtaaaaattgtaaaagggtataaagaatattttatatacgacaccggcaatgagtcttatcaatgcgacggcagaacgtatgatgccggcacaaaaataaaaattcctaaatctgctgtagtatatgctcattctggtctagtagattgtactggacaaaatataatcggatatttgcatcgggctgttaaaccggctaaccaactgaaattgatggaagatgctttagttatttaccgtattacccgtgctcctgaccgtcgtgtattttatattgatacagggaatatgccttcacgaaaggctgcgcaacacatgcaaaatatcatgaacacgatgaaaaaccgtgttgtatatgatgcatctacaggtaaaattaaaaatcagcaacacaatatgtccatgacggaagattattggttgcaacgtcgtgacggaaaagcagtaacagaaattgatactcttccgggtatgtcaggaatgagtgatatggatgacgttcgttggttcagaaacgctctttatatggctttacgagttccattatctcgtattcctaacgaccaacaaggcggagttcaattcgatgctggcacatctatcactagagacgaattaagttttacaaaatttatccgtgagcttcagcataaatttgaagaaatcttcttagaccctcttaaaactaatttaattttaaaaggcgtaattactgaagatgagtggaatgatgaaataaataatattaagatttcattccaccgcgattcatatttctccgagcttaaagacgctgaaatcatggaacgcagaatcaatatgcttcagatggccgaaccatttattggtaaatatatttcgcatcgttcagctatgaaagatattcttcatatgagcgacgaggaaattgaacaagaggctaagcaaattgaacaagagtctaaagaggctcgttaccaagacccagaaaatcaagaggatttctaatggaaagtcaatttatttccgcatgcttatccaacgacctcgttcaggcacgtaagctttttgaaagcatcatgcttgaaaggactacggatttaattggcgaacgcaaagttgaaattgcgcgttcgtttttaattgaaggcgaagagccaaaagacgaagatgagtcagatgaaaaagataaaaaagaatctgacgacgccgatgaaggcgatgacgaagatgaggataactaatgtttcttatccctgaagaccatgaattagtaatcgaaaatgtcgagactcttattccagaagctcagggccgttacgagtcattatcaaaagcgttaagcaaagacgatataaatacaattgtagaaaacatgattgaaaccgataccgatttagcaattgcactcggttcaattaacgaagatatgcaaattaacgaatttatcgttaagcatgtttcaagtaaaggcgaaataactcgaactaaagaccgagctactagagctagaaacgcatttcaaactacaggattgtctaaagctaaacgccgccaaattgctcgtaaggcaaccaagtcaaaacgcgctaatccgtcaggacaagctcgtggacttcgtaaacgtaagaaagctatgaagcgccgcaaagcgttaggattaagctaatgaaaaaatatggtaaccacagaaaaatttgggaagcagttaatggtcctataccattagatgaatttggacgtagttaccatatacatcatattgacggaaatccagcgaacaatgaattatcaaatttattatgcttaagcccaaatgaccattttgaattacacaggtctcaaggcgatttcggggcagcgtttttattactgaataaccatttatctttatccgcagaagagcgctctgatattatatctaaggcaaattcaaatagatggaaaaattattctgatgctgaacgcaaaagcataataaataaaaatagaaattcaaatatatttacttggtcttctgaaaggcttcgaagagagactggtgctaaaattagtgcatcacactcagccaggaccaaagagcagaaagagcaagaatcaatattaagatcttcttctataaaatctgcttggaaatctagttcatttgacgctcaaagagaacatatgtcaactaaagttgtatgtcctcattgcggaagggaaggacaaaaagctgctatgagcagataccattttgacaggtgcaaatatggaagagcagttattaattgagaactggggtttacccggtgagataaaagaaggaaaacctctaattgaatcagtagattcaaacggagaaaaattgcctcctggcttgtatattgaaggaatattcctccaagctgaagttgtgaaccgtaataagcgtctttatccaaaacgtatcttggaaaaagctgtcgctaattacatgaaagaacaggttcagactaagcaagcattaggagaattaaaccatccacctcgcgctaatgttgaccctatgcaagccgctataattatagaagatatgtggtggaaaggaaacgacgtatacggacgagctcgtattattgaaggtgaccacggtcccggagataaattagcagctaatatccgagcaggttggattccgggtgtttcaagtcgtggacttggttctttgactgaaactaacaaaggttataagattgtgaacgaaggttttaaacttactgtaggcgttgatgcagtatggggaccttccgctccagatgcttgggtgactccgaaacaaatttcggaaggcacacaagattcggcaccagctgccaagaaaagtgctgatgaagcatttaagactctcgcagagagtttaaaagcattataaataataatgtaacttaacaacaggaacatcaaaatgctgaaacaagaacttatcgctgaatccggtgcgctggaaatcgcggtagaactcgacagcgttttcgaatcagttgaactttctccggaagtaaaagctaacttcagcactgtattcgaagccgcagttaaaaaaggtgccgctgacctggcagaaaaacgtattaatgctctggtagaagcagcagaagaaaaagttaaagacgaaaaagaaaaagccgaagaagaagctgaaaagaaaatcacagaagctgcttctaaatttttcgaccatttggccaaacaatggctgagcgaaaaccagattgctgttgaccgtggtattaaatctgagttgttcgaatctatgctttctggaatgaaagaactcttcgttgaacacaacgttgtagtcccagaagaaagtgtcgacgttgtcgctgaaatggaagaagaactagctgagcagaaagaagaaactgcgcgtctgttcgaagaagtttcaatgcgtgatgcttatatcaattatgtaagtcgtaccgttgctgttaatgaagccgttaaagacctgactgaatctcagaaagaaaaagttgaatctttaactgaaggtatggaatattctgatgcttttggttccaaacttgaagcaatcgtagaaatggttaaaggtagtttttcagaaaatgcggcagtaaatgaaagcataaatactgttgatactgaggcaactggccttaatttcgtaactgaagcggtcgctgaaccgtctgatccggcagaaaaagtagtagctccttcaatggcagcatacttagctggtgcaaaacgtctctattaatttaacaaggttatacaacacatgaaaaagaataaactcgtagaaaaatggcagccgctgctggaaaacgaagaactgccggaaattgttggtgctagtaaaaaagctctgattgccaaaattcttgaaaaccaggaagcagattttaaagtatctccggaataccgtgatgagaaaatcgctcaagctttcggttctttcttgactgaagctgaaattggcggagaccacggttacgatgctcagaatatcgctgcaggtcagacttctggcgcagtaactcagattgggccggctgttatgggtatggtccgtcgtgctatccctaacctgattgcttttgatatctgtggcgttcagccaatgaacagccctaccggtcaggttttcgctcttcgtgctgtatacggttctgacccgctggctgataaagcaaaagaagctttccatccgatgtattctccggacgcaatgcattctggtcaaggtgccgctgagaaattcgctaaattgaccgctggcgttgctatcactgaaggcgatatcgttgttcatgattttgctgaaacaggtcgcgcttatctgcaggctgtagttgctgtaactccagatgctggcgctactgacccggctaaactcgacgctgctgtagttgctctgatggaagctggtcagctggctgaaatcgctgaaggcatggctacctctatcgctgaacttcaggaaggatttaacggttcccagaataactcttggaatgaaatgggtttccgtatcgataaacaagttatcgaagctaaatctcgccaactgaaagctgcatattccatcgaattggcacaggacctccgtgctgttcacggtatggatgctgacgctgaactgagtggtattttggctactgaaatcatgctggaaattaaccgtgaagttgtagattggattaacttctctgcacaggttggtaaatctggtatgacccagactgttggttctaaagctggtgtatttgaccttcaggaccctatcgatatccgcggtgctcgttgggctggtgaaagctttaaagctcttctgttccagattgacaaagaagctgcagaaattgcacgtcagactggccgtggtgctggtaacttcatcatcgcttcccgcaacgtagttaacgttctggctgctgttgatacttccgtatctcctgctgctcagggtctgggtcgtggttttgaaactgataccactaaagcagtattcgctggtgttcttggcggtaaatatcgcgtctatattgaccagtatgctcgtcaggactacttcaccatcggttataaaggcgctaacgaaatggatgctggtatttactacgctccttacgttgctcttactccgcttcgtggttccgatccgaagaacttccagccggtcatggggttcaaaactcgttacggtatcggtattaacccgttcgctgattctgctgcacagcaacctaaaggccgtatcgtttccggtatgccttctctggttaactctgttggtaagaacgcttactttagacgagtttacgtcaaaggaatttaagatttaaccttaattaagggaaccttcgggttcccttttttcgtttttgatgtaaaacaatattataaataaaatatatcacaaaaggaaagcgcaatggcaaagattaacgaattactgcgcgagtcaactacaacttctagcagctctttagctcgtcctaatttggttgctttgacccgtgctaccactaaattaatttacagcgatattatcgcagaacaacgtaccaatcaacctgtagcggctctttatggagtaaaatatctaactccagataatgagtttagttttcaaactggtgctacttatggcggacaaatcagtgaaaaagaccgtgaaactattccagaattaactagtaaaactcaaacacttgcagttggtgattattttaaatatcaaaatgtcgtgtataaagctttacaagctaatccgttggcatctacaagcgcaacagatttatcagacgcactgcaagaaggattaatttctcttacttgccgtttagttccagatgctgctaatactgaaaaatttgaagatactgatgttgaaattagtagtgctgtatttgaagtaaataaatggaatgctcctgttaaaactcgtaaattgaaaacctcgttgactgtcgaacttgcgcaggatatggagtcaaacgggttcgattctccggcatttttagaagatttattggctacagttatggctgatgaaattaataaagatgttcttcagtcactgattacggtgtctaagcggtacaaagttacaggcgtttctgataatggtattgtagacttgagttacgcaaatgccccggaagcttcacgcaaactgtatgaaatcgtgtgtgaaatgaattcagaaattcagaaaacaacttcttattcgggtacttacgtagtagcttcttctagagcagccgcattgctggcaggttcaggctggttaaaacatcgtccagaagatgatgaatggttgccttctaccgcgtatggatatctgttaaatgggcttcctgtattctgcgatgtaaatagtcctctggattatgttacagtaggcgttaaagaaaactacggtggaaaagaagtagttggttctattttttacgctccatacacagaaggattagacctagatgacccggaccatatcggtgcatataaggtaattgttgacccagatagtttgcaaccatcaatttcattgatgatacgttatgctttgtctgctaacccgtatacagtagctaaagatgagaaagaagctcgcatcatagatgctactgacatggataaaatggctggacaaagtgatatgtcatatttggttggggttaaactgcctaaaataatttatgaggcgccttaatgcaaaaaatagataatttaattagagaatctactgtctcatcggccaactcgcttggccgtcctaatttattgtcatatacaaaagctacaaataagcgtattttcaaatctctcgttgctgaacagaaaactaatcagccgattgctgcgttatatggaatacgtgttcttaatccagttgataaaatgacatatttaggcggcgctacttatgctggtcaaattggtttgtctgaacgtgaatcattacctttagcttctactccatcccaatcttttaataaaggtgagatgtttttatttgaagatgttgtttttaaagcgttagaagataatccattcgctggaacagctgagactgatatgagagaagttatttcagaagctatcgctgctggacatatcagaatggtatctgacgccgctaacacaaacaagtttgaaaatggtcacccagaaattgccgaagctggatttcgtattgataaatggcaaaccgaagttaaatcccgtaaattgaaaacctcaataactgttgagttagcacaggatttagagtctaatggttttgacgctccaaattttatcgaagatgttttagcagtacaaatggcggaagaaattaataaagatgttcttcagtcattgattacagtgtccagccggtttaaagtacaaggtatatcggaaaaaggtgttttaaatttaacggatcctaaatacgataatgctcaagaccgcgcgcgtactctttattattatatgtgcgaaatgaattccgcagttcagagacaaacatcattttctggtacatacgcagtagcttcatctcgatgtgccgcgattttagctgcatccggttgggttgaaaaatcagaagaccaagatgagttagcatatggtgtattaaaaaatggtttgccactctatgctgatgtaaacagcccatgtgattacgttattgtcggtgtaaatgctgatttaggtgaaggacagacggttgcatcactgtattatgctccgtatgttgaggggctagatgatgttgatgaagaaggtgatacttctgttggtgagttcaaagtaattgttgacccagatagtttacagcctactattgctcttttagctcggtatgcattaactgctaatccatatacagtagctaaagatgagaaagaggcacgagttattgatggtgctgacatggataaaatggctaatcaaagccaattaagttcttatcttggcgttaagttaccaccgcttgagaaataagaaaaaagggccttcgggcccttataaactaaatatatcaaacttcggagcatactgttcttgtagctcttcgaaaactttcttatcattcaaatttgtacaaggtattccgtgttgtcttgcaatacgagtagctatacgagttccaccctgttcttccccatttcttactggacaccaataataaacgcggtcaaccggtgacatacaatcttctcccaaaacttgcatcgcatttcgacagaacaatgtctttataatatctcgttcagaatccagccctggataagcttgcttagctttgacgtaactctttatacgagattcattacttaaatcagaccagcaaaccacgccaataccggtgtggcaatgattaaacccatcataaggaataatcctaagcgaaagatgtctatcatatctgctcaaccaagcttcgtctgagcctggagctccaccagaataagagaaatgaccagcctccgaaaaggccaatcccattaaactcattaagtcaagatactttcttggtgcttctcttgacccgattaatgctaatcttaacttacgatttctagccatttttctctgatagtattactcacaacagtctgaagttctcgttttacgaggtccggattatcagcatgaacaatatcaacaccttctcgtttagcttcaataaagatatcctgtattgtcagacccataaccttaccgaagtctttagctttaacttcgccaatatgactaatcacgttagatacacggttccacgtagagtattcacagaggttcgccagaacggtcgagtcgttactagttaatacagctttaggtttaattggcttatcagattttttcttctcagtgaatctggagttcttagatttaattgcaatgcgggtgccattattaaagaaatcaggataaactggttttagtacgtaaccttcagcaacattatcatctgtcactaatgggtcaaatacacacaaattgacttctttcaaatcatcttttgctgcttcgttataagctttgattacagatgtaaaattatttggtaattgaataagttcatcaaaagaaccacatccaataaatggagccattttaaatccgaattcgttacagaacgaagtcatcatcatatcgtccatataaagaacattaccattttgagtatttactagaatgtcaaatacataaaagtctttttcaccataatcaacttctttctgaattccttgacccgcgaactcaccaaaaatttgataagaacttactgaaccaagttcattcgcattcatgcatcgttgaatagttttaatagactcgtcataattcttcaatataatttcgtggccatagaatgattcactaggaagaatgggaccactgcgcttgcacgcagaaactgagtctttggatacgatgattgagaaattagtgccatgaattttttcacgagctacccacaaaccgccatctttaccttcaaaccgaattttagaaataaatttattgttgtagtggttttcaagagaggagtacttcttaaacattttttcaccattataaatagattaaatagagaacttctattcttttccggcagagtgtaatggttactagatattatccttgaaaccattatacaccataaattcttaaagcattttaccacgtaatcataatatacgtgccggaaatttggcattggttccagtatgccgtaaatccttcatcttttaaccatgacatgatatttcctttgaaattagtttcttttgggtagaaaaccagttgagtcttcccatttttggcagcattattaattgattcttcaattagttctttttgcttaacaaatccttcattgttataagaatctgctaagttacggtatttttctgataataacatttagacctcgcttggaataatacgaatatcgatgaaactaaaatcttttgattgtcgtaattcaatctgatttttatcaccaacttcaataaccactatttcatttaattcgatttcagcgatattaaaagcaaatcggtttttaattatgttataaagtatcacaagataatgttcattgtaaaacgaactactatctccaaaagaatacgataattttttcataaaatctttgattgaacaccatttgttcacaccaagcgatgctggagcaaacaaattttcatacagcatataatcaatgatgtcagtaacaactagttccgagtctatcagcacttgagttaagtttttcatactattcctctcattttattaacaagtttcttacgacgaatattaacatcaatatttgataagtgtttacgataaacaatcttctctttgtttttcgctttatctcttgcggcctcaactttagtaaacattaaagccgcgtcaaaagcacttattccacctataattttagcaatatctttaaatgacttgccgttttcatgcatcatgtgcactttaatttctgttttcataatcatctcttcgttggaattgaattcattgtaatcatactttagaaaagcaaaaagggccgcaagggcccttcatgttatggataaataataccagcttctaaagcagaacgatgcacaatatatccatttctagattcctgaacatcaacttctggataatcattaagcatttttgctaataccgcaagatgacaataatatggtgtatcagcttcggtagctgttttccaatctttaccttcttcagtgagcttctggatggcatccataacccaccagccaacccaaatataagctgaatgacgttgtggaagaggatgaacataaatcagtgggcattcttccggaacaacaggttctgctgcttcaacagtaacagacacattaccggttttaactgaatctgtaaatccagattgtgacacagtaacttcacaagcatatgtcttcaagccttcagtagattcagatactactcttgtggcttctgtcgagttgtcatcccatttatacgcaagagtagcaccaggaatagcagggtttatagaagctgtcaaattgaacggaacatcaactgttgcagtagacgggctcgaaatgtcaacagtgaactcagggaacgtattattttcaacagtaataactaccgcgtctggcgttatagtttgattgttataatccgttgcagaaacggtaattaaacaagtcaaagaaacaggtcccgcgacagtagcagtacgagtaatatctttagtagtttcaccagtagaccacaaataatcaaatgttgcaccacttggggcaccttcaacatttgcagaggctttatattcctgtccaactttaaccgttggagtagaagttgataatgtaccggttgcagtcatagttttattattgactgtaatggtagtttgagcttctgcggtttcaggttctccttcggctggggttgtggttgccacaaccttaactactttcgaacccgccggactagccgcgatgtaatccatggtagcaataacagaactctgtggaaccccatcaacggtccatacaaaagattcggtacctgcagcagccgcgccggctccagtagcagtaaatttagtcgttgctcctatgacagctgtaggcgttaaaggggcaattgttacggtaaatgccatatttcctccaaggagcttttgctccttttatttttgtttagtataagcgcacaaaagatgaatttcttgtttcgcggataagaataaaaccgtcgcgttgaatataataaatcaaacttagaagagtttgatgcgcggtagcatgtggaaaagacaatggtctttctttccagtcaggattttcagaaatccattgataaatccaccaaggtaaagtataataacctggatttttacccatcagttgaaaatgaggattaaatgattcggggagagaaaagcttttattttcaacaaccgcagtatcatcaataatcttcattatttcatcagcagaggcagtttctggaatacgaactgcatcttctggaatttctttggttttcgccacttctaaaacagtaatggtttcttcggctggagagtcaataataagctctttgacttctactttatcttcgggttgaaccaaatctttttgttcttctttatcgtcgtcaattaagtcagaaattgaaataccatcattatcttctggaagaggagcatcagcgagcttttcaaattcagcttctaaatccaaaagcatattttcgaatgacttagttttcttcaatttaataccaaattgagatgcgtactcatcgagcttatctttagcttctttcttttcaagtacacggatttcttctatataattcatgtctagcatagtgttgcctctttagttatataaatatacttgtatttataacacggagatgtgaagttggaaaattgcaagtatcattatgtttatgaaataaccaataatattaatggtaaaaagtatataggaaaacactcaaccaacaatttagatgatggatacgtgggttcgggtgtttttataaaaaaggccatcaataagtatggattagaaaatttcactaaaataattataaagaaatttgatacatccaaagaagcttttgagtttgaagccgagatggtaacagaagatgttgttaaaaaccgaatgtattacaatgcgaaaccgggtggttatggcggaatttatatgacagaagagattaaaaagaagatgaaagagtcatctagaaaaagatatctcaattcgcctggcacaacattgggaactacgtgttatacaaatggaaagaaaaatagatttttaaaacctggcgataaaataccagatggattttatattggtcaagttattccaaataaaaaatgccgaaaggggtgcgccgttaaaccaactacaactggaacattttgggttaataacggaacaataaataaacttatgcaaccgtcatctgaaatcccagttggctttgttaaaggtcgcttgatgaagcgtggtattaatggtgaattcataaagggttaattgtggatataaaagttcattttaaagactttagtcatgtttatatagaatgtgaagaatccattctattcgaactaaaagactatttttcattttttgctgatgggtataaatttaacccaaagtttcgttatggaaactggtcaggtaaaatttatttattagaccataaccgtcttttacctttcggtttagttggtcaaattaaaaagttttgtgataactttggttacaaattttggattgacccaaaaatttttgaaaaagaagacttgtcccgtaatgactttgatgaatggttagggaagctccagatatactctgggaacaccaaaattgaaccgcattggtatcaaaaggatgctgtatatgaagggatagtgaaccgcaggcgtattctaaatttacccacttctgctggtaaatctttaattcagtgtcttctttctcgttattatgttgaaaaatatgaaggaaaaattttaatcatcgtcccaacaattgcgttagtagaccagatgattaatgatttttgcgattaccgcttatttggtaaacagcacatgcttggtattcgatcgggtacaaggcgcgactcggatgctatgatttatgtcgcaacctggcagactgcaataaagcaaccaaaagagtggttttctcaatttggtttgatgatgaacgacgagtgctttgatggcgacacattaatcaaaacaccaaatggtgatgttaaaattaaagacatcaagcctggtgataagatttattcttataatgaagatacaaaagaagtatttgaagatgaggtagttaaacttcataaaaacttaactaagtcatcatctgaaaaaatgtatgaactcgaaatggacgacggtactatcataaaagtaaccggtaaccataaatttttaacaaacagaggctgggtcagagccgatgaactcactgaaaatgacgacatagtagaatggaaataaaaatattacgcggcccaagcggccgcattctaactaagtctatggtcaaaaacggtacaataaatgctttaaaagccatgtacacgtggtgtatagataaacctagtgctttggtgtactgttatgaaaataattctattcaacctaattgtaaattctgtggcgaagggttaaattcaccgattaatagctattgcaatccaagatgtcaaatgaaacaccttggcggatttcctaaagactgtaatgttggaaagaccccgtggaataaaggtcttaaagataattctagacattgcagtatagtaaatccggaaaaatgggaagcagccaagcataaaatatccaaagctaattccggagaaaataacggaatgtatggttgggataatgaagaccagcgacggcgtcaaagcgaaactataaaggctaaaatactttcaggcgaatttactcctaataccaataacagaagaacttcatttgatgttgtgtatgatggaaaaaattacagaagcagctgggaagccgcgtacgcttccataaacaaaactgctgtacatgagagaatccgtgttccttatattggaaacgatttaaagaaacacatttatatttcagattttttaaatccggaaacaaacgaaatcgtggaaatccgtccggcgtctctatacgatgacaatcatccaaaaattgtggctattaaaaagtattgtgattccaatggatataaatatactcatattgatatagagtatttctacgcgaaccgtcatttgatagattacgatggtttaggtgatgacacatccaggaaaattacaaatgcgattaaaaagtataaaagaaataaaaaaacctgacgttgtatacaacttgcatgttaaaacaaatcacaactattttgcgaatggtgcattagcacataactgccacttagctaccggtaaatcaatttcaactattgtttctgggctgaataattgcatgttcaaattcggtctttctggttctctgaaagatggtagagctaatatcatgcagtatgttggaatgttcggtgaaatttttaaaccagtttcaacatccaaattaatggaagacggtcaagtaacagaacttaaaattaattctatcttcttgcgttacccggatgaagccacggttaagatgaaaggtaaaacatatcaagaagaagttaaagctgtcactggatttaaaagaagaaataaatgggttgctgctcttgccaaacgattggctgataaaggcgaaaatgcttttgttatgtttaaatttactgcacatggtaaagagctttatcagatgattaaagaccttggacatgaaaaagtttattatgtttcaggcgaagtgtcaacagaaactcgtaatgctctcaaagaaatggcagaaaacggtaaaggaattattattgtagcttcttacggagtattctctaccggtatttctgttaagaatcttcatcacattatttttgctcatggtgtaaaatctaaaattactgtattgcaatcaattggccgagttctacgtaaacatgcgtcaaaaagcttagctacagtttgggatttaattgatgatttaggtgttaaaccaaagtcagctaacacaaagaaaaaatatgttcatattaattatttgttaaagcatggtttagagcgtattcagcggtatgctgatgaaaaatttaattacactatgaaaactatcgatctttgaggaaactatggaatttaaacaatttatacgtgaagcaagcatcggttcatttatgaataaaatcgctcaatgccagacattagctggattagatgaactggaagcttattacaagaaaagaattaaaacaactgaaatcaatgacactgatgatatctctattcgagacgctttggcgggcaaaagaatggattttgagtcagatgatgagtctgaagttgaagaagatttctaatacaaaaaagccccgaccacaaggaaggggcaaaaccaacaagttggctatcaacactagactaaattagcaattgagtttcgtttaaatgctcttctgtattttcagataccggcaattcaacgacataattataacacggcccaggatgaacaggacctttatctgtgtgaacaaccaatgccgaatcgatcggttgcttacaaacagcgcagatttcagacattgtttgtctcctttagttaattacatatctatttatacagttatttacccgcctcaaactgtctcatctcaataacatgcttaattccaaaacctctggatttaatagcatccattgctcctgagcaaaattcaagcaaaattccccagtattgtaaactagtgtcaattttaagaacttcagaatcagctcccaaaactgttttcatttcagacttttcgtaacggtccatgctaaaatcatctccatcaccacgtcccgtgtagtagtccaatttctttttaagagctgattttttctgtgcttcaatacgaagcatttctttacgaattgatgaatgcttatttaaccattttccatacaaaactggattattagcagcttcgtattgtaatttagttgagtctaagattaaatcttgtttcaactcttcttgtaaatcctcgagtttcaattcattacctctttcttgttcatttgtaatcttgttgttattgattgaaaggaactaagaccattataaccattaatcactgaaagcgtatcatctattacttgaagcaagttgtagtttaatctgctcgatatcatccggattatcaacaacgctgaattgaacttccactataagcgtataatcatcataaactggagtgacattaactgctaaatatctaatcctcggctcgtatgctcgtatagaagattctatatttcgttgaacagtgtcagcagtcaatggcgtcatattttcaaataattggtccgtaagcgagcaaccaaaatttgggtcaaaaggcctgcttccttttctggttgttataatacctaaaagagagtttttaattgcccgaagcccgcgtgagcgcgctacgtctttatcccagtccattttaaattctgggtcaatatctgaatacaaattttttatatcagccattatattaacttaaagaattctttaagcccctttatgatatgaacatgattttctccgcattcactgcatttaaccggaactgcgagttgtactgtgggttttagcaggagatttttaatattaatgatatcgtcttctgttatagcagaatataaatcttctatttctctgctgtttaaatcttcaataccgatagtttcgccattaacgtgaatggtttgaatacacgacgatatcatagaagcaatgttctcatcctcgaaaagatttggatatctgagttttattttaaaatgtctcaggttataccagagctcctctggttcatcgatacatgcgaatgtaaagttaatcggcacttgtgtttcatgtccgcaggaacacacccatgtattctggtgattaacctcacctaaactgtgagaccacaaatttactaacaataattcagattcttgcttgttcaaatttttagcatttgtacagtttttaatcaaatctaatacgttttgctttacatgaccattttgtttagctatgattagatttttatattcttctagtgtaaaagccctgcactcgatggtcttttcaccgattaggacttcaaaattatagtcatagttcatgatttactcctcttattactttatttataaatattaataaaggagaccacaatggctaatatcatacgatgtgtgcttcctgatggtgttcaccgtttcaaaccgtttacagtcgcagattatcgagattttctgcttgttagaaacgatttactgaacaagtcatcggacgagcaaactaatatactaaatgaacttttaaatgattattttcccgaatttcccgaaacttggagacctcatatttttcttaaagtttttaccgggtcaataggaaaaacaaaaataccaattgcgttttcatgcccggtttgcgaaaagaagaaacaaacattatttgatttgcatttgaatgatttaaaatctccggaagtagaagttgctggtattaaaatttattttaattttcctgataaattttatgaagataaagcccaacaaattaatgataatataaagtctgttttatataacggaacagaaattttatgggaagatttatcagaagacgataagttacaagttatcgacgctatagatattgacacattagaaaaaataataagtcaaatgacaccaatgagtttaactcttaaaatgaaatgctgtaaaactaccactataaaatatgaagattttttaaatatattttgtcttctattaaatccagatgaagtttttagtttttatcagattaaccatatgctggtaaagaaccaatacgatatgaacagcataatgaatatgatacctgtagaacgaagcatagctctttctttggtagagaaggataatagcaaatgataacacaaattccaggttttcccaatttaagtataaaactttatcaagattacgattcttggcaaaccaaccgatacgtcgagcttgctgctaccgtaataactttaacaatgcgcgacggtctatatggtagaaatgaaggtgtattgcaattcttcgattcaaagaatttacacactttaatggacggcagacaaataatacaaatatccgtagctaattcaaatacaaagaaagtgcaaaacagaatttatggatgtaaacactatagcgtatctgttgattccaaaggagataatattttagctataaatttaggactgatacatgaaatagaagacctaaaatttagcagatgcttttttaatgatgctggtgaatcacttaaagaaatgatcggtgtcatatatgaagataaacctttaatagctcctgctatcaacacaatcaacacatacgttcctcgggttccgtggactagcaatataacaacttataagcagtacgtccgagatataggtttagctgtagataatgaccaatttgtttttgtatgggaagacatttatggtttaaacatgatggactataacactatggtaaatcaagagaccacaaaagttgtagttggtgaacctaggacaataggacaatttgttaatgagcttgagtataatttagcttatgattttgagtggctaactaaagccaactctcatgtacgagaccctatttttaacgctactatatattcacactcatttatggataatgaaattccaagaatagtaactggagatggtagcaatagtatttttgtttctaggtctggtgcgtattcggagatgacatacaggaacggatatgaagaagcagttcgtatccaaactatggcgcaatatgatggttatgctacctgtaaaatggttggagattttgaaatgactccaggcgataaaataaatttcttcgatacaaagagacagttcagagctgatttttatatcgatgaagtcattcatgaagtttccaataatcaaagtataactactctgtatatgtttactaattctcgtagaatagagaatgttgaaccaattaaggtgaaaaatgaacttaaacctgatacttccaattaagaaaataaaatgcaataataaagaaatatctattcctaagctcggtttaaaacatcatcatttaataaaagaagtgagagacctatcagaaaatatggggattttgttggattcaatccacccaggcctcactgcagcagaatccgacttagtgtgtcttcatttattagaattcaacggtaaattaaagtctactgtaacaaaggacggttttacttacaatataaatgacgtttatatatgccaacggttagaatttcaatatcaaggaattacattttattttcgttctcctgagaggtacgaagtttttaccacagtagataaaatgctgtcttcttgttttattaaaactaatttatccgacgaggcacctgatttccttagaatgccagcatttgtttcaaaatgggcagatgatataacaaacatgatagcaattcctggtccacatgaacctatcaaaggaacctctaaaatattagggctatttgaatgaaaaccgaaaacatgacatcctttagacgccgcaaagttattgctgattctaaaggagaaagagatgcagctgcggctgcatcaaatcaagttgaatcattagattctatagggtacaaattagactcagttcaatctgctacggagcttacatctgaagtaattgaacagaaatccaatgatattatatccgctgtgaatgacactacagctggtgttgaattaacagccgaatttgctgagaatacttcaaagacggtaagagaattaacagatgtaacatctgcgataagcgacaaaatatctaaattgacggatatgcttgagcagaaaatacaggcagttcaacaaaaatttgttgatagctcaaaggttaccgatgatactcttaaagtcattggagacagcattcctgagcccgttgaaagtaatttacctgcaatcccggaaaaaatattcgataaacctgaagaaaataattctccggatgctgatttctttccaactttaccaagtaaagccgaagaagttgataacaaaaaagactccgataaaaaaattcttgacactgaaaatttgttaaaagatttggtcgggactacaaagactgggttcaaagcaacagtttcaataacagataagatatcaaatatgttattcaaatatactgtgtccgctttagctgaatcggcaaaattagctggaactatttttgctattgtacttggtatagatttgcttagagcccattttaaatattggagcgataaattcagcagcaactttgacgaattcagtcaatccgccggagaatggggtagtttattgcaatctgttctgggctctttacaagaaattaaaaaattctgggaaaataatgactggtccgggttagctgtggcaatagttaaaggtcttgctgatgttctttataatttaagcgaattaatgtctttaggcatttcaaaaatatccgccgctattttaagcgctcttggatttgataatgctgctctatcaattaaaggtgctgctcttgaaggatttcaagcaagaacaggaaatgagctgaatgaagaagaccaagatacattagctcgttatcaaactcgccgaattcaagaagggccggatgcttttgataaattttccgaatataagactagagcttttgattttataacaggacgagataataaaaacaccacaacaacggaacaagaacgggaagctgaagttaagaagttaaaatctcttccagaagaagaattaaacgagattaataaaaagagcaataacgctagagccgctttagttagatttgaaaaatatatgggtgatgttgaccctgaaaatgcgactaatattgaatctctggataaagcttacaataatgttaaatctcttgttaatgattctgaactgaataaagccccagctattaaaaaggaattagaagtacgtttacaaaaagctgaagctagatatcagaaaattaaaactgagtctaagcctgaacctgctgccccatcagcctctgaagacgtgcagaaagttcaaaacatcgaaaaggcagaacaagctaaaaaatcagatgctaatcagagcagttcatctagcgttgttaatgcccaagttaataacgtaaataatagtagaacaattcaaactattaatcctgttactgctacacctgctccgggtgtatttaaagcaacgggcgtaaactaaggaaaaattatgattgttaaagagcttaaagatacggctaaagaactatggaataaaggcgaaaaaatttctgctggtcaaagttctcaatcatctaaaattaaaagcactgtaactgtacaatacccgtctgagcgttcagctggtaacgatgttacaggcaacttgagagttcacgatttatataaaaacggtcttttatttaccgcatacgatatgaattctagaacctctggtgatatgagaaacatgcgtctgggagaactcagacgtacttcacaagatatagtcaaatccgtgaccggtaaaaatactaaacaggttgataaaatacctgttgctaatattcttttgcctaggtctaaatccgacgttgattcgacttcgcataaatttaatgacgttgctgattctttaatttcaagaggcgggggaactgctacgggagttttaagtaatgttgcgtcaactgctgtatttggtgcgttggagtctgtaactcaaggactaatggctgataataatgagcagatatacaatacggctagaagcatgtatgctggcgctgataaccgcacaaaagtattcacttgggacttaactccgcgttctgttcatgaccttatagctattgttgaaatatacgaatattttaattattattcttatggtgaaactggtaattcaacttttgcaaaagaagttaaatctactttagatgaatggtataaatccacttttttagatactttaacacctaccggtgctcctcaaaacgatacagtatttgagaaaataacttcatttttaagtaacgttattgttgtaagtaaccctaccgtgtggtatgtaagaaactttggtaatacttctaaatttgatggtaaaactgatatttttggaccgtgccagatacaaagcatacgatttgataaaactcctaacggagttttcaatggtctggctgttgcaccaaacttaccgagtacttttactttagaaataacaatgcgtgaaatacttacactcaataggtcgtcaatatattcggaaggtttttaatgtatactttagatgaatttaaaaatcaggcagctaatatagacttccaaagaacaaatatgtttagctgcgtctttgcgactactccttctgcgaaatcccagcagttattggaccaatttggagggatgctatttaataatcttccactgaataatgactggcttgggttaacgcaaggagaatttactcagggcttaacaaatataataacttctggtacaagagatttaactagaaaatctggcgtatccaaatatctcattggagctatgagtaaccgagttgttcaatctttattaggcgaatttgaagtaggaacatacctgattgattttttcaatatggtttatcctcaatcgggcttaatgatttattctgttaaaataccagagaatagattgtcacatgaaatggacttcatgcacaattctcctaatataaaaataactggcagagatttagaaccgttaacagtgtcattcagaatggacccagaagcttcaaattatagggctatgcaggattgggttaatgctgttcaagacccggtaacagggcttagagcacttccaactgatgttgaagctgatatacaagtcaatttacacgctcgtaatggaatacctcacactgttattatgttcactgggtgcataccaattagttgtggagcccccgaattgacatatgagggagataatcagattgctgtttttgatgtaacatttgcttatagagtgatgcaggcaggcgccgttggtcgccaggcggcgatagattggttagaagataaaactgtcgattcaatagataagataaatcccgatttatctctaaacggaagtttaagcagactttcgagattaggaggagctggcgggggtatttctaatattgtaaatagagtattctaaaaaaggggaccaacgcggtccctttttttagttaacgaaatacaacaaatcctactacattagatatttgattgtcctcagcgataatactaattgcacacggaacttcaccaactaaattacccgacaatacgccagaaatatagttatcagcttgtccttcttttaccccaaatctcggtaaagggtgtaattgaaaatttttgtcagttccatacaattcttgaagcagttcatatgctgcttcattaaattcacgcgaatcaggtttagcattttcaattacaatttcagtgcttgcaatacgtaaaatagatttcataatatgttcctcatgttgatttagtataattataacacatccttccatggatgtaaacggtcaatcgacaaaacgatttggtgtatcgtcgaggtctataaacgaagctaaaagagataaaacactggtctcttcagatattttcgcggatttgacaaaattaccaaaatcaatcaatccagcgcccaaactccctcgttctgtatcatctgaatactctataacttcaccagtttccattaaatggtccccgtcataaacaacagtacattcagaaagttgttctgatgtcatgatttcagcttgaatgaatttttgattgctgtattccattccgtcattatatgaagcatctgtgattttgttaatttgaaccatcgtaccacgaggtaaaatgatttccatttcactagtcatgttacttaaatcacctggataaatcacattaactttatgagcgccgtcaatagcccaaccaacattaactttaatacgctcttgtttaactgggtccattttagactcataatcgtctaatttaacgtcttcaatgccaccgtcaatattcaatacattcctagtagcgtcagacgtaaatgcgacaccctgattacctttccacccgccaaaaataatcggagctaaagaagttgatacataattcctaaaatagaatactctgtttttaaccaaagcttcatatatcggtttgcgaattgtttgagaacgccaaattgtgattccttctggtagtctatcgcctcttaaaaaagctttatctaaactagaaatcgcctttttgacttctttttctgttaatgtatcatagttgtcgatagtgtatcgaccgagtaacatattattgatatcagaatacgcagaaccaacatattcttttatgccctgacgctcttctttagtatattgctttggagtgcggtacatagtaatatcacgaatattacgagatactgttttagcataaccttgtaatagctcttttataagcttaactctttgcatgttccatgcgcgttcagcatgttcttgcttttctaaagcagacataccataaggagctgattttatttgagcctcaatgaaattatgcttattttcttctaatctgtcaagcatagtctgcacaaatgcttgcatacttttgacagaagttaaattatcatcgccaattcgctttaaaagctccttttgaacatttttttcttctctttcaaaatccgtaaatgtcttacctacgattttggaaacatgatagacaatttcacctgatgcagtaagagctgatacagcctttgaagcttttgagcttatagcatttaaaatctctttggattctggaattattttcgccgtagcaggtttactaaattcagcggcggtagcttcatagcgttcaaaatctgggccttcaaaacgttcagtttccaaagactgtgacatcgcgacctggcgacgagaaattttagctcgagaaattacgctttgaactgaacgagtgtcattttcctttgcaatagatgaagcaattgccgtgtttttggaaacttgattgccggttttaacatcaacgtaaacttcgcctacagcagtatcaaccttcttgaactcatccgttgatatctctgggacccctggaacggttgagaggtcaatatttttacgatgaataagaatatatgcgtacttcttatcataatcccagagttctttgagtataacgtatttacctccagtgcggctacggactaatcggtccatgataatctggagttgacgggcttgtccgccaattttagatttagtgatacggaacaacactgcatcaattttatattgacgcatagatgaataaacaatattgaatacggtagaaatagttccgattgggtctggacccaagtttttcattttaaccaaagaacctttttcgctcaaagataacataactacgtgcgccatcttatcgccaggcttaatatttttattagtatcgccgcctgacgtataagtacacatacgaaaagccggcgtcgtaccttggtcaatttcgccaatagcaaaaatctgtggtattttcgtttttggataaagatttgtaaccggaaggtccaacttatcttcatcaaaaacttcatttaattctaacataaacagtcctctatagtttattatatttatagacgaaaaaagccccgaagggcttaatacatttttgttacttgtcgccagattttaattcccggagcttcttcaaatgatactacatcttcaaaatacttatcggctatatcccaactattaaattcgagctggtttgttgtgatagctacattaccattgtctgatagaacagtaacttctaataaaatatcgtaactcataatccagtaacctcatggaaatcaccccagatatctgcaaacgtattagcaacatctttatcacgccgcatctttattgcaataggaagaaacagtttaacataatcagttcggccttctgccgccaaccaaccattacattcactttccaatacgcttccgatatattcttcttggttttcccaaatgcgtgtacggtcaagttcgtgagcgtcttttccgggcttgtcttttaagcctgaaccggctttaactttaattaacccgcattccgattcaagataaaaaccaccagcttttcctggatgtttactatgcggataaattccaacaatacgaaggtcaacagtaattacttctttaaatttatattggttttttgaacgagcattctcccaaaaaccaccaatattcttaagaataatcccttcgagtcctttatcaacatatttgcgataaacgactttagcttcgtcaagattgtggacgatatggttctcaatgagaatcatctgagagtagtcttgaaccattagttccagcgctcggaaacgaacatcatacgcaaaaccaggttcttttccatcggaatatactacatccaatggaacataatcccacacttgaaacttcatacctgcagcttctttggctgagatagttcctttcagagatttgttggctagcccgtttgatgcagttcgagattcgttttcttctgatttactcaattcagtcaaatcaccgaacatatcctctaatggtccagaaggttctttcacagcatgataaaccaactcaccgtcaatcataaccccgcccggatgacgttcacgagcttctttggtcatatcaataagttgctgttttaacaaatctaaaccaagatattcattaccagcacgagacagaatttttacatcatctaattcatcaccacgaacttcggcaaacgcccttgcgccatcagccttaagctgcgcaaatgcagggaatttaatattcttaagaatatctttttcgttataagatgaagcaagcatttgtggttgttctggaattaatccagcccaaactttatttgcaatagaacgggatgcaccacaacgaaggtcacgaagaagaacctttttcaatacttctgcatcagagacattcaagtctgcgatataacttgctaattcaacaatagcagcgttaccagtaatttcacgagtggctaagttatattcaaggaaatctaaagcatcatctaaagttaacattccaaaacattgtgtacgctcaccagcgccaggccacttcttgatgtaatattgaagttttccgtcataagtcattcgaaatacgcgctttaaaacttcattatctttattgcgacgaatgattgcttctttttctttggtagaacctatggctgcaatttcattaataatatctaaaatcatattcatcttctctgtttataaggatacaactattttatcatatccagattaaagcttttaaatattcacgtcatgccagcttttgacgtaattgcactctaatttaggttcatggttcctttcaccgcgaggcatgtaaaacaccttcgcccgagaattatactgtttgaacaccgctgctgcggaatcagtatgtttgcccaggtcatcaacgtaacaaacgacacgctcaccatatttttccattacctgggttaatagagcatccttagatgcattataatcacatactaatatttctttaaatgctcccggaaaaagcgcatttaaattaaactggcgatttagatgagcatcaactgagttacctaacgcagtaaccgcaacgaaatcgtaagttttctttaattcgttaacaactttcaatgcatcttcataaactgatagataccgtataaaatctgagttgttatattttaacaaaagtttggttgcgaattcttctgaacaattaaaaagaaccccaggagcaataaatttttcatcaaccatcatttcaagaatatgatttaatggaagattatatttctgggcaaaatatggtaaaccgctttgccacttaaccaaaattccatcaacgtcagtaacaattactggcttttcttgttccaaaatcatacaatttctcttaacattgtaataggagaaagttcttgttccatgtgcacagaccgatttccgtcaacccaatcaatttcatatgcagctaaaacaccgtacttagcaataggtttaatcacatagcagatagttccaggaatgccagatgatttaagttgtactgtctgaagttctttgtattttgctttcatactttttcagccttaaccaaaataacatcactccatatgccaaacggagggagagcttccttaactttgtggaattctgttgttttatcttcccagaaccatagttttatttctctagttacttggaaagaatccatcgcccgacctgacggtgaaacatcaattacatcaaatgttaacttgtaagttggataaagacgcttaattaacttagtcaataatttcataatacaaccacccatgacggaatttcaaagaaatcgggagcatcaatttcatactcaaccgaatgattacgcacacgtacttcaattacatcaatcattgggcaattaatcatacgttcaaatttggcagctacagatttagcaacagatacaatcattttcaattcctcaagtgttgggcccgaaggccctttaattaaaattcaatttcgttagcaacaacatcccacagtgcttcaagttgttcttcagtagctcttttaccaatagcccgccgtagataaagcttgaccaaaagagcccgattagttttccaagaaggatgagtacttaaatcgcgccggaatatttcatcatgaaaaccaacctttatttctgaaccattgaactgaacatctaaagttggaccattttcaaaactgatgaaaacgtaattatcttcccagtacatatcaatctgtgctactgtaccgttgttatgttcccacaataaagtggtagaaatatcccaaccgttgttttgaacgtatttacgtctgaagttagtgaagtccatgttattctccgttgtatctgtttgtttattgagtttatactataacacatacaacggaggatgtaaacggttagacaaaacttattttgacatttttcttagcttctaacttaagctctgtgataaaaacatgataattatcacttgttgacatgcataattcttctgcaattttcttggctttttctaaagtaaagaggttcttttcgttttctctaaaaacgactgcacttccgcattcaagagagcgaacaaccatgaatgtttcaggtccttcagtctcagatttaaactcaatttttccttgcttcacttcatcaaaatcaaacagattccaaccgagccagtcttggccgcaatctgcgccattataacgcctgtccaagaattctacttcagtgatatacttcccaccgacagatacttgagtagctttaagccaatcatttccaaacaagcatttgattttggtgtcaaatgagtctaaatcgccaccccatttatcagtcatacggaatacatcaccaacttcaaagcatgttttcataatttcctcattaaatttaaactaagacagtattggttattgagtttatactataacacacttttctgttaatgtaaacggcagactttagaaataaaaaagggactccttcgggagtccctaacttatgctttatgctttcttacgcggattaccaaacgcagcgtcgtgagcaagaactttacgagcacgagatgctagctggtcagccaatggattgatacgagagttagacccacgcttgtagccagcgcgtttagaggtaccaacaacttcttttactgcagtttttgctttagcttgtttagccattttcaatcttccatattggagaaatacaatgaactggtcttattgacactgccagttctcaagccctcaaagggtacttaggtttttggatatttaacgacaggataaccataaacctcgtcaacattcaagaggcgcaccgtaaaacattttccggcagcttctcgtttttagctcacactaaggcagtgaatctccaacgagttacttcaaagtaactacaaaatgccgaactgctttacgagctgaactgcataagcctttagcgaattttaattcgtcttttaaaagaagagcatcacgaaaatcagcttgtgctggattaagatgtttaaaccctttcagtacttcaagagcttcagccaatacatcaattgatgcaccgtaattttcatgacctgcattccaggcagtgcgttgcagagaaagagcgtgttcaagttgtttgttcatttaaaaagcctcaaatgaggtgaataaaaggaaggcggtataaggagtttaagccctgcgccttccaccatgtaatcagaaagattacaataatatttatatcacttataaacgcacgctaacgatttataatgacaagtaacaaatttttgtttaatttctttaggttgcttaatgcctaacgcaactaatggatgagttacattgcgaatattaccaacaggcaacggagttaaatcaccaatttctacgaagccagcaggtacatcagcaccaattgaatatacttcacacatttcaggaagttggccctgaatttctttacctaagaaaatacccgaatctgaaattttttcatcaccagattgtgctggttctgataccaaaataacaaattcgcctagagctttaataggaagttccattcttacagtttaccttgcttgttaacatgaattaataataacatgaatttcttaaagcaaattactgagtaatcaactgaactaaatgttcagcctttacaccattaacagaaattagtttatcaaaactaaaggcgcgccagccttcactttctgtgtcataaactggaagcatatcaacagcttcttttcgtttaacttgagattctttgactaattcaaaatcactaggaagaatatctcggtcacgagtgcaacgcattgaacgaatggttccgtctgctttttcaaaaaccacctgagattcgccattactcaacacagcttttagagtttcacgaagttgtactttttgctcggttgtaagtttcattttattaacctatgatagttttaattttatgtgcgccacgaacctttaatgcttcatgaagttcttgacaacgtttaagccgctcttcaactttggctttatcatcgatagatacataatcagtttgataaagtactttccatttagaaaagaagtttttcttatattctactgagtatccaatattaattttagcgtaagaactcaatccagttgtttgtactaatcgagttttcattcttcaattccgcagtattcgttaatattatgccagttcaatttaccgaggcttttcttgggaacattgaacacctctataccagcagcccgtaagatattatcccagccaggttcatttttatcgtaagtctcacaataaactaatgttttaattccagattgagcaatagcttttgcacagtctggacatggagaaagagttacatacattgtagctccttcaattgatgaaccattacgagcggcgaacaaaatagcatttaattctgcgtgaatttcattcacttttgaccaagcgctatgagccgctctatgtttgctagataaaccaaccctcgttggcttccattcatcttgacgtaggcccgaccatttttctgtgattaaccagccttggtcatctgcatggtcgcaacagttaactcctcctgccggagaaccattatacccggtagaaataatgcggccatttttctcaataactgctcctactttccaagagcaacatttcgattcttgagaaactaagtaagcaatttggagcactgttgaagctttcattattttatcaccaaataagttgaacgatgtgttttaacaagacttatttcactaaacagtttttcaactgaaagtactgtcccgataattatataacatccgtctttaaagcgttctttcttatctaataacacatcgcctgcaaatcttttacctacttcaatttcttcagtaacccaaggaacatctccgagcagcacagcatcgtatgttgacgggtctattgaattaaagcaccggtcaaaatgcaaaagagtttttatttcttggacgccgtcttcagtaaattctttgtcttcagacaaccaaggacgacaaggacgatattcagtttcacgaattcttctaatagcttcaactagtgtaatcataaatttcctaaaatatttgtcatggtaactgaaccatcacgatttaactttaacccggtgtgttgagatttaaatccttgctcaactgaaataataacaccattagttaacgggtcatttcgcatagtaactgaacctccaggaattttgttagcaacctgctgcgcaaattttttagcaagttctgtaaattcagttcgactaaatgttttatctgatgtcattattcccacccatacactattttgaaactaataaaatcttcattagaactattaaaatcatcattatcgcatggataaacaatgaagtcaaacgtataagaatatgagtcgtatgaagttatgatactatactttatatctttccatagaacaccaaaaatcgacttgatatcagcatccatacgtaagtacagtgcattacttgggccttggttaatataattatccatcacgtaagaaataatttctttagcaatgccagtatatgacagactactatttgctcttactttcattagtgcaccgtatgtacgttgactttaactacgaattgagttacaacttctccaataggattaaactcaacatgatactcgcccttatagcgagaatttaaatctgttcgaatttgggcaagcttattgataagcgctggtgtcatactcatacctacgcattgctgtaaaagcttgtatgcttcttcttcaacttcatgatgtttgttatacattatattcttccaaatattctagcacaatttcaacggatttaaaaatcccgccaccaatgagttcttcattgtcatagtccattatgtctaaaccaatagttccatcgtttaaacaatatgcacaaaacagatattcttgtttcttttcaatttctgtaattaaatcaaaaatctctttaagattattcataagtcgtaggttttccatggtagagggattttagttttcttaacagttaactcaataccgggatttaattttctcaacctaagacattcatcccatgctttaatttcactggaaaatgaataaaacataccatctacagtaacaatacgtttttcattattcatattaacaatagcccagatttcatgatgagttgccattaaaaatctccaaagttaacttgccagcattcgacgccaatacgtcgccacatttctaccacttgagaccggtcatcaacggcaagaactacattatacttatcagcaatatgggtccaaaagatttcttctttaactacatcatctttgcgagaatcaccttgtgcccgctgaaaatggtcttctggaacacagatatgattatcccataaccaatgaagagtatgaatacgatactttaacggttcatctttagttccagattctctaccagatacagttatgattttatatcctttatctgaaagcattttaagaaaattaacaaccatttccttaggagtatcttcccggagtttttctaagtcaaaaggagaacgatgactgttatctgcaagtgttccgtcaaggtcaaagataactgcctttggtttagacaaatccggaacgtacattttctcaacttccatcaactgatagaaatgacgcagaatatcgattggaacagccttttcaccacgatactgattacgcttaagaagttcagtccatggtacgctaaatttcttgaactcaatcacatactgccccttgaaacgaagttcccacttttctgtggtttttgggttcaagttcgtgtctgcaataatgacacctttggtatgctccaaattaagtaaagactccgccgcggacatctgagctgtagtcacagctttttcgcgctgcttagagtatttgtaatcattccgcgcatttagaccaaacaatttctcacggaaatcatctcggcttagaatataccaacccgggttctttgatacaaactcatttgcccaggtgcttttacctgaaccggggcaaccaacagtcataataatctttttcatttttcacctaagaattgttcaagagcttcgattttattatccaaagggccgaagcccttattttgtaaaaagttttactgtataatacacggttacacaaataattaaaacaactaatgggtccatcatttacaccgctcttcatttaagtctttacgataataacatatcgtagcattagcatcttttacgtatctgcttacatcatttaaccaaattctcatttcttgagattcagcaaatggcattccaacccaggcttctccgtcgataactttaacttcccacttcccattccatactgatataggttcgggccatgatggatggattaatggtttagggacagcctctggcttgctagcacaccctattagtaaagccatagatactatcagtaacatgttccgaatcatctagttgattcctgtaaatctctggcaaatgaattaaaactctcgttgatttgtttttcgacgagtcttggctttgcagccaccacgttgcttttcttcgcgtctttacgcattttcgcattagaagtttccgtgattaatctatttgaactacgtttctcatctaaaatttttatatttttaaaatcttctttgagttggtcaatagatttggcctgctcatctgcaacttcttttactgcatgcaaatcttcttttaacccttctacccgctgtgaaaggtaaaaaatagaacctgcaacaacaattccagctattgccagcgtttttatacttatttgcataatttgacaattacctctacaatatcgtcttgagataatccgttccataagacgtgatttggagcgtctgattgtgacactttaaatccttgaatttcatctgccatttctgacgaattcatatacggattatgaatacctaagcgatgcttaccataaattgggtcaactgttatatagcatttacaatcattgataagcacgttaggttgagtgatattaataatcacttctgctccgtatttcgtaagctggttttcaagaaaatttttcatttcttcaacagcttcaggcatcgcttcttggcgagcctctgtaactttattgttgtactctttttgctttttgcgctttttctgatccgtggcgaatgcctttctgaggtcagttaagtatccaacccgccgggaacctttgaataccgagataccgtcgtgatgagtaccatacttttctactaaagcttcgttagtgataagttgtaagttcattgttaatctccgtttagttggtgtaagaacatagtatcataactaaacggagatgtaaacggtcttattcgtattcttttggaatgaacgttttgtagttcttcatgaacagctcgtttaccttcttgatagttgtgtcgtagtccatgctatcattgaacatcagcatcaaaattgtaaacaagaacggtaaacgttcagcatcagccagtctctttgcctcgcctgcgtatgttttacggtctaaaccacgaagtttttgatacgacgtagagataaacgacaatgaacggcgcagataatcaagataaacttcttcgaacttattaattttctttaaagaataagcatcgttagaaaaaagtcctttgaggtcatcagaagcgttattcacaataacttcaaatagtctatcattttttgtgatagagtccttagtatgatgtaaagctgtgtaccaatcagtctttaacttaaatcgaagaccattgtccatcacaaaaacataaccttcaatcccttccattgctttaatatcggatacaaaatctccttccggaatttcatacgactctaccaaatactgacgaagaacagggtctttagcgatttcgttgtatggaacataagctccagtatcattttcacggatattcaaaagaataaggtcttttttctgataagcgagaacaatacgattttcaggagatacgtattcaaagttagctgtaaaaccatcacgagctagttcaagaagtctccacaacaacgcttcatgagtgatgctagtaagcatagcagaagacaaataagcttgttcagatttaagcgaagactttgatttaaagcgaagaatattgccatccaaatagcttgacaccaaagaaccatcttctttcttcatcatatgaaccgcgttagaaagatcgaggttcattgtaaacggagtttcatttaaattaaagaatttttccattggtctagaagcaattcttactggtactccgtcaatcatttcaaacataattcctcgacactctaaagcatctggaagcaaccaatctgaatatgaagcatagttataactaaaaattctgtactttagcccagacggagaaatatcatcacgataaaagaaccgtgattcgtccgtatcattacataaattcatcaaattgtcgaatagctctttcatggtttagccttgtgttgagtgttccatggaggattaaatcttttaataaacataggttcttcaagagacatcgtctctaccgacattgtaccaagttcatttgtcatgcttaagttaaagcattgacgagcccagaattcaacttttttaccttccattaaagcttctaaaatctttgctgattttacggaatctgaagtctggtcttttctgtttatagcagtacgataataatttatacgcttacgaagattttttgtttttccaatataaacaagttcatcatcaacagcaattgcataaactacattcttcttattggggacctctatagttttaatagaggcatcttctagtaattcaagctcagcgtattttataaatgaaaattcattagcaatatctttcatattaaaaaaggggccgaagccctttaccttaaaaatattttttgaaaccaataattatattgtcgtcaacgtcgttgtcgatttgagctactaagtaacttgaaatttcaacttcctgcggagcagattgtaccgcatctgagtttaagtattcacgaatccatggaattggatgacgagtaggagcatcgactattgggcatggaagaccgcaactacgcatacgagaaactgtcaaatagtcaacaaaatcatgcagaatttttacattcagacctggcaacccgccatctttgaacaagtgaatagcccattctttttcttggcggttgatttccatgaagatatcaactgcttcttgttcgcattcacgagtaatctgaacccattcgtccccatctgcgccttgttgaagctgacgaataatatattgagtacccttaagatgcaactgttcatcacgagcgatgaacttcataatcttggagttaccttccattatttccatgttcttgtggaaattaaatgtaccgtacgttcgattgagctcgctagttctcaacccgttctcttatgaactgctgcatattactatgcagtccagactatatcacaatcccaaagggattctccccatttcgagtcgcttgaccctacgtccgaagactagtcgttgaaccttgctttgcaattgtcgccgtgccaacgtttatatgatgacggtgataaatccttcttatcacagtgtggacaattcaattgaattctatttggattgaatttacatcgttcgttgtgttttagataaaatcccggacctttacctttatgcccgcagaaatcacatacaatttctttttgggccggatgggttccgttattaaccatttctaatgtttttatcgatgttcttttcttatgttcttctgataagaaatgatgattgccatcatttactctttttgattgagtttttgattgcattttaccaccgcaaaacacatgaatgccttcctttatagctttggcattacggtctttaacttttttaatatgcccgacttgttgaaaattatgtatacccaatgcaactcgatttaaattagacttacgttgtatttcaccgcttaaaaggtgaaatgtaccgttttctattttagttttaatagaggcaatgtttttagctcgcacttcaggaatattaaaaacttgtatttttcgcgatttagctgcttttgaagcaagttctgaaatttcttctgcagaatatttcattcgtaactttatcgcatgacaagcttgataatctttttgagctaaatgtaaatcataatgttcctgtatagaaaggcacattaaattatctaaatcattattttcacggttcccgtctttatgatgaatttcataagttctaccattttcatcttttggtatagggccgttttcttttatccaaatttttctataattcaattgtgcatcctcttaaaagtataaccatatttataatattatactaattaaaggtgcaagcaaaaccttggctgctagttttcctataaaggactttccagcaattaaaggagttttcgataagcgttaccacttaaaggcgcattttacgcaaaagatacataaaaacgaattgcttcaagaccattgatgacatgcaaacacaaataaagtgctttcattaagtcacgtttagtttctttaacttggtcttttgcgtctcgaataagttcttcatcatgctcagtggcttcataaaactctaaatcagctttagaattttcccagtaacgagttttacgaataacatcatcatagtaacggccaattgattcagctcgagccataatagcatcatctaaaacaatttcatcaaaaattttggccgggtccgcgaacaggttacgcataatgtgcgtgtaagaacgagagtgaatcgtttcagagaaagtccaagtctggttccaagtatctaatgacgggtcagaaatcaaagcagaaagaactgcagcaggagcccgtccttgaatactgtctaaaagagactgatatttcaagttgttaataaaaatatttttttgatgctctgggagtttatcaaattgagctctgtcagtcatcaagttaacttcttctgggcgccagaaaaatgagagctgcttttcaatcagttcttcaaatgtacggtgacgctgaatatcataccgtgctaaaccaagaccgcttccgaaaaacatcggttcattcaaaacattaactggttgtgtattaaaaactgtactcatttattcacctttgctcttcctcttatccatccttcaggaatagtttcagaggattcaattaatttattcttaaacccgtcgtttatacaaattttaccacgggctcctttataatttcgtggttttattttatcaaaattaggagtaagcgaatacgaccatctgaatccgtaagcatactggaaatggccttcagcgcaatatttgatattagaaccgttcccattaactgatttagcagcttcggatatagaaggaaatgtctctatgaaattaccgtctaaatcaaatttgtgtatagttacagaaacttcttctgcccttttaattaatggtaatttaatcttttctaaagaatctttagagtgctttttgctaagcattcccttggggtgtgggttattagctaaatattctttcatatatttagaggattcttcggaaaatctctctcggtgccaagcatataatctattattaattctatttccggatttatcggtgcacattaaagtgatagcacataataaaccgtatgttttatgaattttataaagcaactgatgcgcaataaagtgttctcttgcgctcaatgccactaagttatctttatcatctgaaccacccatgcatcggggaatgatgtggtgattttcggtatagccgatgaaaggagaggcttttcgcctctccattaagctatcatatattctttgatagttcattataatttacaagctgcacagtcatctgcttttggttgctcaacttcatagtcatctgtgccagaaccatctctagtgttatgataatagagactttttccgccaaaataccagaagtaaagcaggtcatcaagcatcacactcattggtactttacctttttcataattctgagggtcatagtaagtattagcagaagcgctttgacacaagaacttggtcatgatagcaacttgagttaggtaaggtttgttaccttgtttagccaatttccatgcataatcataaaggtctatgttgtgctcaatattgggcacgacttgattaaaggaaccctcttttgactctttaacagagactggtccacgcggaggttcgatgccgtttgtactgttagaaacttgggaagatgactcacacggcataagtgcagataaggtgctattacggatgccgtggctaaccaggtcttcccgcaagctctcccagtcacacacataattgggcgctgcgatttggtcaatctttttattgtaccagtcgataggtaattcgcctctagaccaacgagtttctgaataatattcgcaaggtcctttttctttggcgagtttaattgaggctttaatgagtgcatattgtaatctctcaaataattcatgagttaaatcatttgcatctgcatatgatgcaaaattatcagccaaccaagcagcgtagtttgtgacacctacacctaatgcccggcgcttcttagctttcaatgcttcttttacaggataaccttgatagtccaataaattatctaaagcacgaacttgaacttctgcaagttcttcaatcttgtcttggtcctgccagtcaaaattacccaacacaaatgcagctaatgtgcacaacgcaatttcagggtcatcactaccaacgtctttggtcggtaaagcaatttctaaacaaagattgctctgtttaattggcgatgtttcacgaatgaacggagtataacggttcatattatcagtgaacgctggatacactcgagccgtgccagaacgttctgtcatgaacaattcaaacaattcaagagctttgatgcgtttcttgcgaataattggatttttttctagttcttcatacaattcacggaatttatcttcatcccggaaataagaatcgaacaattcgccattagccacatctgggctgaacagtgtgatgtacccatttttaccgagacgttccatcatcaaatcattgatttgcagaccgtaatctagatgacgaatgcggttttcatctacacctttgttgttctttaataccaacaggttttcaacctcaagatgccacattggataataaagagtagctgcaccaccacgtacaccgccttgagaacaagattttactgcagtctgaaaatgtttccagaaaggaattacgccagtatgttttacttcgccattaccaatttttgagccttcagctcgaatcataccggcgttgatgccgataccagctcgcttgctgatatacttaataatactgttacttgccgcattaatagaattcagtgaatcgccagcttcaataactacacaagaactaaactgacgagtaggagtacgagcccctgccataatcggtgtaggcaatgaaatctggcgagtagatacagcatcataaaaacgaataatatgagccagacgattttctggttcttcttggtgtagtgccataccaattagcatgaatgcaaattgaggtgtctcgtaaattttaccagttgaacggtctttaaccagatatttttctttgagctgcatcgccccagcataagttaaatcaaaatcacgttcgtgtttgatttttgattccaagaaagtgatttcttcagctgaatacttggagagtaattctgaatcatatttaccctcattaacacaataagaaatgtggtcgataaaagacggcggttcgaattgtccgtacacttctttacgtaatgcgaacatagccaggttagaagcaacatattgataatccggttcttcttttgaaatggagtttgcagctactttaatagcagcttgttgaatatccttggtgctaattccgtcttggatatggcttttaatacgctcatataattcatatgggtcaattgaagtaccttcagcggcccatactaaaatcttttgaagtttggatggaataaattcctgtttaattcccgatgattttactacttgcattttatatccttagttatcagataatttattttatcatcaaagacttttagcttatcgtttcctcaaagactaaaatggcagcccgaaggctgcctgtagtgttatatttattatttaagcttcttttactacaacaactttaaccgggcttcggttcatgtcaatactcagaaatattgattggataatataaaaatatccattaatcattatttggccgccttctttcaattcacgaccaatatcactttcagtttcggcaaatactttatcaccgtgctctgatgtaaatttaataagcataatattcctatagaaacagattcaacgaaataattataataagaaaaatgataagcgcaatagttagtttgttcatagcagtcatactgccagtatcatttacaaatctagtaatcattcacaagccatcagtgctgcttcgagcacttcaattaagtttcgaacttggtctagaggtaactcaaaacctaagccagaatagttgattttcagacaaactctatcacagtaattcgggtaaactacagcccgaatttcttcttgatatttgtctgtcacatggtctatgataacctgatgaaacatatcaccaggttcattcatatctttacgtttaatcatacagccatttttcctttgattgtagggtggctctcgtaaccgtcaagaacaaaatccgccggggtcatatgagtgcaaacccaatacaactgcatttcggtgtcccagtcttcaaaaccttcaggaaaattaattttcagttcacagagttcttttggctttcgacggagaacttctttacactgttcaacgtggttcaaatatatgtgagtattaccaccagtgaacaccagatgtccaggttttaacccagtcattttagctacaatatgaatcaaagcagcataagatgcaatgttaaatggtaaaccaaggaagacatcaacgcttcgttgggaccacattaaatctaaaaacccattacgcacgttaaattggaacgcatagtgacacggtggaagcgccatcttagagagctctagagggttccaggctgtcacaatctgcctccggtctgccggcatttcttttattctatcaatgactaacttcaattggtccacgcccatgaaatcacgccattgtttaccataaaccggtcctagttcaccgtcagtataacccatcgaaacagcttgattttcataattatcatcccagacggttttcccttctgttcgagaaccatgttgaatttcacggaggtcatctacatttgttgagccagataagaaccacaacaattcagcaatgcacgctttccacgcgagtttctttgttgttacagctggaaatccttcctgtaaatcaaaacgaagctgagtgccaaatacagcaattgttcccgtgcccgtacggtcatcagtctcatagccttcatcaaaaatgtgttgaattagttcttgatattgtttcattgttttccaactttaaagagaatttcggcgcctttcttttcaaaacggccttgcatccaaaggagaccattttcaactttcatataaccaagattaatatagtccaacatctgacgattactgaaaaacgctttaaatgttccatggttagaacgtacatatataccattagtgcacgcagagtggatattctccaacggcgccctaacctcataaaacccatgaggaatagtaacatatttctctggatttcgtttaaactggtcaattgtaggggccattccatcgataaccaaagcccagttcttttgcttctcttcaacaattaaatctaatttagcagtcaaaatgtttcctctgttaatgggtcgaaaaatattacattaccggattttctaaaccgtccaaccattgaacagcaaattccattaaagcgagtttgccctacgcttactgattgaaatatagttttcatttcacgacacaattcaagacgaccaataaccccatcaagcaaacaatgagaaccattccatgaagaaattgagtcaatatcaaattcaagaagataaattccatgaggaatgttgaaacgctgccatttcttttgcacttcatctttttccaataaagtgattttgtatattttattcatcacgccctctcataaacatcttctgaaatattagtaagttcgtcaatattataccaatgagtctcaacaagttccatatcttcactgatattccatataaaatctgccgagagtttaatatcagaatttacacgatgttttttgcgaatagttgtgcatataattttatctgcgtaaattctcgaatgctcaataatatgtgcaccgccaataacagaataattggcatcatcgcgttgaataaaacaattatacccaaaatcatgcccagaaacttgaactttattaccttctaaaaattgttgaaactgtgtttcattgatatagagctcagcggtttgtcctgatttagtttttgcataaggacgagaaaaatcttgtactacaatatgagaacgtccatgaagttttcctcttaagctcataaatgtttttgcacccataataagaacagtatctttagttctggaagcaaaattttgcatgtcttgcttgatatgtccccatggaagaccagtgtttaacccaaacgcaaattcatttttattgtcgacagttttagtagggcaatacgcaaaaattaactgaatcattataatacctcaacataagcgatgtcagatggctcgatataattggttttgcattgacctttataattattaatgcaaaaataaaactgcgatttggcattgctccaaaccaaattgaccttatgcaaatcaccttttatagtttcaactaaaaacacgctatcaaaatatgctttatttgagcaaatatcttcaatatttaaatcttgaaaaatttccattaaatttatagttttcatcatccttgcctcattttacaattaggacaaattccacctgcgaacaaaagtccgccgccgcaatatttacactcccagtcggttaaaattttcatcttaagttcctaatacgttcacggatgatattcaaaaactgccgtgtcatttcaatgttagcttctcgccataagaagttgctattcatagcattatattcagcagtcacatggtcgtttaactcacataacgcgtgtagtttgccatgttttactgcatcagaaattgctttatcaaactcttcttttgacattgtaatttgcattatttgtttgaaccctttttagaggctaaaaccatggtacgaagcattctaaggcctttatcaacagcttcagcaatttcgcccgccacgttctcattgaatagaccgagagttcctgatttgatatcttccattaaaatgtagtttatgtcattttcagttaaagaaatttctgggccaattccacctgaaaaattaatcttacagaatacattctgtccacgttgttcttggtagcgaatattaatgtgtgtcacaccaggaacatggtcaaactgacaacgaacattaacttcaggagcagcagaacaccagatatcagccattataattcttccttagcttctttaaatgattttttgaaatcttcaacgtattcgataggaatccagaacccagaaccataaccgtcttcatagcatgggcacatatcgcaaaactgttgccaatgaatagttttaccttctacagtgaagggagcttccatttcgcataaagactcttcaacaagttcaatcatcgctggatttttgtcataaatgcagaaattccaaacacctttaactgtggaatctttaatgctttcacgttgtaatttcattttattatcctcatttgttttgatagggttatagtatcataaccataacccgttgtaaacggtcatttgaaagttttttgtaaaagttcaatgatttcgtctacgttttgttttgtaacaacacaatgaattttagttacaccgtcagtatctttacattcgtcatcaagaactggttcttcatattcgcgaaagcaatagaactcattatcgtaaagttcaaaataacaatcacctagaccatcgtcgcaaaagcactcaccattagcgcagacaatttcagttacaaaatattggttgtcaaataattctatagattttacttcaaaccaaccgccattttcgtggataatatctaccatttcagcattattcaaagggcttaagccaataaaatcattaataagctctgggactagttcgtattttttgcctattttcattttgatttcctcaattattagttattgaatgttaaaagttgctttaatcaatgcaatggcttcagcggcgttgctttgattaacctgcatgtgaatggtttgggtgtcgaccacaggagaatcatctacttccaagaagtatttgaattcatattcagcgagttcaaaatagtcttcacctttctcgcacatggaagtaaggatggacccgtctttcatttcaaccttttcaacaaagcactcaccaccatacatttgcatgtcaagaactttaaaactatctccgcactctgccatccgcttaaccataagcgcgttatcatctgggcagtcagcgatgaaacgttttttagccgccgggtttaatacgtaaattttaccgattttcattttgatttcctcagttattctttaattaaacccatataaaacattttatcttcgggttccataccttcgcagtactcaatttccataaaacgattaatagcttttaaaggaccattaatgacaacatttatgttccatgatttggaattctgtgaattagcgatacgaagttctgggtatcgattacgaataacttcttcaatgtattcaaaatctacaacatcaatatcaacactagccattttattttcctcatttgttttgatagggttatagtatcataaccataacccattgtaaacaattaattgatatcactcatatacatttcgatatcttcatattcgcaaatttccaaatactcgcggatatcttcaacttcaccaatgatttcaactaaaggccatccgccagcgggtccacgttctgctataacgttaaactccaatttaccaggaagaatttccatgaaccgagtgcaatcatcaaattctaaatcaataatcattccgccttcatctttgataatttcacatactaagtcaagttctaaacgtgccatgatattttccttcatttgttttgataaggtaatagtaacgcagtttaaagctgatgtaaacagttaattgcaaatttctgcatcaactttactctttcacaacttaattcattgcctagaaaaatcatagacaatagtcatttgcactctcaataacatcgtatgaggttataccataactataacctcataatgtagtatacgtcttattgttccataaattcatctagcaaccaatcaatgtcttcccattgattatcttcaagccatttgcggatatttttttcagacccgcgaagataaatcactggccatccgccgccggtgccttcttcgattataaggtcaaaatcaagaccatggtcaacatcataaaaacggcttccatcctcaaaaattaaatcagttgcaattccatgctcattgcggtgaacttcagctacaatatcaagttctaaacgtgccattttcaatttcctcatttgttttgatgaaataatagtatcacagtttttggaggatgtaaacggttagctccagaaacaacaaaggagcccgtaggctccttttattattaaagaccgttcaaaatgtcgtccaggtcatcatcgtcagatgaactaacatctgaagtagaattgttagttgtagaaccagatgagaaagcttccatatctttatcaaaagcgtccaggtcatcagctactttatcagcctgtcgttcagcttttgctgcggcaccgcccatagcagcagttcccataactttctcaaatttcttttggttgtcgtcaaaagatttaaatttatctttagaggtcatttcagttaaatcaaccatctggtcattgagagatttctgaacagattcatcgtcaatatttgggatttcagattggcccaagaatttcgattcgtcgtagttactaaaaccggatactttcttaactttcagtacaaagtttgcaccttcataaggacaagttacatcaactggagtttcacccatatcagtatcaactgcaatcattgcgttgattttgtcccaaattttcttaccaaaacgatatttgaaaactttaccttcattttccggagaagccgggtctttaatgaccaggatatttgcccagtaagaagttttgcgtttcagtagtttgtattcttcgttatttgtgttgtagctatcattcttggaaagatattgacaaaccggacaagaatcgtaatcaccatgagtagatgtgcagttttcaatgtaccactgattatttttcttaaagccgtggttaatcagaagagcaaacggagcagcttcttcatttttggaaggcagaaaacgaatcaccgcttgaccattacctgcgttgtcgagcttaagtttccattcacctttatctgaatcttggaaaccacctttgttaccagacagagcagccagttgagcttgaagttgagcgggatttttacgtttaaacatattatttaccttattaatatttacagttttttacagtttttacgaacagttgttttgcttctaatgcatcgacatcaagaattttcttgtatgcgttgagcttagttgaataatttgaccaaactaaattgtccgttgcctggtcatgattatttataatatccaaaaatgaatcaagaattataaaagtttcgaaagaaataatactactttgaagtagtttaaacacatatgatgtgttgattttgttattatatacaaatatttcgtttagcgttttaacttcaacttttttgctgaagtaatagatatttctgacgtcttcttcaaaggtgcttttaatcattttcaatttgccgatatattctctataaaatacaagagcatcggcatcactgatatctccaatccaagcatcttgatttgcaacaagattgctcatgaagattattgcaagctctttaagcttgtacttttctgatagtttttcaaagaaatatttatcgcggcgcttctgatacgccttatcagaaacccgcatacgccagttgtattttattacatcatatctgccagcgaaatgattttttaacatcaagtacaacaaatatactgatttgccattgatgtatctattaccatcaggcggcatgcggattttaatcataacagaaattctaacgtattagttttttcaccacgagagacactaggtcttagcatatgctcatcgatagcttctgacctaattttttcaataataccggatggtataaatttagagtacattgtttctgggatggaattttcttccatccacatagtagtagcttctaaataccctaatccgttttcttcaactaaagcttcaataataaatccgttttgttgcttatctagcaactcatttaatttatcatttttttctttagtagatggaaccggaattgtttcgtcatttagtgaaaatagagtcataaatttcaaccactttatctttttcttcttcaaactgttcacgagtatctttatgatacattgccaataattgattaaaagctttcgaatcgacgcctaaatcatctttggcagctgctttcaaatcagcgattagtactcgataaccagaaattttcagaagatggtcagaagcttctttaattttcttacggaggtcttcaccatgaatagcttcatcaaattctacagcaactttcttttctttggccattttaaaactcattaatgtgattagttaatttagcaagacccgacttcacaaagtaagaataaatcttaccgcgaggaggtgttttgtataattcataatattctataatcggtttagcaatttcttctggaatataactaaaatcgataagaactctattttcaagataacgattatattcggcttctgttaaaagcgatttcattccttctggaccagcatctaaacactgttcaaggagcttagttgaaaacgaaggagttcgctcaccgtcaattttagtgtaccaataatcagaacgtactttaactgatgcgatgttatctttgcggtcgccttttaacactttagttaaacattcaagttcagcgtcaccggttttgcatacaacaaatttcttttgcatcggggaccactgtttaacattaggatatcgatgaagttgtttaaagtcaccgtcagaagaaacaatcataattttatgtcccttcaaggaaagataaggaacaagaataccaatatggtcatcagcctcgtatttgtcaatattcatgacggtataaggcatatatttctggaattcatcaataattgtgcgaattccagtaaaatatccttcccaatcccaagtgctttcttcacgaccttgtttacggttctttttataataatatgcaatatcacgacgccagtaacctgatttagcgttatctgcgcaaatgataactttttcatatccttgtttgcggaattgtaggacattctttttgagtgtacttaacacaagatgtcgcatcatagatggctgaattttctctttatcagagaatgtgtttaacgctgctgctaaagcaatttgtgataaatccactaaaacaataccttcttttgtttggtcttcttcgccaaacagacaatctagatttgacattgaataatctcattcagtagttaacgtaactattataaatacattctataatagcaaataggagcaatcatggccgaattaaaacgtaagttcagagctcaagaaggtctggacgctgcgggtgagaaagtcatcaacgttgccaaggcggatcgcacggtcatgtccgatggcgttaacgttgaataccttatccaagaaaacacattacaacaatatgatagtactcgcggttatccagcacattttgctgtcatttatgataatcgtatttgggtgtctaatagagaaattgctgaaccagcaggcgattttactgagctttactggaattctgtacgcactgatgcaaaatggaaaacagtgtcatctggaacaacaaatttaaaatcaggtgattttatttcagctgacactgccggaagaacagatatgaaattcattcttcctagcaatccgcaagatggcgataccatttttattaaagatattggtggtcagccaggatatgcttctcttactgtcgatgcatctattcaatccatagtatggatgggttctcaaataagaaccgctcaaatgacgcatccatactcacaaatggttttcgttttcagtaatcgtttgtggcaactttatataagtgataacgaatcaagagccacttatataactccagctagtattcatgaagcgcaagcaggcgaaaatctagttagaagatttacttctggagcagaagtttttattactcttcctaaacatgctaacaacggtgatataatttccgtagttgatttagattctcttaacccgttgtttcatactacattaaaaacttatgaccaaaatactagtataggccaagttggaactcatgagatgcagttccgtacttccggagatggatttgtagtatttgattcagctgataatttatggagagtatgggacggtgatttacgtacccgcttgcgtattgtaactgaagatactgacgttagaccaaattctcatatcatggtttttggggctaacaatgacgaaataaagacagttaatctaaacttgcccgaatctccagctattggagacacagtaaaaatttctcttaactatatgagaaaagggcaaacagttaatataaacgctactggaactgacacaatagcttcaaatattgaacttttgcaatttccaaaacgctctgattatccgcctggagctacttgggttcaaagcagtactttaacgttcaatggtgatgaatcttatgttccaattttagatttatcttacatagaagatgaaaactctcaatattgggtagttgcagataatactccgaccgttgaaagagtcgattcgactaatgatgagacccgagctcgtttaggtgttattgctttggcaacccaagagcaagctaataaagataaagaagataatccagaaaaagaattagcgattactccagaaactttggctaaccgtattgctactaaaatccgccgcggtattgctcgtttagctactcaagctgaattagaagttaaaactggcggggctttattagatgatgtgattgttactccgaaagttctgaatgaccgtaccgctttagaagaccgtcaaggcctcgctgaattagcaactcaatcagaaactaacgatggtgttgatgattctagaattgtaactccgaaaaagttacataaccgcaaagcttcagaaatattaaccggtattttggcgttagttaaaactggaatttcaactcttgcaggtgtagatagagatacaaaaggaagtaacgtatatgactatactgataatgaaaaagctgtaactccagcttctttatttgaaaacaaagctacatatacatcacaaggtggttcatacttagctacagaaaccgaagttattcagggcactccacatgaccctaaagtgcctacagtagtaactccagtcgaattgcataagaaaactgctactgaaacacgtattggttttagtgaaattgctacgcaaaacgaagtcaatactgggacagatgatttccgttatgttactcctaagaaattaaatggccgtaatgctacggaagatttaactggtatttcgcgagtcgcgacagacgctgaattcgctgctggggagctagataatgttatttctactcctaaaaagattaagaattacttttcttctcctgaccgtaaatctgttgttactgaatctggattagttgaatcaggtaactcctgggaccattataaccttgatattcaaaaagcatctgagacgcaacgcggcacattacaattagccacacaagttctcactgacgctggggttgatgacacgactgctgtaactccgaaaaagttacaagctaaaaagacatctgaaacttctgaaggcattattcagatagcgactcagtcagaaacaacaagtggtactgtaggaaataaagctgttcctccgaagcatctaaaatatgctatccaagaacaacctgattgggaagcttctcctcttcgtagaggtccagttaaattaacagaaggcgctttaacgtttgttggtgataaagaatttggttctggtgtcaaatttgacactacaactggtctttatattaatgataatgataagttaaatgccggaaattatttcaaatctggatatgctatatctccctttgaaatgaacaagactcttcaaaactttttgccaataaacgcaactgctgttaattcgcataagttagataatcttgattcaactcagttcatcagaagagatattgaccaaacggtcgaaggttcgttaacgttaacgcaacaaacgaacactagtgctcctctagtatcctctagtactgcgaagtttgttagtatgttggttactacagaagctactatcggggacgctacgggtcactctgtgattaatttggacgctaaaaccaataaatgggttattgatggacaagctaattctcagtatttagattttactgccggaactacagatgttcttaagctcaaacgagatggagacgttaacgtagcccaaacattatcggctggtaatagagtagatgcttcaaaaggctttagcgtcgaaggtggtataatggttattaatcctaccgccaacaatattcaaattggttcacaatctaaagctactaatatccaaacaacagacgccggaaacttgaaagttactgatacatcaggctcttctgtgatattgaccactaaaaacgctgttactatcgtaggtaataacttcgttaataaagctggcgattcaatgtctggccgtttagatatttctgctgcaatgagttcagtaattactgaagctaaagcgataggtcctcttactaacgaaactgtgggtaattggtcagcagaaatcataactgaagatatctacaaaacattgcctggatttatggttccaatttattctgacgatggcggtggtaaagtaattataggttatgtagattatgacccggctgatgcatcaaaacgcggtgtaagagctccgggtgtattatctcagattggaacgagtaaaaaggaattcacatatcaaatatggaaccctcgtccagctacagcttatacagatgctaaatcttctctttggattagaacctatgacccagttaaaggtgcattcaatgaatggggaagagtttacactactgaagctcctgttacgtctgctgaaattggtgccgtttctacagctggttcttcatttaataacttaacaatcagagactggttacagattggtaatgttcgcattacgcctaatcctgatacccaatctgttgattttacttggataccttaatggaaaaaatgatggcgagttttggtaacggatataccaaaactcaagttatttctgaaaataattccatcaaatacaaaatttcatttgctgcggggtcggttttttcgaccccttcttctgcttattttacctttcaggataatccaataggtaaccagcaagatggtgctggtataaatatcagagtttttaatccagcattgaatactgtatctgctaagaaaacatttttattgacacccaatgataatgacccaggcaatagagcattcattgaatatttgtcaacatttactcaagataatactaacttgttaatattcaccacatcaggtgatattaaaacgagcaatttagtagagaataaatttaagtccatttattcaactatgtggccaaataaatggatgacatctcggtattcatgtacttattgcggtttattttcaataaaaaataataaaattattgccgaaaacgtaacatattctgatggagttcttcgggacgaagacatcagacctgctttagaattcgtttatgataaagctgatgatattggagctaccgggttttcttatagagctgttgaagattttgaagaatacactagttccgcagcaacaataaaaagatatccagttgattctgcttcgggcgtagaaattagctcaattggaatatctcctggcgatattctgttctggtcatttgaatttttgcatggagataatattccgccggaagttccagggacaaataataataaaataagaatagaaataagatggttaaattcatctggagggtggattaaatcagttaatgttgactctaaccacgcaaatgctggaaaatggatacagcacgaacaaactgttgaagtccctgctgacgctgcccggatagttattcttgcttctaaaactactccaactgatacggtcggtactggaggtgttcgtagtatgattttaactgaaacttcgcgagctactgaggcattaacttctccatctgcgatatcagttaatggtattcgtttgaatactatagtttcaggagataacccgacgctgcttattttacctgctaacgaagttgattcaactggcaaaccattaccaggtgaagatgtttcaggaataatttacagttctgattggagagagtttgagaaaaatatttaagggccgaaaggccctttttctttgtaaaataacaaataaatatgaatatacttaagaggacttcatatggccgatttaaaagcaaatagtacagtaggcggagctccgatatggcataaaggaaattttcctttgtctccggtaggtgatacgctactttataagactttcaaagtctatacagaattcgataaacctcaagcagtagataacgattttgtttctaaagccgctggaggagaatatttaaaaaacgttaattttaaagaaggcttatcatttagcgacaaagatggagcttctgtttttattggtgttcctaaaaatactacagcaacagctacttataccgcatcaataaaattaaccggacaattcgctttagaaactcctgataataaaccatttatcatatttgacccaaacgagtcatttagccctgatgtatatcgcttaactgttatgggtgatatgctttctcgtcaaatttatgatgaatccggaagagttttttctcctgggaatactccgtcaaaagcgcaagttgggttagatttagtcgataacgctaagcaagttcaacttgaaaaatctggtgttcaaacaatgaccggggttttggctgctccaaactttataagtaccaatccggcaacggcagataatcatgtagctcgttttgaccagattgtaataaaagactcaattcaagattttggatattatagttaagaggacatatggctactataaaacaaatacaatttaaaagaactaaagtagcaggctctcgtcctactgccgctcaactcgctgaaggcgaacttgctattaacttaaaagaccgcactattttcacgaaagacgatttgaaccaaatcattgatttaggttttgcaaaaggcggtgaagtatcaggagatatcacgcagattggtaattatacccaaactgggaactataatttaaccggcgatgctactatatcaggcaaaactactacaagcacactggatgttgggtctgtttcagatctaagacagacaaactttagaccagtattaagcacaacaactggttctaattttattatatcaaactctggcggcttgattaaaccaattactttgacggtagaaggcacagctacaagttcaaacactattctgcgccattcagttgatactactgtagcagcttctggatttatcgattcaattaatgtttctttaaatccgacggacggcgctcttgttacagctctcaatggtactgtgaatatcggtagttcccttaaaactcctaaactttcagtttctggcgcggaaactgctttgggagattatagtatttcaatcggtgataatgatacaggatttaaatggaattctgatggtgtattcagcttagttactgacagtaattcaatttatacatactctcgtgataggacatattctaaccgtccaacaaatttccggtatacgtctgactttgatgctacgacacctgctttagctccgccaggcacatggttagcttcagttgaaactgcaatagacggtaacgcttacggcgatggaatgagctatctcggttataaagataccgcaggttatagtttttatttccgcggcggcggcacttttaacgtagcttctaaaggtggatttaatgtagacacagctgcggcttttgccaaaacggttgatgtatctgatattctaacatgcagctctattattaaagctaaaggcccaggtcaagttgatgttactagtgctggtaatatcgcacttggtggaactattcaatgggtgccttcgtatatgagcggaagcccaaatagagcacgagatacaatagctacagcagcttggggcgatgccgaccaacgaattaacgtattagaaacatctgacccgcatggttggtggtattatatacagcgcgcaggttctggaagttcttctcctacgggaatagaagggcgagtcaatggctcttggcaggcatctgatttaatttctgataatactctaagagtagctggagctttcacttgtactagaagaaactccgcaggatggggtgataacgctggatggtatgctggagcaacaccagtagtagctaaccaaggaaacgttcaagaaatggaccccggtgtaggcggtttttatcctggatttgctcaatataactataatggcactggatggaaccaagcatttgttctggggttactaggccaaggtgttcagagatggcgtcgtggtgtattagctcttagaggcgatggccctgttgatgctggacaacaaattgctcgttggtattttagtcaagaagacggaagtttggaatcagaaggtccgcttaaagctcctagtgttcaagctggacaaataacatcttttggtgtaaacgttacaaacgcgttaggcagtgcgtctatagctattggcgataacgataccggattgcgctggggcggcgatggtatcgttcaaattgtagctaataacgctatcgtaggcggatggaattcaacagatatttttactgaagctggtaaacatataacatccaatggaaatttaaatcaatggggcggaggcgcaatttattgtagagaccttaatgttagttccgacagaagaattaagaaagacataaaagcatttgaaaatcccgtagatattttaagcactataggcggttatacttatcttattgaaaaaggatttaatgaagatggaagtcaggcttacgaagagtccgctggattaattgctcaagaagtagaagctgttcttcctcgtttagttaaaatatccaatgatggaacaaaagatgttaaaagacttaattataatggtataacagctttaaatactgctgctataaatgtacatactaaagaaattaatgagctcaaaaagcaattaaaagagcttaaagacattgttaagtttttaactaaataagagcctacgggctctttaggagatattatggcagttcaaggaccttgggtaggttcgtcttatgtcgctgaaacaggtcaaaactgggcctcattagcggcgaatgaattaagagtaacggagaggcccttttggatttcctcatttatagggcgctctaaagaagaaatttgggaatggactggagaaaatcacagtttcaacaaagattggttaataggcgaacttcgcaatagaggtggtactcctgtagtaattaatataagagctcatcaagtgtcttatactccaggcgcacctttatttgaatttcccggagaccttccaaatgcatatattacacttaacatttatgcagatatatatggaagaggtggtactggtggagttgcttatttaggcggaaaccccggcggagactgtattcataattggattggaaacagacttagaataaacaaccaaggctggatttgtggtggcggaggcggcggcggtggctttcgtgttggacatactgaagctggtggtggtggcggacgacctttgggagcgggcggagtttcaagcttaaatctaaacggagacaatgctactttgggtgctcccgggcgaggatatcaacttggaaacgattatgcaggtaacggcggcgatgtcggtaatcctggttcagctagttcagccgaaatgggcggtggagcggctggacgagctgttgtaggaacctcacctcaatggataaatgttggtaatattgctggttcttggttataaatatctctaaggagataatatggcttcaaaaatttcgttaccaataacggatataatttttggagtgtgggacagagtttttaaagataatgcatccgggagggttttagtctcccgggttgttgttgtaattattttctttgtacttggattagtttggtcaaaaagcgatgcaatactaaccacttacagagattcgtcttacgatgcgtacgcgaaaattatacaacaagaacgcgaatcacgctttgaaacaactgctctggaacagcttcaaatagttcacatatccagcggagcagatttcactgctgtgtattcgtttagacctaaaaatttaaattattttgttgatttaatagcgtatgagggtagattaccttcaaccgtttcggaaaaaagtcttgacggtttcccggttgataaaactactaatgaatattctacacatttaggaggaagagtttttaaatcatcacaagaatttgcttttctaccgtcaaagaaaaaaacaactgaattaaaatacatgttcagttgtccttacttcaatttagataatatatatgccggaactgtttctatgtactggtacgacggagctccaagtgtaagcccggaacgacttgaatcgatatgtggccaagccgctcgtacattaggaaggtcacgttagaaattacttattggtatgcatcgtcagatgacgatagatatcttcaaatccttcgttgaattcttcaacaagcattcctttctcttctgcagttaaatcagaaattatttttctaaagctactctgatttaactgcttccaatttttatcagcactcatcgtttcattgataaaagcaataaagttatctcgtttatcaacaatatcatcgcgaccaaatttaattaacaaagacgcaatagtaacaacttcacgagcaacttcaaacttagtcatcttatatcctttagtatttaatttttaaatcaataaacggtatagaagtatagtatcaaaattttattggtattgtaaacggttgagtgaactaatttaaaacttcccaacgaaccatcagatgctcaggttgagttatgtactcatttccagaattgttcactcgaatggcgtagcggcctccttgcattgcagctgatatataccattcggctcctactggacgaaccctacgtcccatccaatgacagatttccatggcctcgtgaaaagagtaatcttctttgtccattgccaaattaatcatcatgctttcaatgtaacgctgaatttctacagtttggttgctcataattttcccttcaattctttagataaaatattatcaaaataaatcacggcagcttcaagaatgtttggattctgataagtagaaaatttgaaattgcatccagaataagaccctcccatgtacttcacatgaacaccgtactttttatagaccttttcttctgccctctcaatttcgtcaggaaaatcacttccaaactttccaaatttaattacttcagaagtgtgtaaataactgtgctctgtgacaatatttttatgcttgaaagtcatttgactgtcctttgtgtttttgtttgcgtttggagtcattaatggatttctttttatttttatgaaatccacctttgttaaaatcattttttgccactgggttattcaactaattttcctcttgcgtttttaagctgcttaacttgatgagccaaatgctgcagtggaatattttcatcttggttaagatttcgtctaattaattcaacaaaccactcatattttggtctttttgataattcagccctaagtttagcattttcttgttcagctatggtagctctctgcctataatccatttaaaattcctttgataattatttgaaccacattttaattctcatccatagggatttctgaacagctttgtttaccccgtaagaacgaattactggctgactttcttgaagttctttataatcagctttataaacttcgcaagcagcgggaacaaatgaactaattgctgccataaaatttgtacgttcacctaaaggatttactgaactatcgcgaacaatcaaatattttccagctttaaccttcacgatagttccaagatatgcaccatgataccaaatatcccaaccttctgaagtaggttctacacaacgctgaagttcattcataattgcaaaacggttcataatacttcctagactttaacaacgtgttcaataaataacccatgtttattttcgccttgagtgccttgtataaagattctcactgcgtttggaatatctctagcaaatatttcaacccaatatgtaccaccaccaatctcgtaagtgattttatatttgttcataattcctcacagtgtgtcaacagagttgatgatagtttcaatattttcttgagtacgaacgatatctaaataaacattaccatttttagaatgtttggcaatcataccaaggtcttcaaagtgcttaacttgctcttcagtcattttataacccgaaatacggaagttacctttattgctaacctcgaaactgcgaataccaaatgtgcgtttttcaaggaccgcgataaagttactacgataaacatcaagttttttgattttgaaaagttcttctttagttccaagaagctccatcataaaatctttatctgcttccatatcacccgtaatcgggcgagctttacgagtattgcgtttttctagaagttcaggagcattttcctgtgcataaagtaccgccgcgtttgagatgatgtcctgtgcttcacccgtgattactagaccatcaccagatttttcaattaatcctttcttaatcaaaacaccaatattactgttgactgaagatgcagtcattttatcttctaactgttcacgaagttcagctgaagtgatgaaatcttgttttgcaactttaactaaaatcgatgcagttttttcattcagaacatcattagaagctttgatgatataagttacttttgacattttgtttctccgataatctatttgtttgttgataaagtaatagtaacacagtttaaagcggatgtaaacggttgaagtaaaaatttttaaagttaaccagaacggttgagagtaacgcagaagaaaggatgattaattatatggaccgggctctagaatttactagagccgcatagagttacagcaaaatggagagaagtgcaagaagaagggctaaaccgcctaaaactacgacgattgacaacagcccggctactaagaccgggcttgcataccaaagaaaaaccgccagcgaaattatcagagctactcgcatagctcctccaaatccttcatgaactcaacttccggagtggtatctttccagtactgatactctttcttgagctctttggcagcctctacgagttttttggcttcatctgacgttatgtgataaatgttcataccaaccaatttatcaatatgagccttgaacaattcagttttttctagttctgttacaagctgcttacgagtttttccttgaataacaatttcacccgaaattacttgtttaatgaattgagctttagctactgccaagttcaactgagacaaaacgtcttcacgcttaaactcaattcgtttttcaacaaaagtcttacggacttcaacaaaatgtttaatgagttcagacgctttttgaaacttgtcgtttaacttgccattttcgtcaatgacaacaatgaactgcgaaagtttttcaattaatttgaaatctcgcattacagcgtcatgccgtttatcttcgtctgccggtaacccataatctttcttgaattttactttaaagccaaacccagattttgaacagtcatccgtataagtaataaaacctttgtcttctaacgggtcgagtactttttcaatataagtatcacggtcaaatttatacggaatttcactgatatacatctgtgtagctgaagtgaatttataaacaccgtgtaattcaactccaccgtcatcagtcggaacaattttaccattgaattttggaaattcaacttctggctctttatcaagctttccctgtaaagcgagtttagtgcattctacaactgatttaaaactgtgcggaagaatattagttgcgtacccggtagcaataccgcgaacaccatttaataatacggtaggaataaccggaagataaaaagctggcggtgtatgttcttcgtctttgtgttttggagcaatctctaagtctttataaactttacggaaattgtcagaaatacggcaaaagatgtaacgagacgcagcagctttttgtactaaacgcgaaccaaagttaccttgtccgtccaataaagggaaattgttattccacgtattagccatcagtgccccggcatcttgtgcagagccttcaccgtgatgataccctaaatcagctactccgccagcgactgatgcaagcttatgaaatttttctttattacctttgctgaggtctaatgctcgacgaataacaaaacgctgtactggtttaaatccatcaatcatatttggaattgcacgattttctactgtgtagattgcgaattctttagcttcagtatcaataatactttgtaaacttctttcatttaattgcatatgatttccaattaccaaatgtatgaactgacgtcaattataacacgtgtaaagaaaagcgtcatctgtagtgctataaaatataagcttgcgagaattattccaaatatcgctaaacaaatcgcggcgattgtcaaaattctcatttaattataccactataagagaataaccgctccagcgacagagcagctattccgaaacacatagcgccaagaactcttgacggaggggctaacccctcccaaataaacatcccagaaactatgaataacggtatcattataataaacacggtcgcccatatagttttaattgcattattcatattatttcctagataatttaaaattgtttaaatgcggtaatgactaaaactagaccaagagtcaattgagcaacaaactgagccacgaatgaagactctcgtgtcactgcagtgtaaattgctaaaccaaaccacaccgcggcgattaataatgtcaacatttcaaatcctcttaatatttctgcagaataaatttaaaattatcatttaacatgcgattcatttcttcgaggttctgaaatgcatcttcgtgtttacgagtgaaagctaaagacaattgtcctttaccatgacctgtcgtaagaggtttcattttttcagctggaacgaataccacgctatacacctggtgattattgctcaaagtacgaccaagttgagagcgtccttgtcgaaattgcgataaagtattagaaaacccggttttagaacgttgacgaccaacgtaactacgagataccgcaaatccagcgatattcataataaagtaaaaacctgggcgagatagttcttcttccattggaataccacccacccaatttgcgtttttaatcacgccaattacagttgcgccagcttttgacaaagtttcgatagacaaaaatgtacgacgggtcatattgatatcctcaagttaagtaatttattatcctataatatcacaaattttaattaatgtaaacggttatgatagtttccatagcaacaagctaaaacaaacgcaaatcaacgggatacataatatccaaattaagcaccaagctttactgctcatgattacctcttagtaattagtcatgttatgttttgatgaggtaatagtaacacatccttccatggatgtaaacggctgataatcaaatcattaggtaccaaccttcatacttacttcttttgacaattttcttagtgtcttctgggtccccaacgaacactggggtaaactcgaagcctccagttaaattctctacgacatctaatataattatacagtctgcaacttgatgattcaggaatggccctagattaaccccataaccatagggaaagttaccagagtatcccgtagtaactgaaatccacttagactctgattgatgtgtttttacttcaatgcggagaccacagtatcttggatgcgcaagtacatcccatgcgaaggtgtaagggtcatcatgattttcttgaccatgcattacataaccattaacccattctgcgacggccttttcagctaattgcgctatcatgcaccttttaaccgcggcctctttatcttggcctgggtcttttgacatcgtgtaatttacggtgtcttttattttaactctatcttctggagttaaatcattcttcccgcggataaatgtcggcagtttcttcagtctcaacaaccccggattgttcttgttcattttgctcacctgtataaacgtcttttacccgaagaataccacaataaattcggtcatcaaaatttaaactttctttgtttgagagagcaaattgtatgtgttctttaccaataaaaacatcatcgcaagtcagtacaccatcaacattagggtcaatcaccaaatccaaagcatacacattttgagctttgtgattgccgtgcaatcgtgattcattaattttcgaatcagaaacgttaatccaattaatcataatcatctcttaaagaaaaagggaccgaagtcccttagaattaaattagcgatgcgacggtattagaacgtgcaccatttgctagttacatcttcaattacttggtatttacatgtacgcattttagcatcgccgtaatcaaccgggatagatactacatctcgcggatgaactttaactgaaacgatacggtcactagaaccacggaaatagctaatataactcttagagcaaacatgcaatccagctgaacatgtacgttcgtcatcttcatcaacctggttacgagccatttctacagtaaccccaggggagttatcaaaagtgcggctatggcaatctttgtagttttcagtaacaactttccaagcgataaaatggccgtcatcagtgatttcaatatcgttcgcaaccaagaaatcaaacagacgagctacagctttgcgacttgggttttccatcaaattttcaaggaaaggcatatagaattcgaagttctcgccctgttccatggatttcaggatacgctctgtgagacctgatttaatttcgatgtctttatagaacagacggccttcgtcaattttaacattacctttaacgtaagaggtcaaacctttttcagcgttaacgatttccaatgcgccttcaatatcaccatcaatcaggcgctgcagagcaattttaaaaccgggtagtttatcatctgccggataagttttgtgagtgctcaaatcggtaattgagataaatttattagaagcgttccagatatattctggcgcagcaaccggagtttcaactgcttcaatttcttctactttagtttcttgagccatttctttaactacgcggcggatagtatctactgaacagttgaagtgcttagcaatccagtctcgtttgtagcctgaatcaacataatcaacgatagacaatttctgagaacgagtaaacatttgtacggccat

(19) United States
(12) Patent Application Publication
(10) Pub. No.: US 2019/0380355 A1
(43) Pub. Date: Dec. 19, 2019

(54) IMPROVED CONTROL OF BACTERIAL CONTAMINATION IN FOOD

(71) Applicant: MICREOS FOOD SAFETY B.V., Wageningen (NL)

(72) Inventors: Steven HAGENS, Bennekom (NL); Bert Theo DE VEGT, Doorn (NL); Iancu CATALIN, Wageningen (NL); Giovanni ERACLIO, Utrecht (NL)

(73) Assignee: MICREOS FOOD SAFETY B.V., Wageningen (NL)

(21) Appl. No.: 16/480,453

(22) PCT Filed: Jan. 31, 2018
(86) PCT No.: PCT/EP2018/052417

§ 371 Date: Jul. 24, 2019

(30) Foreign Application Priority Data
Jan. 31, 2017 (EP) 17154050.3

(51) Int. Cl. A23B 4/22; A23L 3/3571; A23L 13/50; A23L 17/00; A23B 4/12; A23B 4/30; A23L 3/3517

(52) U.S. Cl. CPC A23B 4/22; A23L 3/3571; A23L 13/57; A23V 2002/00; A23B 4/12; A23B 4/30; A23L 3/3517; A23L 17/75

(57) ABSTRACT

The present invention relates to the field of biotechnology, more specifically the field of food biotechnology: the control of bacterial contamination in ready-to-eat foods by a bacteriophage composition.

### FIELD OF THE INVENTION

The present invention relates to the field of biotechnology, more specifically the field of food biotechnology: the control of bacterial contamination in ready-to-eat foods by a bacteriophage composition.

### BACKGROUND OF THE INVENTION

The use of bacteriophages for the control of bacterial contamination in and on food products, in food processing equipment and on surfaces of food containers is known in the art (see e.g. WO2004/004495 and WO2013/169102. Other ways of controlling bacterial contamination in and on food products include treatment with e.g. lactate and acetate salts, be in its chemical form (sodium/potassium lactate and sodium/potassium (di) acetate) or in a natural form (vinegar, culture sugar). These compounds are inhibitors of bacterial growth and are added as ingredients to the formulation, either to the cutter (emulsified products) or to the brine (injected whole muscle). It remains however a challenge to control bacterial contamination in ready-to-eat foods such as processed meat. Especially for ready-to-eat foods, bacterial contamination is a substantial problem when it occurs. Since, as the name clearly depicts, no processing such as blanching or another step that could inactivate bacterial contamination is performed by the customer on ready-to-eat foods before consumption, any bacterial pathogen present may lead to infection of the consumer and subsequently to a variety of conditions, including but not limited to, diarrhoea, abortion, encephalitis and ultimately even death. Of course, the same applies to foods that are not labelled as ready-to-eat frozen foods, but are consumed after without processing.

Accordingly, there is an urge for improvement in the control of foods, especially ready-to-eat frozen foods, to protect the health of consumers.

### DESCRIPTION OF THE FIGURES

FIG. 1 depicts the concentration of Listeria in log CFU/cm² versus the storage time in days for treated and untreated samples of food product. Listex is PhageGuard Listex. Samples were concentrated in order to detect and quantify the very low bacterial numbers that would otherwise be below the detection limit.

FIG. 2 depicts the concentration of Listeria in log CFU/cm² versus the storage time in days for treated and untreated samples of food product. Listex is PhageGuard Listex. Samples were concentrated in order to detect and quantify the very low bacterial numbers that would otherwise be below the detection limit.

FIG. 3 depicts the concentration of Listeria in log CFU/cm² versus the storage time in days for treated and untreated samples of food product. LX is PhageGuard Listex, Optiform is potassium lactate with sodium diacetate. BactoCease is buffered vinegar. Samples were concentrated in order to detect and quantify the very low bacterial numbers that would otherwise be below the detection limit.

FIG. 4A (study A) and FIG. 4B (study B) depict the concentration of Listeria in log CFU/cm² versus the storage time in days for treated and untreated samples of food product wherein in the groups of three bars, the left bar represents zero days of storage time, the middle bar represents 14 days of storage time and the right bar represents 21 days of storage time. LX is PhageGuard Listex, BV is buffered vinegar.

FIG. 5 depicts the concentration of Listeria in log CFU/cm² versus the storage time in days (y-axis) for treated and untreated samples of food product. Ctrl is control, PG-L and LX are PhageGuard Listex, BV is buffered vinegar, KL is potassium lactate, KL-SD is potassium lactate and sodium diacetate.

### DETAILED DESCRIPTION OF THE INVENTION

It has been established by the inventors that, surprisingly, the combined use of an organic acid, or a salt thereof, and a bacteriophage provides superior control of bacterial contamination in and on food products. This invention does not only provide superior control of bacterial contamination in and on food products, it also provides a reduction in cost saving on anti-microbial agents of up to 50% to 75%.

Accordingly, the invention provides for a method of controlling bacterial contamination of a food product comprising administering to the food product:
an effective amount at least one bacteriophage, and
an effective amount of an organic acid, or a salt thereof,

to reduce the number of a pathogenic bacterium in said food product.

The bacteriophage and the organic acid, or a salt thereof, are herein referred to individually or collectively as compound according to the invention or plainly as compound(s).

An effective amount is the amount of the combined compounds that reduces the number of the pathogenic bacterium by preferably at least 1 log, more preferably at least 2 log, more preferably at least 3 log, more preferably at least 4 log, more preferably at least 5 log, more preferably at least 6 log. The effective amount can also be the amount of the combined compounds that is able to maintain the number of the pathogenic bacteria below the detection limit of e.g. 1 log or e.g. the 2 log out growth for at least 10, 145, 20, 30, 40, 50, 60, 70, 80, 90, 100, 120, or more days after administration of the compounds or after packaging of the food product.

The food product may be any food product and can be provided by the person skilled in the art. A preferred food product is a ready-to-eat food, as known in the art, preferably in the form of slices or other ready-to-use portions. Such food product is herein referred to as a food product according to the invention.

A preferred food product according to the invention is a food product that is processed, non-processed, cured or uncured as known in the art.

A preferred food product according to the invention is selected from the group consisting of meat, fish, shellfish, pastry, dairy products, vegetables, fruit and mixtures thereof, as known in the art.

The processing or curing of the food product according to the invention is preferably one selected from the group consisting of cooking, salting, baking, steaming, smoking, grilling, roasting, drying and brining (e.g. injecting with brine).

The food product according to the invention may be any food product that is known in the art and is susceptible to bacterial contamination and/or spoilage, preferably the food product is selected from the group consisting of poultry, such as chicken and turkey, beef, pig, horse, donkey, rabbit, goat, sheep, salmon, trout, lobster, clamps, shrimps, crawfish, cheese, ice cream, sausage, such as frankfurter, bologna, meatloaf, roast beef, ham, sliced meat and mixtures thereof, as known in the art.

The bacteriophage according to the invention is preferably from the family of causovirales, more preferably from the Myoviridae, Podoviridae and/or Siphoviridae.

Phages, as antibacterial agents, have the advantage of replicating within the bacterial target. Thus, when their progeny lyse the cell and escape into the extracellular milieu, they can infect and multiply in succeeding generations of bacteria, producing progeny levels far greater than that of the binary growth of the target bacteria, thereby increasing the phage population exponentially in numbers at the expense of the bacterial targets.

A preferred bacteriophage according to the invention is a virulent Listeria monocytogenes bacteriophage, such as P100, as well as other virulent phages from the Myoviridae and Siphoviridae families, and virulent mutants of various temperate strains of phage (such as but not limited to phages B054, A118, A502, A006, A500, A511, PSA, P35 and related viruses). These phages described in WO2004/004495 which is herein incorporated by reference. Phage P100 has been deposited at ATCC with deposited number PTA-4383 and is a preferred bacteriophage according to the invention. Phage A511 has been deposited at ATCC with deposited number PTA-4608 and is a preferred bacteriophage according to the invention. The person skilled in the art will comprehend that bacteriophages P100 and A511 may conveniently be combined.

A further preferred bacteriophage according to the invention is a virulent bacteriophage specific for Salmonella enterica (see e.g. Marti et al, 2013, Mol. Microbiol. 87(4), 818-834). Preferably, such bacteriophage is bacteriophage S16 belonging to the order Caudovirales. Phage S16 has a contractile tail, which is the defining morphological feature of the Myoviridae family. Phage S16 is the first strictly virulent, non-toxic broad host range T-even like bacteriophage solely infecting Salmonella bacteria ever described. Phage S16 lacks any kind of virulence factors as is the case for other T-even phages described in the literature. Phage S16 is a new member of the genus of T4-like viruses, belonging to the T-even type of subgroup and is the first fully characterized member of the T4-like phages limited to infecting Salmonella. This bacteriophage and derivatives thereof are extensively described in WO2013/169102, which is herein incorporated by reference. Phage S16 is deposited at the CBS Fungal Biodiversity Centre under number CBS130493. Preferably, an S16 bacteriophage according to the invention has a genome that has at least 50, 55, 60, 65, 70, 75, 80, 81, 82, 83, 84, 85, 86, 87, 88, 89, 90, 91, 92, 93, 94, 95, 96, 97, 98, 99 or 100% sequence identity with the genome of Phage S16, deposited at the CBS Fungal Biodiversity Centre, Utrecht, The Netherlands, under number CBS130493 and represented herein by SEQ ID NO: 1.

It is within the scope of the invention that more than one specific bacteriophage is in the methods according to the invention. Suitable bacteriophages may be mixed, e.g. a bacteriophage specific for Listeria may be mixed with a bacteriophage specific for Salmonella.

A further preferred bacteriophage is the broad host range phage Felix O1. Felix O1 and bacteriophage S16 show largely overlapping but a nonetheless complementary host range. In conjunction with the well-studied broad host range Salmonella phage Felix O1 an almost complete host-range can be achieved making a combination of Felix O1 with bacteriophage S16 extremely useful for combating Salmonella-bacteria in the various methods herein. Furthermore, as the phage Felix O1 and bacteriophage S16 have different receptors on Salmonella cells (Lipopolysaccharide or LPS and OmpC, respectively), a mutation leading to resistance to one of the two phages would still leave the cells susceptible to the other phage. A preferred combination is a combination of bacteriophage S16 with bacteriophage Felix O1. To this combination, or to bacteriophage S16 of Felix O1, bacteriophage P100 and/or A511 may be added.

Preferably, in a method according to the invention, the pathogenic bacterium is one selected from the group consisting of Listeria, E. coli, Salmonella, Campylobacter and a combination thereof. More preferably, the pathogenic bacterium is selected from the group consisting of Listeria, E. coli, Salmonella and a combination thereof. Even more preferably, the pathogenic bacterium is selected from the group consisting of Listeria, Salmonella and a combination thereof. Most preferably, the pathogenic bacterium is Listeria or Salmonella.

The food product may be packaged, usually immediately after performing a method according to the invention or as a step within a method according to the invention. Preferably, the food product is packaged such that it can be stored and transported from the manufacturer via the distributor, wholesale, retail to the customer. The package may be a package under vacuum or under protective atmosphere using an inert gas. The packaging material may contain oxygen scavengers or the like. The packaged food product may be stored at temperatures below room temperature, such as 4 degrees Celsius/29 Fahrenheit.

The compounds according to the invention may be administered to the food product in any way known to the person skilled in the art, e.g. by mixing them with the food product or dipping the food product in a composition comprising the compounds according to the invention. A preferred method for administering is wherein the administration of the at least one bacteriophage and of the organic acid, or a salt thereof, is performed by spraying of a solution comprising the bacteriophage and/or the organic acid, or a salt thereof. Spraying of food products with agents is known in the art and any suitable method known may be used; the person skilled in the art knows to select a proper method. It is preferred that the bacteriophage and the organic acid, or a salt thereof, are present in different solutions and that the spraying of the at least one bacteriophage and of the organic acid, or a salt thereof, is performed from different nozzles. The spraying of the at least one bacteriophage and of the organic acid, or a salt thereof, is preferably performed simultaneously. Simultaneously herein means that the spraying of the two compounds is performed preferably at the same time or shortly after each other, e.g. at most 1, 2, 3, 4, 5, 10, 20, 30, 40, 50 or 60 seconds after each other.

The organic acid according to the invention is preferably selected from the group consisting of lactic acid, preferably L-lactic acid, acetic acid, propionic acid and mixtures thereof. The salt of the organic acid according to the invention is preferably selected from the group consisting of the sodium salt, potassium salt, ammonium salt and mixtures thereof, preferably K-(L)lactate, Na-(L)lactate, K-acetate, Na-acetate, K-diacetate, Na-diacetate, K-propionate, Na-propionate and mixtures thereof.

Preferably, in a method according to the invention, the organic acid is acetic acid in a buffered aqueous solution, preferably comprising 2% to 30% acetate, more preferably comprising 5% to 20% acetate, more preferably comprising 10% to 20% acetate, more preferably comprising 15% to 20% acetate, more preferably comprising 15, 16, 17, 18, 19 or 20% acetate, most preferably comprising 17% acetate. The preferred pH of the acetic acid in a buffered aqueous solution is 2 to 7, more preferably 5 to 6.5 and most preferably to 5.7 to 6.3. Preferred buffering is performed using sodium acetate, acetic acid, sodium hydroxide, sodium carbonate and/or sodium bicarbonate.

Preferably, in a method according to the invention, the salt of the organic acid is in an aqueous solution comprising a mixture of K-(L)lactate and Na-diacetate, preferably comprising 50% to 80% K-(L)lactate and 2% to 10% Na-diacetate, more preferably comprising 60% to 80% K-(L)lactate and 3% to 10% Na-diacetate, more preferably comprising 70% to 75% K-(L)lactate and 4% to 6% Na-diacetate, most preferably comprising 72.8% K-(L)lactate and 5.2% Na-diacetate. The aqueous solution may be buffered as described here above.

Preferably, in a method according to the invention, the at least one bacteriophage is present in an aqueous liquid and preferably comprises 1×10⁷ PFU/ml to 1×10¹¹ PFU/ml, more preferably 1×10⁸ PFU/ml to 1×10¹⁰ PFU/ml, more preferably 1×10⁹ PFU/ml to 1×10¹⁰ PFU/ml, most preferably 1×10⁹ PFU/ml. PFU herein is Plaque Forming Unit. The person skilled in the art knows how to calculate and assay PFU's.

Preferably, in a method according to the invention 0.01% (v/w) to 2% (v/w) of the solution comprising the organic acid, or a salt thereof, is administered to the food product, more preferably 0.1%(v/w) to 1%(v/w), more preferably 0,1%(v/w), 0.2%(v/w), 0.3%(v/w). 0.4%(v/w), 0.5%(v/w), 0.6%(v/w), 0.7%(v/w), 0.8%(v/w), 0.9%(v/w), or 1.0%(v/w) is administered to the food product. “v/w” means that the given percentage of solution is administered in relation to the weight of the food product, e.g. 1% (v/w) means that 1 ml of solution is administered to 100 gram of food product. A preferred method of administration is spraying.

Preferably, in a method according to the invention, 1×10⁵ PFU/ml to 1×10⁹ PFU/ml of the at least one bacteriophage is administered per cm² of food product, more preferably 1×10⁶ PFU/ml to 1×10⁸ PFU/ml of the at least one bacteriophage is administered per cm² of food product, more preferably 1×10⁷ PFU/ml to 1×10⁸ PFU/ml of the at least one bacteriophage is administered per cm² of food product, more preferably 1×10⁷ PFU/ml, 2×10⁷ PFU/ml, 3×10⁷ PFU/ml, 4×10⁷ PFU/ml, 5×10⁷ PFU/ml, 6×10⁷ PFU/ml, 7×10⁷ PFU/ml, 8×10⁷ PFU/ml, 9×10⁷ PFU/ml, or 1×10⁸ PFU/ml of the at least one bacteriophage is administered per cm² of food product. A preferred method of administration is spraying.

The invention further provides for a food product obtainable of obtained by a method according to the invention. Such food product may be packaged as defined previously herein.

The invention further provides for a food product that comprises at least 0.5% of the organic acid, or a salt thereof, according to the invention and further comprises at least 1×10³ PFU, or at least 1×10³ PFU equivalents, per average gram of food product. At least 1×10³ PFU is preferably at least 1×10³ PFU or 1×10⁴ PFU or 1×10⁵ PFU or 1×10⁶ PFU or 1×10⁷ PFU or 1×10³ PFU or at least 1×10⁹ PFU. At least 1×10³ PFU equivalents is preferably at least 1×10³ PFU or 1×10⁴ PFU or 1×10⁵ PFU or 1×10⁶ PFU or 1×10⁷ PFU or 1×10³ PFU or at least 1×10⁹ PFU equivalents. PFU equivalent means that said amount of bacteriophage of the invention has been administered by treatment of the food product. After prolonged storage, the bacteriophage itself may not be fully biologically active, but the remains are still present and can be detected by methods known to the person skilled in the art such as, but not limited to, mass spectrometry and nucleic acid amplification techniques such as Polymerase Chain Reaction. The food product may comprise some indigenous organic acid or a salt thereof, such as e.g. lactate, this is believed to be approximately 0.5%, hence the threshold mentioned here. At least 0.5% of the organic acid, or a salt thereof, is preferably 0.5% of the organic acid, or a salt thereof, 0.6% of the organic acid, or a salt thereof, 0.7% of the organic acid, or a salt thereof, 0.8% of the organic acid, or a salt thereof, 0.9% of the organic acid, or a salt thereof or 1% of the organic acid, or a salt thereof.

Unless otherwise indicated each embodiment as described herein may be combined with another embodiment as described herein.

Definitions

In this document and in its claims, the verb “to comprise” and its conjugations is used in its non-limiting sense to mean that items following the word are included, but items not specifically mentioned are not excluded. In addition, reference to an element by the indefinite article “a” or “an” does not exclude the possibility that more than one of the element is present, unless the context clearly requires that there be one and only one of the elements. The indefinite article “a” or “an” thus usually means “at least one”.

The word “about” or “approximately” when used in association with a numerical value (e.g. about 10) preferably means that the value may be the given value (of 10) more or less 5% of the value. The sequence information as provided herein should not be so narrowly construed as to require inclusion of erroneously identified bases. The skilled person is capable of identifying such erroneously identified bases and knows how to correct for such errors. In case of sequence errors, the sequence of the polypeptides obtainable by expression of the genes present in SEQ ID NO: 1 containing the nucleic acid sequences coding for the polypeptides should prevail.

All patent and literature references cited in the present specification are hereby incorporated by reference in their entirety.

### EXAMPLES

### Example 1

Effect of an Anti-Listeria Monocytogenes Bacteriophage in Combination with Buffered Vinegar or Lactate/Diacetate on Listeria on Cooked Turkey when Applied on the Surface of the Food Product.

Materials and Methods

Commercially available cooked turkey was inoculated with Listeria monocytogenes at 1 Log CFU(Colony Forming Units)/cm². A four-strain cocktail of bacteria was used: L. monocytogenes 10403S-SV 1/2a; EDGe-SV 1/2 a; WLSC1042-SV 4b and WLSC ScottA-SV4b. All strains are reference strains and are commercially available.

The surfaces of the cooked turkey was subsequently sprayed with a volume of 5 μl/cm² of:
Control: water
2% PhageGuard Listex=4×10⁹ PFU/ml=2×10⁷ PFU/cm². Phageguard Listex comprises bacteriophage P100 which is described previously herein.
Opti.Form Plus—a commercially available solution comprising 72.8% potassium lactate, 5.2% sodium diacetate and 22 water.
BactoCEASE—a commercially available solution of buffered vinegar (17% acetate, pH 5.7-6.3)
Combination of Opti.Form Plus and PhageGuard Listex
Combination of BactoCEASE and PhageGuard Listex

Samples were subsequently vacuum packed and stored at 4 degrees Celsius. At intervals, the Listeria concentration was measured and depicted as Log CFU/cm².

Results

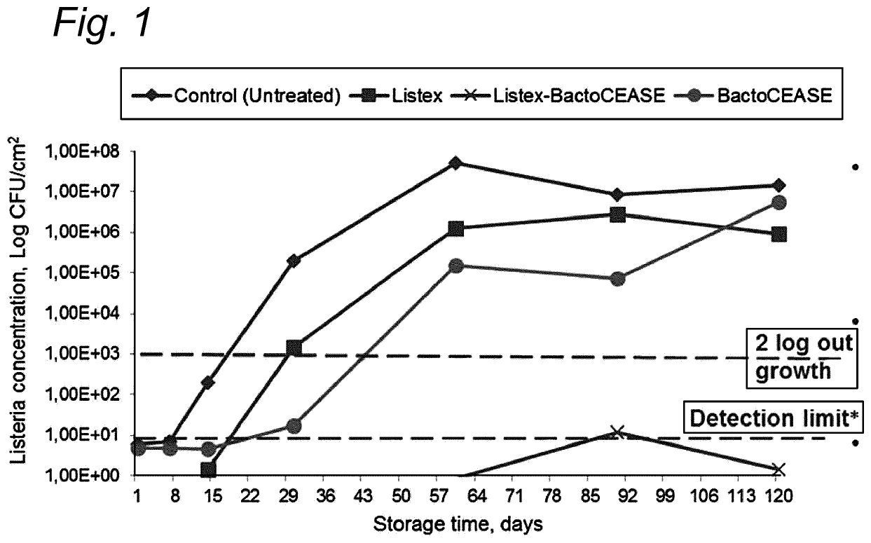

The results are depicted in FIGS. 1 (BactoCEASE) and 2 (Opti.Form Plus).

From FIG. 1, it can clearly be observed that PhageGuard Listex decreased Listeria to undetectable levels up to 20 days, when growth was first detected again. BactoCEASE controlled Listeria for up to 30 days. The combination of PhageGuard Listex and BactoCEASE controlled Listeria for up to 120 days. At 92 days, the growth reduction by BactoCEASE was 2 logs, the reduction by PhageGuard Listex was less than 1 log, but the combined reduction by BactoCEASE and PhageGuard Listex was over 6 logs!

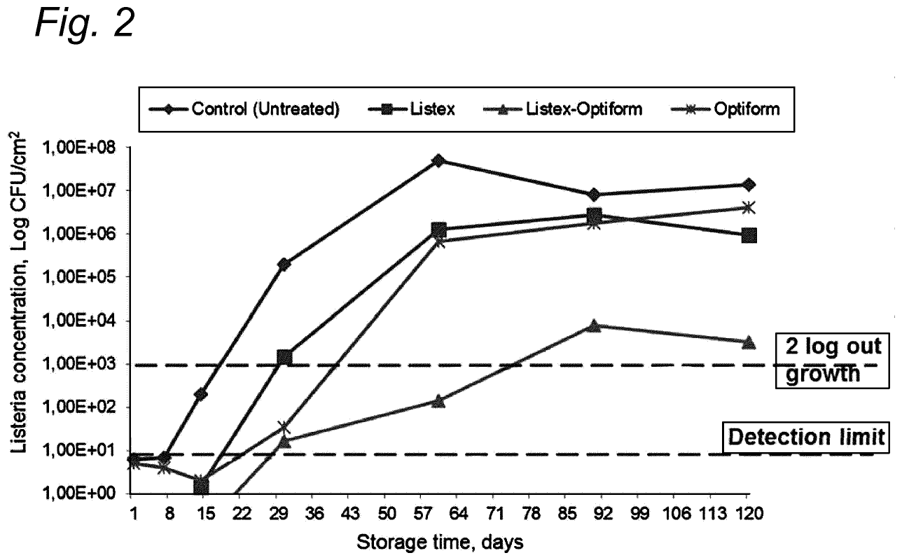

From FIG. 2, it can clearly be observed that PhageGuard Listex decreased Listeria to undetectable levels up to 20 days, when growth was first detected again. Opti.Form Plus controlled Listeria for up to 25 days. The combination of PhageGuard Listex and Opti.Form Plus controlled Listeria for up to 30 days while keeping the concentration of Listeria below 2 logs/cm² for up to 70 days. At 92 days, the growth reduction by Opti.Form Plus and PhageGuard Listex individually was less than 1 log, but the combined reduction by Opti.Form Plus and PhageGuard Listex was over 3 logs!

These results clearly demonstrate that a method of controlling bacterial contamination of a food product comprising administering to the food product:
an effective amount at least one bacteriophage, and
an effective amount of an organic acid, or a salt thereof,

to reduce the number of a pathogenic bacterium in said food product, is superior over treatment by the individual compounds; a surprising synergistic effect is observed.

In addition to the analysis described here above, sensory analysis on samples treated by a method according to the invention revealed that the products were not adversely affected; seven out of eight panellists were not able to taste and smell a difference between treated and untreated samples.

### Example 2

Effect of an Anti-Listeria Monocytogenes Bacteriophage in Combination with Buffered Vinegar or Lactate/Diacetate on Listeria on Cooked Turkey when Applied on the Surface of the Food Product Experiment 2 was Repeated.

Materials and Methods

Commercially available cooked turkey was inoculated with Listeria monocytogenes at 1 Log CFU(Colony Forming Units)/cm². A four-strain cocktail of bacteria was used: L. monocytogenes 10403S-SV 1/2a; EDGe-SV 1/2 a; WLSC1042-SV 4b and WLSC ScottA-SV4b. All strains are reference strains and are commercially available.

The surfaces of the cooked turkey was subsequently sprayed with a volume of 5 μl/cm² of:
Control: water
2% PhageGuard Listex=4×10⁹ PFU/ml=2×10⁷ PFU/cm². Phageguard Listex comprises bacteriophage P100 which is described previously herein.
Opti.Form Plus—a commercially available solution comprising 72.8% potassium lactate, 5.2% sodium diacetate and 22 water.
BactoCEASE—a commercially available solution of buffered vinegar (17% acetate, pH 5.7-6.3)
Combination of Opti.Form Plus and PhageGuard Listex
Combination of BactoCEASE and PhageGuard Listex

Samples were subsequently vacuum packed and stored at 4 degrees Celsius. At intervals, the Listeria concentration was measured and depicted as Log CFU/cm².

Results

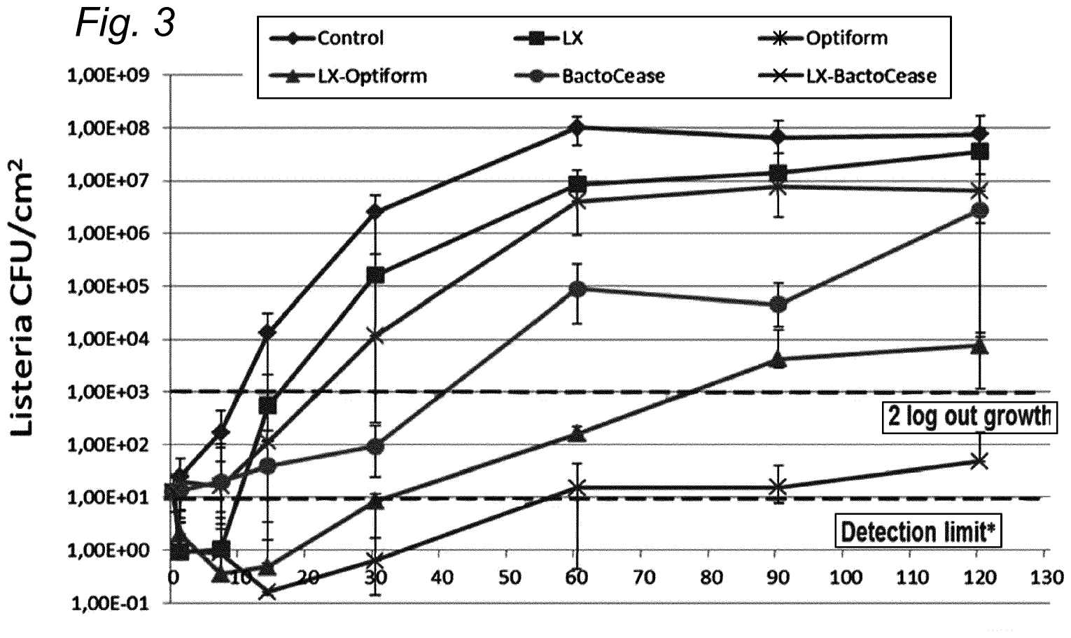

The results are depicted in FIG. 3.

From FIG. 3, it can clearly be observed that PhageGuard Listex decreased Listeria to undetectable levels up to 15 days, when growth was first detected again. BactoCEASE controlled Listeria for up to 30 days. The combination of PhageGuard Listex and BactoCEASE controlled Listeria for up to 120 days. At 92 days, the growth reduction by BactoCEASE was about 3 logs, the reduction by PhageGuard Listex was less than 1 log, but the combined reduction by BactoCEASE and PhageGuard Listex was over 6 logs.

From FIG. 3, it can clearly be observed that Opti.Form Plus controlled Listeria for up to 25 days. The combination of PhageGuard Listex and Opti.Form Plus controlled Listeria for up to 30 days. The combination of PhageGuard Listex and Opti.Form Plus controlled Listeria for up to 90 days and kept he concentration of Listeria belwo the 2 log outgrowth for 70 days. At 92 days, the growth reduction by Opti.Form Plus and PhageGuard Listex individually was less than 1 log, but the combined reduction by Opti.Form Plus and PhageGuard Listex was over 4 logs!

These results clearly corroborate that a method of controlling bacterial contamination of a food product comprising administering to the food product:
an effective amount at least one bacteriophage, and
an effective amount of an organic acid, or a salt thereof,

to reduce the number of a pathogenic bacterium in said food product, is superior over treatment by the individual compounds; a surprising synergistic effect is observed.

In addition to the analysis described here above, sensory analysis on food samples (frankfurter sausages and cooked chicken breast) treated by a method according to the invention revealed that the products were not adversely affected; seven out of eight panellists were not able to taste and smell a difference between treated and untreated samples.

### Example 3

Effect of an Anti-Listeria Monocytogenes Bacteriophage in Combination with Buffered Vinegar or on Listeria on Salmon Fillet when Applied on the Surface of the Food Product

Materials and Methods

Commercially available smoked salmon fillet was inoculated with Listeria monocytogenes at 2 Log CFU(Colony Forming Units)/cm². A four-strain cocktail of bacteria was used: L. monocytogenes 10403S-SV 1/2a; EDGe-SV 1/2 a; WLSC1042-SV 4b and WLSC ScottA-SV4b. All strains are reference strains and are commercially available.

The surfaces of the cooked turkey was subsequently sprayed with a volume of 5 μl/cm² of:
Control: water
2% PhageGuard Listex=4×10⁹ PFU/ml=2×10⁷ PFU/cm² (applied at 5 μL/cm2)
Buffered vinegar—two concentrations (8.5% and 12.5% acetate) and pick up (1.2% and 1.8%)
Combination of PhageGuard Listex and buffered vinegar (total 13 μL/cm²).

Samples were vacuum packed and stored at 4 degrees Celsius for 7 days, then 7 degrees Celsius for the following 7 days and 9 degrees Celsius for the last week (total storage time 21 days).

The experiment was performed in duplicate (A, B).

Results

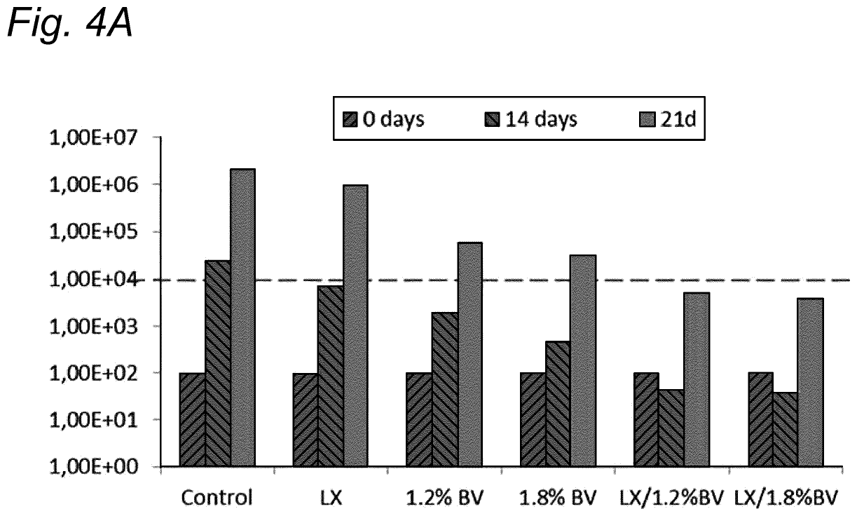

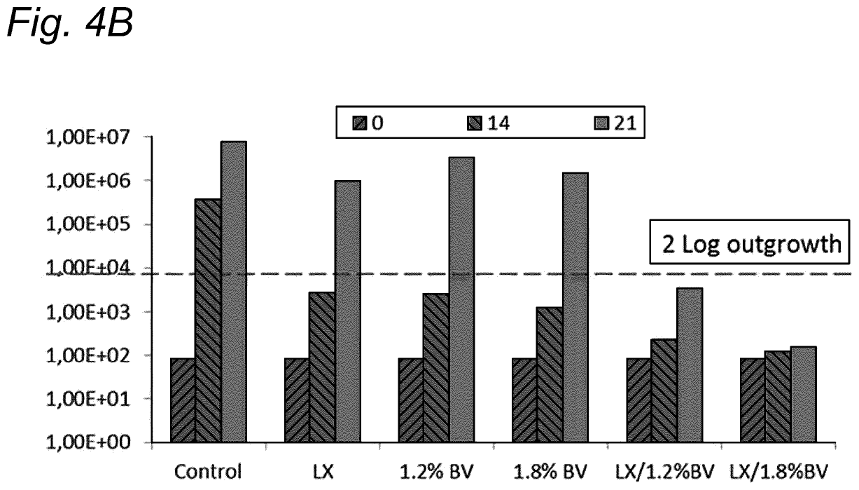

The results of experiments A and B are depicted in FIG. 4 (FIG. 4A, FIG. 4B).

From FIG. 4, it can clearly be observed that Listeria outgrowth is controlled for up to 14 days by buffered vinegar and Listex when used individually whereas the combination of Listex and buffered vinegar controlled Listeria outgrowth for up to 21 days. In addition, it was observed that control of Listeria outgrowth was superior by the combination of Listex and buffered vinegar in view of outgrowth control by the individual components.

### Example 4

Effect of an Anti-Listeria Monocytogenes Bacteriophage in Combination with Buffered Vinegar and Other Organic Acids or on Listeria on Salmon Fillet when Applied on the Surface of the Food Product

Materials and Methods

Commercially available smoked salmon fillet was inoculated with Listeria monocytogenes at 1 Log CFU(Colony Forming Units)/cm². A four-strain cocktail of bacteria was used: L. monocytogenes 10403S-SV 1/2a; EDGe-SV 1/2 a; WLSC1042-SV 4b and WLSC ScottA-SV4b. All strains are reference strains and are commercially available.

The surfaces of the cooked turkey was subsequently sprayed with a volume of 5 μl/cm² of:
Control: water
1% PhageGuard Listex=2×10⁹ PFU/ml=2×10⁷ PFU/cm² (applied at 10 μL/cm2)
Buffered vinegar (17% acetate)
Potassium lactate (78% potassium lactate)
Potassium lactate-sodium diacetate (respectively 72.8% and 5.2%)
Combination of PhageGuard Listex and Potassium lactate-sodium diacetate

Samples were vacuum packed and stored at 4 degrees Celsius for 7 days, then 7 degrees Celsius for the following 7 days and 9 degrees Celsius for the last week (total storage time 21 days).

Results

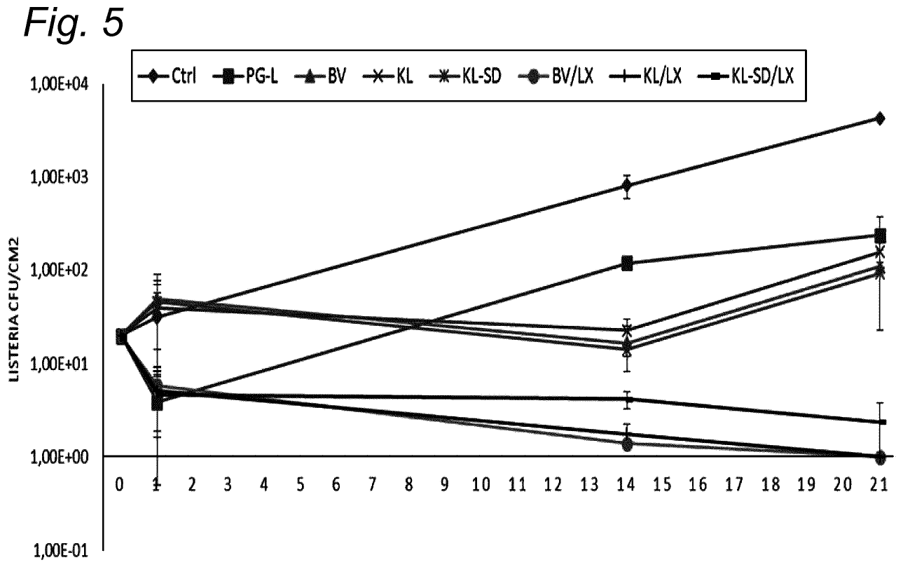

The results are depicted in FIG. 5.

From FIG. 5, it can clearly be observed that Listeria outgrowth is controlled for up to 14 days by the individual components: buffered vinegar, potassium lactate, potassium lactate/sodium diacetate and Listex. The combination of Listex and either of buffered vinegar, potassium lactate and potassium lactate/sodium diacetate controlled Listeria outgrowth for at least 21 days. In addition, it was clearly observed that control of Listeria outgrowth was superior by the combination of Listex and either of buffered vinegar, potassium lactate and potassium lactate/sodium diacetate in view of outgrowth control by the individual components.

1. A method of controlling bacterial contamination of a food product comprising administering to the food product:
an effective amount at least one bacteriophage, and
an effective amount of an organic acid, or a salt thereof, to reduce the number of a pathogenic bacterium in said food product.

2. The method according to claim 1, wherein the food product is a ready-to-eat food, preferably in slices or other ready-to-use portions.

3. The method according to claim 1, wherein the food product is a processed, non-processed, cured or uncured food product selected from the group consisting of meat, fish, shellfish, pastry, dairy products, vegetables, fruit and mixtures thereof.

4. The method according to claim 1, wherein the processing or curing is selected from the group consisting of cooking, salting, baking, steaming, smoking, grilling, roasting, drying and brining.

5. The method according to claim 1, wherein the food product is selected from the group consisting of poultry, such as chicken and turkey, beef, pig, horse, donkey, rabbit, goat, sheep, salmon, trout, lobster, clamps, shrimps, crawfish, cheese, ice cream, sausage, such as frankfurter, bologna, meatloaf, roast beef, ham, sliced meat and mixtures thereof.

6. The method according to claim 1, wherein the bacteriophage is from the family of causovirales, preferably from the Myoviridae, Podoviridae and/or Siphoviridae.

7. The method according to claim 1, wherein the pathogenic bacterium is one selected from the group consisting of Listeria, E. coli, Salmonella, Campylobacter and a combination thereof.

8. The method according to claim 1, wherein the food product is packaged under vacuum and/or in a protective environment.

9. The method according to claim 1, wherein the administration of the at least one bacteriophage and of the organic acid, or a salt thereof, is performed by spraying of a solution comprising the bacteriophage and/or the organic acid, or a salt thereof.

10. The method according to claim 9, wherein the spraying of the at least one bacteriophage and of the organic acid, or a salt thereof, is performed from different nozzles and wherein spraying of the at least one bacteriophage and of the organic acid, or a salt thereof, is preferably performed simultaneously.

11. The method according to claim 1, wherein the organic acid is selected from the group consisting of lactic acid, preferably L-lactic acid, acetic acid, propionic acid and mixtures thereof.

12. The method according to claim 1, wherein the salt of the organic acid is selected from the group consisting of the sodium salt, potassium salt, ammonium salt and mixtures thereof, preferably K-(L)lactate, Na-(L)lactate, K-acetate, Na-acetate, K-diacetate, Na-diacetate, K-propionate, Na-propionate and mixtures thereof.

13. The method according to claim 1, wherein the organic acid is acetic acid in a buffered aqueous solution, preferably comprising 5% to 20% acetate, more preferably comprising 17% acetate, with a preferred pH of 5 to 6.5.

14. The method according to claim 1, wherein the salt of the organic acid is in an aqueous solution comprising a mixture of K-(L)lactate and Na-diacetate, preferably comprising 50% to 80% K-(L)lactate and 2% to 10% Na-diacetate, more preferably comprising 72.8% K-(L)lactate and 5.2% Na-diacetate.

15. The method according to claim 1, wherein the at least one bacteriophage is present in an aqueous liquid and preferably comprises 1×10⁷ PFU/ml to 1×10¹¹ PFU/ml.

16. The method according to claim 1, wherein 0.01% (v/w) to 2% (v/w) of the solution comprising the organic acid, or a salt thereof, is sprayed on the food product.

17. The method according to claim 1, wherein 1×10⁵ PFU/ml to 1×10⁹ PFU/ml of the at least one bacteriophage is administered per cm² of food product.

18. A food product obtainable by the method according to claim 1.

19. A food product comprising at least 1% of the organic acid, or a salt thereof, as defined in claim 1 and further comprising at least 1×10³ PFU, or at least 1×10³ PFU equivalents, per average gram of food product.
